(19) United States
(12) Patent Application Publication
(10) Pub. No.: US 2002/0072963 A1
(43) Pub. Date: Jun. 13, 2002

(54) Traffic information & pricing (TIP) system

(76) Inventor: Wiebren de Jonge, Almere-Stad (NL)

Correspondence Address: Ronald A. Sandler, Jones, Day, Reavis & Pogue, 77 West Wacker Drive, Chicago, IL, 60601-1692, US

(21) Appl. No.: 09/948,845

(22) Filed: Sep. 7, 2001

Related U.S. Application Data
(63) Continuation of application No. PCT/NL00/00161, filed on Mar. 9, 2000.

(30) Foreign Application Priority Data
Mar. 9, 1999 (NL) 1011501

(51) Int. Cl. G08G 1/00; G06F 17/60

(52) U.S. Cl. 705/13; 340/928; 340/540

(57) ABSTRACT

The TIP-system concerns a class of systems for collecting and/or disseminating information in relation to traffic, whereby information about individual persons and/or vehicles can be collected and checked on reliability (trustworthiness) in such a way that yet sufficient (privacy) protection can be offered against illegitimate tracing of individual persons and/or vehicles. Also, these systems can easily be prepared for future expansion (extensions), refinements and possible other changes. So, one may start using a simple variation and gradually introduce more and more applications and refinements. TIP-systems can be used, for example, for imposing all sorts of traffic fees, that is, for traffic pricing. In case of road traffic it is, for example, possible to charge for all distances traveled and to relate the fee for each distance unit traveled, if desired, to the place where and/or to the date, the point in time and/or the traffic intensity when that distance unit was traveled, to the brand, model, year of make, gearbox type and engine type of the vehicle used to the gear engaged, the number of revolutions, the fuel consumption, the noise production, the speed and/or speed changes when traveling the distance unit with that vehicle, and/or to the environmental pollution caused. Reducing noise nuisance by aircraft is another example of a possible application. Keywords: electronic toll collection (ETC), traffic pricing, proportionate pricing, continuous pricing, discrete pricing, odometer-based fee, mileage fee, kilometer fee, kilometer tax, road pricing, congestion pricing, pollution pricing, privacy protection, tracing, fraud resistance, controls, checks, verification, identification, semi-identification, agent, hunter, intermediary, reachability, congestion, traffic congestion information, traffic delay, environmental pollution, fuel consumption, noise nuisance, traffic fee, traffic tax, toll, meter reading, odometer, speedometer, tachometer, revolution-counter, automatic calibration, cruise control, rolling tester, taximeter, tachograph, black box.

### BACKGROUND OF THE INVENTION

This application is a continuation of International Application No. PCT/NL00/00161 filed Mar. 9, 2000 which claims the benefit of Netherlands Patent Application No. 1011501, filed Mar. 9, 1999.

1. Field of the Invention

In this introduction we give first a description of our use of the notion traffic information system, we show what such a traffic information system can be used for and give a few properties that a traffic information system preferably must have. Then we give a short description of a few characteristic aspects of traffic information systems belonging to the invention, i.e., of TIP-systems. Then we close in on a specific, important application, namely traffic pricing, before giving a further characterization of TIP-systems used (exclusively or also) for traffic pricing. After a comparison with existing systems we give a closing overview of the further content of the text, where further explanation will be given.

1.1. Description of Related Art

Traffic makes use of (a part of) an infrastructure, that is, the collection of all provisions for traffic, such as a traffic network consisting of traffic ways and all the things that go with it. For example the infrastructure in the case of shipping traffic consists of waterways, harbors, radar stations, beacons, (satellite) navigation systems and shipping communications systems, such as maritime phones (VHF). We hope with this example to have illustrated that the notion infrastructure must be interpreted in a broad sense.

With the notion traffic is not only aimed at ‘physical’ traffic (such as transport over, under and/or through land, water and air), but also at ‘logical’ traffic (like for example message traffic in computer networks and/or economic traffic). Even though TIP-systems can be used, possibly in adjusted form, by such other forms of traffic¹, we restrict ourselves in the following explanation to ‘physical’ traffic. To not complicate the description of TIP-systems and of the necessary and/or used techniques unnecessarily, we concentrate ourselves in the following examples and the further explanations mostly on the instance of road traffic. Based on the given explanation a person skilled in the art can create himself/herself a (where necessary adjusted) description for other forms of traffic or transport. The given examples and mentioned variations are intended for illustration only and thus must not be interpreted as implied restrictions. ¹ Think, for example, of charging for data transport or perhaps even on electronic charging of sales tax, salary tax and/or income tax.

1.2 Traffic Information and Traffic Fee

The term traffic information will be used for every relevant bit of information that has to do with traffic in the broadest sense, including also information about the involved infrastructure, about relevant (for example, taking part in traffic or having taken part) vehicles and/or persons, about the use of vehicles and about other relevant aspects, like for example traffic congestion, weather conditions or other usage conditions². ² For example, in case of shipping traffic tide tables could be relevant information. See also the next footnote.

We use the term traffic fee not only for traffic taxes, like for example road taxes, license fees and tolls, but also for all kinds of other costs that one way or another are related to participation in traffic, like for example traffic fines, transport costs and insurance-premiums. For transport costs think for example of the costs for the use of public transportation and for insurance-premiums think for example of the fees for car insurance, whereby the amount for example could depend on the number of driven kilometers and/or on the location where the kilometers were driven. (For example because the risk of damage per driven kilometer on a freeway is lower than on a secondary road or in a city center.) Further we interpret traffic fees to include not only fees on active traffic participation, like for example in case of road pricing, but also passive ‘participation’, like for example in case of parking fees. In summary, our term traffic fee has, just as our term traffic information, a (very) broad interpretation³. ³ Most often we will use the term fee. We have just explained that this term encompasses taxes, tolls, levies, costs, etc. related to traffic. Sometimes we use one of these other terms, each of which in our text is usually intended to be a synonym, i.e., to have the same wide sense (broad interpretation) as the term traffic fee.

### SUMMARY OF THE INVENTION

1.3 Traffic Information System

When gathering and/or disseminating traffic information one speaks of, what we will call, a traffic information system. A traffic information system can, for example, be used for gathering information about the traffic intensity or the utilization degree of (part of) the road network, about traffic congestion delays, about fuel consumption, about amounts of environmental pollution caused and/or related to payable traffic fees. A traffic information system might be used (exclusively or also) for the dissemination of information about for example distances, speed limits, traffic delays, outside temperatures, air pollution⁴ and/or reduced visibility (e.g. fog banks). ⁴ Think of (advanced) warning for extreme air pollution in, for example, tunnels. Air pollution is an example of usage conditions.

A traffic information system can be used for diverse goals, such as for:

The supporting of traffic management and control, in the broadest sense; think for example of traffic control, traffic census, the tracking of traffic flows and the measuring of their average speed, the determination of the distance between successive vehicles, the detection of traffic jams and the measuring of traffic delays, but also on determining and/or planning of the need for expansion of the infrastructure, because management (in the broadest sense) of the infrastructure falls within this too.

The improvement of traffic safety; for example, through continuous and (more) efficient speed controls, through immediate warnings for fog banks and/or through cruise controls with automatic respect for local speed limits, spread via transmitters.

The collecting of information about fuel consumption of vehicles in practice; the results could for example be divided into make, model, year, gearbox type, engine type, speed, acceleration, gear engaged, revolutions per minute, engine temperature, weather conditions, etc.

Determining as accurately as possible the environmental pollution caused by (a part of) the traffic: for example as an aid in the making of or compliance with agreements about reductions in environmental pollution.

The calculating and possibly also the charging of traffic fees; only price calculations, such as could be the case for travel per taxi or for insurance-premiums, or also the actual charging, such as could be the case for public transportation or traffic pricing; an important aspect in all this is the ability to introduce or improve proportionate pricing.

For improvement of law enforcement; for example, through automated detection all kinds of traffic violations, through automated and reliable identification, through association of traffic violations with individual persons for use in a penalty points system, through better automation and greater reliability of the settling of traffic fines and/or through quick and simple tracking to combat vehicle theft.

For support in managing, in a broad sense, a vehicle park⁵; for example, the vehicle park of a taxi car rental or transports company. ⁵ This example might be placed (in part) within the broad notion of traffic control.

### DETAILED DESCRIPTION

1.4 The TIP-system

The TIP-system⁶ is a traffic information system that can be used for all of the aforementioned goals, for each goal apart as well as for many or possibly even all goals simultaneously⁷. Due to its broad applicability, the TIP-system can be rightly called a multifunctional traffic information system. Because in the TIP-system (all or part of) the applications might also be compiled into one integrated, larger whole, one can also speak of an integrated multifunctional traffic information system. ⁶ We usually say ‘the system’, although actually it concerns a class of many systems with certain characteristics. ⁷ For clarity, we emphasize that one can also (want to) collect information about speeds and/or environmental pollution caused by traffic without using this information for law enforcement and/or traffic fees.

1.5 The Authority

Due to the many and diverse tasks that a TIP-system can perform, it is very well thinkable that multiple authorities (including official bodies, corporations, organizations, etc.) are involved in the diverse applications of a TIP-system. In such a case the TIP-system will most likely be managed and controlled by one or more of the involved authorities or by a separate authority, not directly involved in one of the specific applications. The manager/controller is (respectively, the joint controllers are) responsible for the TIP-system and for the services to the rest of the involved authorities. Control is here again meant (intended, supposed) to be seen in a broad sense and thus encompasses, among other things, maintenance, security. adaptation, expansion, keeping it operational. etc.

To keep our explanation simple we will in the following, when referring to one or more of the above-mentioned authorities (including the controller), often use the term the authority (or: an authority). The singular term authority can therefore be used to reference a certain separate authority, which is responsible for or has interest in a specific application, but also for all (or a part of) the involved authorities together. Sometimes we also use the paraphrase ‘information collecting and/or verifying authority’.

1.6 A Number of Desired Properties

A traffic information system must preferably have at least the following properties:

Being automated as much as possible; this is of importance, for example, with respect to speed (timeliness) and usage costs; fast collection and dissemination of recent information is of importance, as is avoiding staffing costs as much as possible.

Functioning without interfering with (i.e., disturbing) traffic; this is relatively easy to achieve, for example through the use of transmitters and receivers.

Being prepared for ‘growth’; to protect the investment the system should be adaptable and extendible (i.e. flexible), so that for example new applications can later be added relatively easily. (See also chapter 17.)

Providing for sufficient privacy protection; this particularly concerns privacy protection with respect to movement patterns, or hindering illegitimate tracing of individual, uniquely identifiable persons and/or vehicles⁸. ⁸ ‘Privacy protection with respect to movement patterns’ and ‘hindering illegitimate tracing’ mean the same to us. The addition of ‘with respect to movement patterns’ will often be left out and the addition ‘illegitimate’ will sometimes be left out. We also speak often of ‘prevention’ instead of ‘hindering’ or ‘not making practically doable.’ (See also the elucidation to claim 1 elsewhere in this chapter.) What exactly is meant will generally become apparent from the context.

Guaranteeing sufficient reliability (trustworthiness) of the gathered information; this concerns, for example, sufficient fraud-resistance, which is particularly of importance if the collected information is used to calculate and/or charge traffic fees.

In general the first two mentioned properties, at least for a large part, can be achieved in a rather obvious manner, namely by using computers, transmitters and receivers. Realization of the last two properties is much harder, certainly in combination. After all, keeping a certain amount of supervision is indispensable for, among other things, reaching (part of) the desired fraud-resistance. And for controls⁹ it is generally necessary to identify the controlled object. Thus, verification and identification generally go hand in hand. But unique identification of persons and/or vehicles during the gathering and/or verification of information forms a privacy threat, because this often enables or eases tracing of those persons and/or vehicles. Through this coarse reasoning we hope to have given enough of an explanation as to why performing controls (verifications, inspections, audits, etc.) generally becomes more difficult if at the same time privacy has to be protected (and vice versa). ⁹ The word control here is a synonym of or, formulated more precisely, is used by us as a synonym of audit, verification, inspection, supervision, and the like. Thus, the said controls encompass (also) audit, supervision, inspection and verification. As our emphasis usually is on the verification of the reliability (correctness) of certain information, we have decided to use mostly the word ‘verify’. Other words, like for example ‘inspect’, ‘check’, ‘audit’, ‘examine’, ‘monitor’, ‘supervise’ and ‘control’, are used (much) less often. In this text each of these words (i.e., these verbs, their corresponding nouns, etc.) is meant (supposed, intended) to encompass the meaning(s) of all the other ones as well, so all these words may be, and often are, used interchangeably.

1.7 Global Characterization of TIP-systems

Based on the above-mentioned elucidation we can state that traffic information systems will differ from each other in particular with respect to the methods used to provide for adequate verifications and/or privacy protection¹⁰. It should be no surprise that the TIP-system distinguishes itself from other traffic information systems mainly by these two aspects and the possibilities of combining them. For clarity we emphasize that the TIP-system gives the option of combining all of the mentioned properties. We are now ready for a first, concise characterization of the TIP-system. ¹⁰ Here privacy protection of course refers to the prevention, i.e. the hindering, of tracing.

The class of traffic information systems that belong to our invention, i.e. the TIP-system, is especially characterized by the way in which the following properties are provided:

The property that certain information about persons and/or vehicles, in particular also about individual persons and/or vehicles, can be gathered and (as far as necessary) can be verified (checked, etc.) on reliability by (respectively, for) the authority;

The property that the authority does not have to rely on the fraud-resistance of components in vehicles other than possibly in vehicles present agents (see below);

The property that (at the same time) illegitimate tracing of individual, uniquely identifiable persons or vehicles can be prevented.

1.8 Tracing

It should be clear by now that the last mentioned characteristic means that the information gathering and/or verifying authority generally does not need to get access, or reasonably cannot even get access, to information (considered to be privacy sensitive) about the movement pattern of a certain vehicle or a certain person of which the (respectively, whose) identity can be hunted down. More elucidation will be given in chapter 3.

1.9 Fraud-resistance and Verifications

In a strict sense, one can only speak of fraud-resistance if there are no possible means of fraud. In practice, one usually speaks of fraud-resistance as soon as there is resistance to all known, practically achievable, profitable forms of fraud that one wishes to be protected against. We use the term fraud-resistance particularly in this last meaning. We will go somewhat deeper into this term and its uses in chapter 4. There, we will also give a further explanation to the meaning of the term fraud-resistant when applied to an individual component.

Fraud by providing incorrect information in or from (within) a vehicle is hindered by verifying the received information. Verifications (checks) can therefore provide for at least part of the fraud-resistance. However, information can be incorrect not only due to fraud (attempts), but also in good faith due to e.g. inaccuracy or malfunctioning of certain equipment. Thus, checks on the reliability of information are useful for more than fraud prevention alone. Because the terms verification (reliability checking) and fraud prevention (fraud abatement) are closely related, they sometimes will be used in this text more or less as a kind of synonyms.

1.10 Agent

The term agent will be used for every hardware and/or software component that:

now and then actively performs in a vehicle one or more tasks for the authority, and

must be fraud-resistant (as seen from the standpoint of the authority).

At the risk of laboring the obvious, we mention that the last point implies already that the correct performance of the task mentioned in the first point is essential to the protection of the interests of the authority and therefore to the correct working of the traffic information system. In other words, an agent serves the interests of (respectively, represents) the involved authority in the vehicle and is a component of which the proper, i.e. not manipulated, functioning can and must be trusted by the authority, in particular also in an environment as formed by a vehicle that (from the standpoint of fraud prevention) can be considered to be an insecure environment. What an agent exactly is, or can be, will undoubtedly become clearer when reading the complete text. For tasks to be performed by an agent think, at least provisionally, of (partly or fully) exercising controls (i.e. supervising, checking, etc.) on the reliability of certain information supplied by other components in the vehicle. In chapter 18 the reader will find a rather extensive enumeration of tasks that can be performed by an agent.

1.11 Characterization of the Methods for the Hindering of Tracing

The methods by which a TIP-system can provide for privacy protection with regards to movement patterns is particularly characterized by the use of at least one of the following three elements:

Semi-identifications

Semi-identifications can, as we will demonstrate later, be used for privacy friendly gathering of certain information; for example, for fully automated and up to the minute precise determination of the current traffic delays. More in general, the use of non-unique semi-identifications helps to reduce the use of privacy threatening, unique identifications of vehicles and/or persons.

Agents

Agents can, as we will demonstrate later, be used for the gathering and verifying of all kinds of information in such a way that there is no or hardly any need for the use of privacy threatening, unique identifications of vehicles and/or persons.

Hunters and/or intermediaries

Hunters and/or intermediaries can, as we will demonstrate later, be used for collecting somewhere outside of a vehicle (i.e., in the outside world) information that has been transmitted from the vehicle and that does contain data uniquely identifying the person and/or vehicle in question, in a privacy protective way, i.e., in such a way that sufficient protection against illegitimate tracing is provided for.

1.12 Characterization of the Method for Performing Verifications (Audits)

The method by which in (case of) a TIP-system an authority can verify (check, etc.) the reliability of, and thus can hinder fraud with, certain information supplied to it in or from a vehicle, which (information) can particularly also include all kinds of meter readings, has two manifestations:

Only verifications by the authority from a distance: the interests of the authority then are sufficiently protected without any of the involved individual components in the vehicle (transmitter, receiver, sensors, meters, counters, connections. etc.) having to be fraud-resistant.

All or some of the verifications by the authority are done with the help of agents in the vehicles; the interests of the authority then are sufficiently protected without any of the other involved individual components in the vehicle (transmitter, receiver, sensors, meters, counters, connections, etc.) having to be fraud-resistant.

As we do wish not to interfere with (disturb, hinder) traffic unnecessarily, it seems plausible to carry out (at least part of) the necessary inspections from a distance, that is, to perform from outside of the involved vehicle all or part of the checking on the reliability of the information transmitted by that vehicle. The use of certain identification seems difficult to avoid (at the least) when verifying (only from a distance).

It will appear that the approach using agents offers more, respectively better, potentialities (prospects, possibilities) than the approach using only verifications from a distance¹¹. Yet one can achieve surprisingly much when using only remote verifications¹². Later chapters will give more details. ¹¹ This last approach we sometimes refer to (sloppily) as the approach without agents, even though strictly speaking this certainly is not the same. ¹² In this text ‘remote verification’ stands (just as ‘distant verification’) for ‘verification from (at) a distance’.

1.13 Charging Traffic Fees with the Aid of a Traffic Information System

As mentioned earlier, it is possible to use a traffic information system (also or exclusively) for traffic fees, under which head are at least also included tolls, traffic fines, license fees, insurance-premiums and parking fees. Because this is a very important application, we will now go deeper into this possibility. In this section the emphasis of our further elucidation lies on traffic pricing. Also in the further treatment and explanation in the coming chapters this application will often be the central theme. That we focus our attention primarily on traffic pricing has not only to do with its importance, but particularly also with the fact that this application is well suited to illustrate and explain a considerable portion of the possibilities that the TIP-system offers.

Traffic pricing may be used merely as a form of taxation, but for example also as an environmental protection measure and/or as a measure to improve the reachability (accessability) of certain areas at certain times. When using it as an environmental measure one wants, also in traffic jam free areas, to prevent the unrestricted growth of the amount of traffic or perhaps even to reduce the amount of traffic, because traffic participation always goes hand in hand with energy consumption and with a certain degree of environmental pollution.

Although from a qualitative perspective this last statement is absolutely correct, one may not forget that quantitatively seen there can be large differences in the degree of environmental pollution caused. Think, for example, of the differences between the various kinds of transport (for example cars vs. busses, but more in general for example air transport vs. transport via water or train traffic vs. road traffic), between the various kinds of propulsion engines (for example electric engines vs. combustion engines, but also the one type of gasoline engine vs. another type) and between the various kinds of fuel used (for example, solar energy vs. fossil fuels or Liquefied Petrol Gas vs. gasoline).

When imposing traffic fees it may, for example for the sake of justice, be a desired situation that all kilometers (or whatever distance units) are taxed and that kilometers traveled under the same relevant conditions (say, with exactly the same kind of vehicle, same speed, same kind of fuel, etc.), are taxed the same. Just suppose that in a certain country traffic pricing is introduced solely as an environmental measure. Then it would seem reasonable, for example, that kilometers traveled in an urban environment in that country are just as heavily taxed as kilometers traveled in a rural environment, at least if they are traveled under the same relevant circumstances/conditions (that is, in this case, with the same environmental consequences). After all, for the environment in a certain region it generally makes little difference whether the polluting exhaust-gases are produced in a rural or in an urban environment within that region.

But it may also be desired to indeed make the tariff, even in case of equal pollution, vary for each kilometer traveled, for example depending on the traffic intensity (i.e., the degree or amount of traffic; the term traffic intensity thus covers traffic way occupancy as well) or on time and place. This kind of tariff settings can be used, for example, to improve the reachability of certain areas at certain times, e.g. by combating traffic jams during rush hours.

In this text we prefer to keep aloof from a discussion about (the justice of) all kinds of reasons for (wanting) traffic pricing. We do remark, however, that it is beneficial for the general suitability (capability) of a traffic information system for imposing all sorts of traffic fees, if the tariff settings can be varied (chosen) in such a way that all kinds of possible wishes, among which the two mentioned above, can be met.

Therefore, it must preferably be possible to make the tariff for a traveled distance unit dependent on (respectively, it must be possible to ascertain reliable values of) as many variables as possible, like for example the date and time when (or more precisely formulated: the exact period wherein), the place (location) where and/or the traffic congestion when that distance unit was traveled, (a part of) the complete classification (or characterization or typing, i.e., the brand, model, year of make, gearbox type, engine type, and the like) of the vehicle used, the kind of fuel, the fuel consumption, the gear engaged, the amount of noise produced, the kind and amount of the environmental pollution caused, the average speed, the number of revolutions per minute (rpm), the speed change(s) and/or the rpm change(s) with which that distance unit has been traveled with that vehicle.

1.14 Possible Use of Derived Information

Between certain variables there exists a certain connection. For example, there exists for every vehicle of a certain year of make, type and model that is equipped with a certain gearbox type and engine type, a connection between the fuel consumption at a certain moment and a few other quantities at that same moment, like for example the outside temperature, the speed, the number of revolutions per minute and the acceleration. Something similar is valid for the amount of noise produced and for the amount of pollution caused. If such a connection is, also quantitatively, sufficiently accurately known, it can be used for sufficiently accurate determination of derived values, i.e., for sufficiently accurate calculation or deduction of certain quantities from other ones.

Sufficiently accurately derived values can be used in two ways, namely for verifications, i.e., comparison with an (as reported) actually measured value, or for leaving certain measurements undone. The first mentioned possibility is the case, for example, when the reliability of reported fuel consumption is being verified. The second mentioned possibility is the case, for example, if one determines the kind and amount of the air pollution caused at a certain moment by a certain motor vehicle without at that moment actually measuring and analyzing by the concerned vehicle the kind and amount of its exhaust-fumes¹³. ¹³ Although we assume that the actual measurement and analysis of the exhaust-gases of each vehicle is too expensive, it can in principle be done. However, the actual measurement from (within) a motor vehicle in traffic of the total amount of noise that is produced/caused by this same vehicle (thus including the noise from air rushing along the vehicle), seems impossible, also because of the possible vicinity of much other traffic. Rather accurate derivation (computation/deduction) of the total noise production of a vehicle from other data therefore seems to be even necessary (i.e., the only possibility).

1.15 A Characterization of the TIP-system when Used for Traffic Pricing

An important characteristic of TIP-systems (also) intended for traffic pricing is that all earlier mentioned wishes can be met. Characteristic for the verification method(s) used for such TIP-systems is, that particularly also fraud with (regard to) certain meter readings can be combated, so that the said traffic information systems can also collect reliable information about meter readings. This has as a consequence that the gathered information also can be used for a fraud-resistant implementation of continuous pricing. (In chapter 2 we will come back to this notion, which concerns a levy/fee whereby the total ‘consumption’ expressed in e.g. kilometers or e.g. in a certain environmental pollution unit can be charged.) Thus, the desire to be able to charge for all traveled kilometers (hectometers, miles, or whichever distance units) can also met, among other things.

In summary, the TIP-system thus encompasses, among other things, a class of systems for computing and possibly also charging traffic fees whereby all traveled distances can be charged, whereby the tariff per traveled distance unit (for example, per kilometer) can be varied in many ways, whereby also extra costs for the use of certain sections of roads (toll roads, bridges, tunnels, and the like) can be charged, whereby sufficient privacy protection and fraud-resistance can be offered and whereby (as we will show later) extensions, refinements or possible other changes can be easily be introduced later on. The tariff for a traveled distance unit can in case of the TIP-system be made dependent on all kinds of variables, like for example the traffic intensity, the type of the vehicle (i.e., brand, model, year of make, gearbox type, engine type, etc.), the sort of fuel, the fuel consumption, the gear engaged, the noise, the average speed, the number of revolutions, the speed changes and/or the rpm changes with which the distance unit has been traveled, and/or the date and time when (or more accurately formulated, the precise period in which) this distance unit has been traveled. A notable aspect thus is that it is possible to charge for all kinds of environmental pollution (like for example noise and air pollution) caused by the use of a certain vehicle, without actually having to analyze and measure by the vehicle in question continually the kind and volume of that pollution. For clarity, we here already emphasize that our system is not only suitable for continuous pricing, but also for other kinds of levies (fees), such as open and closed tolling (see chapter 2).

1.16 The Need for the TIP-system for Traffic Pricing

Currently in certain countries taxes are levied already in various ways on traffic in a wide sense. Think, for example, of taxes on the purchase, ownership and the use of vehicles. In case of these existing forms of traffic fees one can not or insufficiently take into account, for example, the amount, the places and the times of the use of a vehicle and the amount of the resulting environmental pollution.

For example, in case of the levying of taxes (duties) on fuel, which can be considered to belong to the third above-mentioned category of taxation, the amount of use really does play a role. But yet also this form of traffic pricing is clearly lacking. For, one cannot take into account, for example, the place and/or the time of use, nor the fact that a certain amount of fuel can be consumed in a more or in a less environmentally friendly way. Furthermore, there is the practical problem that the excises on fuels usually cannot be raised or lowered at will without creating serious problems. Think, for example, of the consequences for gas station owners in borderlands and of the possible loss of tax revenues due to legal and/or illegal import(ation) of fuel from a neighboring country. In short, the existing forms of traffic pricing can insufficiently meet yet the wish for more or better variability¹⁴. ¹⁴ If, for example, the type of a vehicle is used as a variable, one can relate the tariffs to the environmentally (un)friendliness of vehicles of that type. And so one can, via the tariffs, stimulate the purchasing of the most environmentally friendly vehicles in a much better addressed way.

There is thus really a need for a practically usable, effective and flexible system for the levying and/or the improvement of the variability of all kinds of traffic fees, like for example fees for the use of a vehicle (taking into account the amount, the places and/or the points of time of use and/or the amount of caused pollution) and for the use of certain sections of road (toll roads, toll bridges, toll tunnels, and the like), without having to violate the privacy of users or payers (when levying). The TIP-system is such a system. Besides, the TIP-system can also fulfil, among other things, the desire to be able to determine at any moment immediately (i.e., in real-time) traffic delays expressed in minutes (or in some other time unit) in a cheap and privacy friendly way.

1.17 Comparison with Existing Systems for Traffic Pricing

For traffic pricing already many systems have been contrived. Often this concerns toll systems whereby only toll is charged when passing certain toll points. Such toll systems thus only support the kind of levy that we will call open tolling (see chapter 2). Open tolling forms a rather coarse and narrowly (limited) usable means that in many cases will be lacking. It can be used for improving the reachability, but is not suitable for use as an environmental protection measure¹⁵. Furthermore, it is a disadvantage that use of open tolling often leads to all kinds of unfair situations. ¹⁵ We will not elaborate here on the arguments that this assertion is based on. We only note that open tolling can in principle even have a negative effect on the environment, because traffic will try to avoid toll points as much as possible.

Suppose, for example, that around a certain area a completely closed cordon of toll points is introduced as a measure to improve the reachability, i.e., in order to levy toll during rush hours (and thereby to discourage the access to that area with a motor vehicle) with the intention to relieve somewhat the road network within that area. In the sketched situation some people/vehicles may continuously criss-cross this area during the rush hours and thus continuously burden the road network in question after having paid toll only once (during rush hours to gain access to the area) or not even once (if they are already within the area before the rush hours begin). However, others do have to pay toll (respectively, have to pay the same amount of toll) for making only one short trip during rush hours. Or even have to pay toll several times for several short trips.

We know of no system that, just as the TIP-system, is fraud-resistant and also can apply per person and/or per vehicle many forms of continuous pricing, like for example in relation to the (total) fuel consumption, the (total) noise production and/or the (in total) caused environmental pollution. At the least we know of no single existing system whereby the noise and/or the emission or, more general, the environmental pollution caused by individual vehicles is computed rather accurately, let alone a system whereby such calculations play a role in charging traffic fees. Also we do not know of any system that can verify whether the in or from (within) a vehicle reported fuel consumption is correct, i.e., reliable. In short, as far as we know the TIP-system is unique with respect to the number of aspects about which reliable information can be gathered. (Think, for example, also of the traffic intensity.) As a consequence, the TIP-system is also unique with respect to the extent to which various forms of continuous pricing can be applied (respectively, with respect to the number of various forms of continuous pricing that can be applied).

There do exist a small number of systems that, just as the TIP-system, can be used for the application of the one specific form of continuous pricing whereby all traveled kilometers are charged. However, to the best of our knowledge it is true that all these systems (at least) either offer insufficient protection against tracing, or that they use a (relatively expensive) Global Positioning System (GPS), or that they are either insufficiently or less fraud-resistant, or that they have to make (more) extensive use of physical protection measures in order to reach a sufficient level of fraud-resistance.

1.18 Some Unique Aspects of the TIP-system

A unique aspect of the TIP-system is, therefore, that all kinds of continuous pricing can be realized and that can be taken care of good protection against fraud and against tracing of individual, uniquely identifiable persons and/or vehicles without the necessity of physically protecting the involved components in vehicles, other than possibly present agents, against fraud and without having to use GPS.¹⁶ ¹⁶ More concisely formulated, the TIP-system is unique because it is, as far as we know, the only system that is not positioning-based (i.e., is not based on determining positions by means of a GPS and/or an electronic roadmap) and at the same time indeed is suited for the fraud-resistantly imposing of continuous fees (like for example a kilometer fee).

Besides, the TIP-system has much more to offer. For example, the possibility to gather fully automatically and very privacy friendly the most recent information about traffic delays, which expressed in minutes are much more informative than information about traffic queues (tailbacks) expressed as lengths in kilometers. Further we mention here the possibility to identify vehicles in a privacy safe and/or fraud-resistant manner and to acquire better insight in the actual traffic flows, the possibility to systematically gather reliable data from practice, for example, about the in practice realized fuel consumption per vehicle type, and the possibility to effectively combat theft of vehicles.

1.19 Description and Elucidation of the Invention, Respectively the Claims

The invention is characterized by a method for the collection of traffic information by an authority

a) whereby there is made use of in at least part of the vehicles present means for supplying information,

b) whereby traffic information is derived directly or indirectly from (the receipt of) the information supplied from (within) vehicles,

c) whereby illegitimate tracing of individual persons and/or vehicles is hindered,

d) whereby the reliability (trustworthiness) of the information supplied in or from vehicles is verified in so far as is necessary,

e) whereby the authority does not have to trust on the fraud-resistance of individual components in vehicles other than possibly a per vehicle small number of agents, and

f) whereby one does not have to use a GPS (Global Positioning System).

Elucidation

Somewhat shorter (and less precisely) formulated, claim 1 describes (a method for) a fraud-resistant traffic information system that prevents illegitimate tracing and that does not require the use of a GPS.

The notion traffic information must be interpreted in the broadest sense, as has already been illustrated earlier in this introductory chapter. By traffic information we understand both collective and individual information. By collective information we understand information about collections of several persons or vehicles. Think, for example, of information about traffic flows and/or about average fuel consumption and the like. Individual information concerns information about individual persons and/or vehicles.

Individual information encompasses, among other things, vehicle information, personal information, usage information and circumstantial information. The term vehicle information is described in chapter 18 and personal information is self-evident. Usage information covers both information about the use of the vehicle (kilometers covered, pollution caused, point in time, etc.; see earlier in this introductory chapter for many more examples) and information about the driver and/or user and/or payer. Circumstantial information covers information about various circumstances during the use, like for example traffic intensity, weather conditions and air pollution.

Traffic information also encompasses information about the infrastructure. This kind of traffic information often is only disseminated by the traffic information system, but may also be partly collected via the traffic information system.

The term authority is used here and in following claims as described earlier in this introductory chapter. So, it is possible that the term represents (stands for) several authorities (including official bodies, organizations, etc.).

The term vehicles must be understood in such a way that it encompasses at least all possible means of conveyance. Note that if one wants to use the TIP-system for charging public transportation fares then in certain cases each passenger must be considered, i.e. act, as a virtual vehicle for the means for supplying information. For, the supply of the information then might occur before and/or after the entering of the actual, real vehicle of the public transportation system. (For example, when entering and/or exiting the platform.) Although a passenger then equally will take along with him/her into the actual vehicle the information supplying means in question, the communication with the authority then will not take place from within an actual vehicle of the public transporter, but from a passenger (i.e. from a virtual vehicle) outside the actual vehicle.

We have chosen for covering such possibilities via the explicitly in this elucidation clarified possibility (potentiality) to interpret the notion vehicle extra broadly. This choice has been made, as it is not easy to include such possibilities explicitly in the formulations without making these again more complicated, less clear and less understandable. As further illustration we sketch our best attempt. In the formulations (certainly of claim 1, but also in a number of other claims) then everywhere the broader notion ‘traffic participant’ should be used instead of vehicle(s). But, this notion (i.e., traffic participant) then at least does have to include both persons and vehicles.

As a consequence, point c of claim 1 then will contain the phrase ‘persons and/or traffic participants’. Note that only having ‘traffic participants’ in point c would be incorrect, as then the essence would be missed as soon as the traffic participants do not stand for persons, but for e.g. vehicles, as is the case, for example, in case of road traffic. Yet, the earlier mentioned, indeed correct formulation of point c does have a strange trait. After all, the traffic participants can, like in the above-described example in the context of public transportation, sometimes stand for persons. Therefore, the formulation of point c then actually will include the in itself correct, but yet somewhat strange phrase ‘persons and/or persons’. Anyhow, with the above example we hope to have elucidated sufficiently the big range (wide reach) of the formulation of claim 1.

By ‘in at least part of the vehicles present means’ we understand, among other things, means that are present only during the use of the involved vehicle (e.g. because a person who uses the vehicle, has got those means with him), and of course also means that have been installed in or at the vehicle involved.

By ‘means for supplying information’ we understand not only the means (like for example a transmitter) that are directly involved in the supply, but also means that are indirectly involved in the supply, such as particularly means necessary for the gathering and/or registering of all information necessary to obtain the information to be supplied. For example, these means can also include a receiver. For, assume that an agent (see below) is used for the supply to an authority of reliable information about, say, the odometer reading, and that the agent now and then verifies the precision of the kept odometer readings by means of reliable information supplied from the outside world via a transmitter, say, reliable information about the involved vehicle's speed at a certain moment. (See section 16.7.) Then the required receiver in that vehicle belongs to the means in question. At least all means being mentioned in the in chapter 5 given enumeration of possibly required elements and/or pieces of apparatus, can belong to the in a vehicle present means for supplying (information).

The information to be supplied encompasses at least all information from which traffic information in the broadest sense (see above) can be derived directly or indirectly. Of course, the information supplied from an individual vehicle in our context generally will relate to that one vehicle and/or that one vehicle's near environment and often will be already itself a form of individual traffic information. Think, for example, of information about that vehicle, about the use of that vehicle and/or about the circumstances when using that vehicle. Anyhow, in principle it may concern all information that can be gathered in an individual vehicle (and thus can be supplied from that vehicle).

The traffic information can be derived from the contents of the messages sent from vehicles or from the receipt. With the formulation ‘ . . . from (the receipt of) . . . ’ we want to emphasize this. The directly or indirectly derivable information thus also covers, for example, information that can be derived from one or more of the following observations: 1) that a message or a certain message has been received at all, 2) that a (certain) message has been received at a certain place (location), 3) that a (certain) message has been sent from a certain place, and/or 4) that a (certain) message has been received at a certain point in time.

The notion of illegitimate tracing has already been mentioned in this introductory chapter and is treated extensively in chapter 3. Thus here it concerns privacy protection in relation to movement patterns. Note that the restrictive qualification ‘illegitimate’ implies that prevention of legitimate tracing of persons and/or vehicles is not required¹⁷. We consider the tracing (in limited amount) of persons and/or vehicles of which the (respectively, whose) identity cannot be hunted down/out (tracked down/out), to be legitimate. So, in case of a traffic information system using the method described in this claim tracing really can be permitted, as long as the identities involved cannot be hunted down. Tracing apart from (i.e., behind the back of) the traffic information system cannot be prevented, of course. So, the word ‘hindered’ here must not be interpreted as ‘prevented’ in the strict sense of ‘made impossible’, but as ‘prevented’ in the more liberal sense of ‘made almost impossible’ or ‘not made practically feasible’, i.e. ‘not enabled’. ¹⁷ An alternative formulation for clause c is ‘ . . . can be hindered.’ However, because an operational system in general will (have to) meet the legal requirements, it may be assumed that not hindered (kinds of) tracing are legitimate. Therefore, both formulations come down to the same.

The formulation ‘information supplied in or from vehicles’ has been chosen because verifications on the reliability can be performed not only from a distance, i.e. outside the vehicles, but possibly also (fully or partly) in the vehicle by an agent. (Below there will be said more about the notion of agent.) If so, the information supplied to an agent in the vehicle is (fully or partly) verified and the agent then takes care of the supply of (more) reliable information from the vehicle to (the rest of) the authority in the outside world.

As has been explained already in this introductory chapter, the invention is characterized by, among other things, the way by which ‘the reliability (trustworthiness) of the information supplied in or from vehicles is verified in so far as is necessary’. As a further elucidation of what has been mentioned already in the previous paragraph we present here once more and explicitly the characteristic ways by which verifications can be performed. Either 1) information is transmitted from a vehicle (almost) continuously and samples taken at random from the transmitted information then are verified on reliability (trustworthiness) by the authority and outside the vehicle on the basis of independent observations/measurements (see also claim 8). Or 2) information is (almost) continuously supplied in the vehicle to (at least) one agent that now and then (for a random check) is contacted by (or contacts) a part of the authority in the outside world via a transmitter and/or receiver, and then based on independent observations/measurements verifications occur, either a) in the vehicle by the agent, which is informed by the involved part of the authority in the outside world about the independently ascertained values, or b) outside the vehicle by a part of the authority that compares the independently determined values with the values reported from the vehicle by the involved agent via a transmitter, which are based on the information supplied to him in the vehicle. (Hybrid forms are also possible; see, for example, claims 8 through 11 and the elucidation to these claims.)

With respect to the verification of the reliability of information we have added the restriction ‘in so far as is necessary’, mainly because it is not necessary to verify all information in order to attain (sufficient) fraud-resistance. Herewith we do not only aim at the fact that verifications usually are performed on random samples, but in particular also at the fact that correctness of all information does not have to be vital. As illustration and clarification of this last remark we point out the possibility (mentioned in chapter 8) to make only (semi-)identifications to be transmitted from (part of) the vehicles in order to be able to derive information about traffic delays. In this example it is in general not necessary to verify the correctness of the transmitted (semi-)identification of each vehicle. For, the desired information usually can be obtained even if the percentage of incorrect (semi-)identifications supplied is substantial. Furthermore, most traffic participants then generally will have no interest in supplying incorrect information.

For a further elucidation to the fraud-resistance of individual components we refer to chapter 4. Means in the vehicle, like for example transmitters, receivers, sensors, meters, counters and connections, thus do not have to be physically protected against fraud (so far as the authority is concerned), i.e. do not have to be fraud-resistant individually.

For the notion of agent we primarily refer to the description given earlier in this introductory chapter. Note that a component being fraud-resistant as seen from the viewpoint of the authority is called an agent only if that component now and then in a vehicle actively performs a task on behalf of the authority. So, a passive component, like for example a magnetic stripe or a stamped chassis number, cannot fall under this notion. Even not if, for example, the chassis number has been applied to the chassis or bodywork in such a way that it really is considered by the authority to be sufficiently fraud-resistant. For a further clarification of the notion of agent we refer to elsewhere in this introductory chapter and to chapters 16 through 18.

With ‘a small number’ we knowingly are somewhat vague, for one might use unnecessarily many agents. The most prominent numbers covered here are 0, 1 and 2. These three possible numbers are explicitly expressed in, respectively, the claims 8, 9 and 10.

The word ‘possibly’ is supposed (intended) to express extra clearly that also the absence of agents (i.e. zero agents) comes within (falls under) the description.

The words ‘does not have to’ are used to express that the use of a GPS is not necessary, but also is not excluded at all. A GPS can, for example, be used (as a help) to determine on behalf of the user which tariff is appropriate for the current location of the vehicle, in other words, to determine the locally valid tariff. Also, a sufficiently accurate GPS might be used to keep (without using a sensor on the drive shaft) an odometer and/or speedometer (tachometer). An important point is that in case of the TIP-system no information about successive positions of the vehicle needs to be given to the authority (which also includes its agents), let alone frequently. With existing traffic pricing systems based on the use of a GPS and/or an electronic road map, i.e., with existing positioning-based systems, (an agent of) the authority really must get frequently information about successive positions and is, as a consequence, the potential to trace by definition present in plenty. As possible abuse of position data for illegitimate tracing can also occur surreptitiously (for example, by means of so-called covert channels), in case of such systems there is always the question of a serious privacy threat.

In a preferred embodiment of a method according to the invention, reliable information can be collected about one or more aspects, which include individual information about, among other things, the distance covered, the place, the date, the point in time, the brand, the model, the year of make, the gearbox type, the engine type, the chosen gear, the number of revolutions, the speed, the speed changes, the kind of fuel used, the fuel consumption, the noise production and/or the environmental pollution caused, and collective information about, among other things, the traffic intensity, traffic queues, the fuel consumption, the noise production and/or the environmental pollution caused. (This is claim 2.)

Elucidation

With this claim we try to indicate the wide reach of the TIP-system with respect to the kinds of information that can be gathered and, as far as necessary, be verified on reliability. Now observe that continually it concerns information that in principle can be gathered. So, it is not true that every TIP-system actually has to (be able to) collect and verify all mentioned kinds of information. The here used notions of individual and of collective information have been introduced in the elucidation to claim 1. The more precise meaning of the concisely formulated enumeration has been made clear(er) already earlier in this introductory chapter by means of a more extensively formulated enumeration with some corresponding elucidation. To be quite on the safe side we mention here once more explicitly that the enumeration is not exhaustive. Note that the collective information can be divided (split up, itemized), if required, according to one or several of the (mentioned or not) aspects.

In a further preferred embodiment of a method according to the invention, the tracking of traffic flows and the determination of traffic delays can be performed automatically and in a privacy friendly way. (This is claim 3.)

Elucidation

With the tracking of traffic flows we particularly mean also the gaining of an insight into how traffic flows split up and join. It is thus necessary to be able to track individual vehicles in the traffic flow. Both tasks mentioned can be performed with the aid of semi-identifications transmitted from (within) vehicles. (See also the next claim.) Note that the aspect of privacy friendliness in fact is already included in claim 1 as well.

In a further preferred embodiment of a method according to the invention, semi-identification(s) is/are used. (This is claim 4.)

Elucidation

The term semi-identification here stands both for a semi-identification process and for a semi-identifying datum (respectively, a semi-identifying combination of data). These notions are treated in chapter 15. Semi-identifications can be used, for example, for the privacy friendly inspection of average speeds (i.e., privacy friendly trajectory speed traps), for inspections of the precision of meters and for certain tasks belonging to the denotation ‘traffic management’, like for example performing traffic census, tracking traffic flows, determining the average speed of traffic flows, determining speed differences between individual vehicles in a traffic flow, determining the distances between vehicles, detecting (incipient) traffic jams and/or determining traffic delays (in particular, delays due to traffic jams). Indirectly, this is, for example, also useful for traffic control and for determining and/or planning the need for expansion of the infrastructure.

In a further preferred embodiment of a method according to the invention, illegitimate tracing is hindered by using at least one organization that is independent from the authority. (This is claim 5.)

Elucidation

This claim does not only encompass the use of a hunter and/or intermediary, but also, for example, the use of an organization that provides for (the possibility to protect privacy by means of) a certain indirect identification. The indirect identification then concerns an identification that has been supplied semi-anonymously. (See chapter 13. The word identification here stands for an identifying combination of data, like for example an identification number.) To be quite on the safe side the use of a hunter and/or an intermediary is also covered by two separate, specific claims, namely claims 6 and 7.

In a further preferred embodiment of a method according to the invention, one or more hunters are used for at least part of the communication between vehicles and the authority. (This is claim 6.)

Elucidation

The notion of hunter is described in chapter 13 (and particularly at the end of that chapter). A hunter is an organization that controls at least part of the transmitting and/or receiving devices in the outside world (i.e., outside the vehicles) in aid of the communication between vehicles and (the rest of) the traffic information system and contributes to keeping the position of a person or vehicle as secret as possible, in particular at the moment of reception of a message from that vehicle. Primarily we here allude to a ‘pure’ hunter (see chapter 13), but secondarily also to a hunter that does perform at least part of the tasks of an intermediary as well.

In a further preferred embodiment of a method according to the invention, one or more intermediaries (acting as go-between during communication) are used for at least part of the communication between vehicles and the authority. (This is claim 7.)

Elucidation

The notion of intermediary is described in chapter 13 (and particularly at the end of that chapter). An intermediary is an organization that is independent of the authority and that for the benefit of privacy protection acts as a go-between during the communication from (within) vehicles with the authority.

In a further preferred embodiment of a method according to the invention, there is in at least part of the vehicles, also during their use, no agent required. (This is claim 8.)

Elucidation

For the vehicles without agent the possibly required verifications then must be performed from a distance, i.e., outside the vehicles concerned. This claim thus covers the case that for (a part of) the vehicles the approach using only remote verifications is being used.

In a further preferred embodiment of a method according to the invention, there is in at least part of the vehicles one agent required during their use. (This is claim 9.)

Elucidation

See chapter 16 and particularly sections 16.12 and 16.14. Note that here, for example, it has not been laid down (recorded) that the agent should perform verifications. If the agent does perform verifications, then still the agent does not necessarily have to perform all verifications. (See also the elucidation to claim 11.)

In a further preferred embodiment of a method according to the invention, there are in at least part of the vehicles two agents required during their use. (This is claim 10.)

Elucidation

See the elucidation to claim 9.

In a further preferred embodiment of a method according to the invention, all or part of the verifications of the reliability of the information supplied from a certain vehicle are performed fully or partly outside that vehicle, i.e., from a distance. (This is claim 11.)

Elucidation

This claim is particularly meant (supposed) to cover explicitly all possibilities whereby verifications occur that are performed fully or partly from a distance. Implicitly at least a number of these possibilities were covered already. For the sake of clarity we here explicitly recite four of the total number of possible situations: 1) the possibility that all verifications in relation to a certain vehicle are performed fully from a distance (this possibility actually was already covered indirectly, respectively implicitly, by claim 8.), 2) the possibility that all verifications are performed fully by one or more agents (this possibility was covered already by the claims 1, 9 and 10, but note that the claims 9 and 10 also cover cases whereby for a certain verification agents take care of only a part of that verification), 3) the possibility that in relation to one certain vehicle a certain verification is performed fully from a distance and also a certain (i.e., another) verification is performed fully by one or more agents, and 4) the possibility that a certain verification is performed partly from a distance and partly by an agent. For an example of the last mentioned possibility see chapter 16, and particularly section 16.3 and a number of sections following that section. This claim is meant (supposed) to explicitly cover possibility 1 and in particular also the possibilities 3 and 4.

In a further preferred embodiment of a method according to the invention, information is gathered about the fuel consumption of individual vehicles. (This is claim 12.)

Elucidation

Information about fuel consumption includes information about the speed of fuel supply (i.e., about the value indicated by a momentary fuel consumption meter) and about the reading of a total fuel consumption meter (i.e., fuel consumption counter). The information in question can be gathered, for example, in order to be able to derive data about the fuel consumption as actually realized by vehicles, analyzed or not into e.g. brand, model, year of make, gearbox type, engine type, speed, speed change, gear engaged, number of revolutions, engine temperature, air humidity, outside temperature, and the like. Or it can be collected for example to be used (also) for traffic pricing (see claim 18). Note that the gathered information can, if desired, be verified on reliability.

In a further preferred embodiment of a method according to the invention, information is gathered about environmental pollution caused by individual vehicles. (This is claim 13.)

Elucidation

This kind of information can be gathered, for example, to get a better view of the total environmental pollution caused by motorized vehicles or, for example, to use this information (also) for traffic pricing (see claim 18). Note that the gathered information can, if desired, be verified on reliability.

In a further preferred embodiment of a method according to the invention, information is gathered about noise caused by individual vehicles. (This is claim 14.)

Elucidation

This kind of information can be gathered, for example, to get a better view of the noise nuisance, respectively the traffic-noise, on certain road sections or, for example, to use this information (also) for traffic pricing (see claim 18). See e.g. sections 15.8 and 18.4. Note that the gathered information can, if desired, be verified on reliability.

In a further preferred embodiment of a method according to the invention, information is gathered about the gear engaged in individual vehicles. (This is claim 15.)

Elucidation

Note that the gathered information can, if desired, be verified on reliability. See also claim 28. This kind of information can be gathered, for example, to use this information (also) for traffic pricing (see claim 18).

In a further preferred embodiment of a method according to the invention, information is gathered about the number of revolutions of engines in individual vehicles. (This is claim 16.)

Elucidation

Note that the gathered information can, if desired, be verified on reliability. See also claim 28. This kind of information can be gathered, for example, to use this information (also) for traffic pricing (see claim 18).

In a further preferred embodiment of a method according to the invention, information is gathered about certain meters belonging to individual vehicles or persons. (This is claim 17.)

Elucidation

The meters can be of all kinds. Think, for example, of odometers, revolution-counters, and the like, but also of meters measuring (momentary or) total a) fuel consumption, b) noise production, c) environmental pollution caused, d) usage rights consumed, e) ‘levy points’ imposed, and the like. This kind of information can be gathered, for example, to get a better view of the total volume of the traffic with certain kinds of motorized vehicles or, for example, to use this information (also) for traffic pricing (see claim 18).

In a further preferred embodiment of a method according to the invention, the gathered information is used (also) for imposing traffic fees, i.e., for traffic pricing. (This is claim 18.)

Elucidation

The wide sense of the notion traffic fee has already been described earlier in this introductory chapter. Note that all three kinds of pricing mentioned in chapter 2 (open, closed and continuous tolling) are included. For a number of examples of tariff functions we refer to chapter 7. See claim 2 and the earlier text in this introductory chapter for examples of (verifiable) quantities that can be used as parameter(s) of a tariff function. See also claims 19 and 20.

Note: With tariff function we mean the same as with price function (see e.g. chapter 7).

In a further preferred embodiment of a method according to the invention, the tariff employed can be related to one or more of the following aspects: the distance covered, the place, the date, the point in time, the traffic intensity, the brand, model, year of manufacture, gearbox type, engine type, the gear engaged, the number of revolutions, the speed, the speed changes, the kind of fuel, the fuel consumption, the noise production and the environmental pollution caused. (This is claim 19.)

Elucidation

On the basis of claims 2 and 18 this claim is rather obvious. To be quite on the safe side we have chosen to formulate this claim also explicitly. See e.g. the text earlier in this introductory chapter for a somewhat more extensively formulated enumeration with (a part of) the corresponding elucidation. To be quite on the safe side we here emphasize once more explicitly that the enumeration is not exhaustive. (See possibly also the elucidation to claim 2.) The above is valid for open and closed tolling (discrete pricing) as well as for continuous tolling (continuous pricing).

In a further preferred embodiment of a method according to the invention, the gathered information is used (also) for continuous traffic pricing. (This is claim 20.)

Elucidation

Continuous (traffic) pricing is a specific form of traffic pricing. The notion of continuous pricing will be treated in chapter 2. The continuous pricing fee can be based, for example, on an odometer, a (total) fuel consumption meter, a (total) noise production meter, a (total) environmental pollution (equivalents) meter and/or any other traffic fee meter. In this way one thus can charge, for example, for all distances traveled, all fuel consumption, all noise caused, all environmental pollution caused, and the like. For a number of examples of tariff functions (price functions) we refer to chapter 7.

In a further preferred embodiment of a method according to the invention, at least part of the communication from a certain vehicle with a traffic information gathering, verifying and/or disseminating authority takes place via a transmitter (i.e., any means for transmitting) being present in and/or attached to that vehicle and a receiver (i.e., any means for receiving) being outside that vehicle. (This is claim 21.)

Elucidation

This claim describes that all or part of the communication between vehicle and an authority in the outside world can take place via transmitters and receivers. The passage ‘at least part’ has a double function, as it emphasizes: 1) that here the communication in one direction, viz. from vehicle to the outside world, is concerned, and 2) that not all communication has to take place via the means for transmitting and receiving.

In a further preferred embodiment of a method according to the invention, at least part of the communication from a certain vehicle with a traffic information gathering, verifying and/or disseminating authority takes place via a transmitter (i.e., any means for transmitting) being outside that vehicle and a receiver (i.e., any means for receiving) being present in and/or attached to that vehicle. (This is claim 22.)

Elucidation

For this claim the same is valid as for the previous one, on the understanding that now the communication from the outside world to the vehicle (i.e., in the other direction) is concerned.

In a further preferred embodiment of a method according to the invention, at least part of the means outside the vehicles for transmitting and/or receiving are mobile. (This is claim 23.)

Elucidation

This claim speaks for itself, on the understanding that the meaning of mobile should be taken ambiguously, namely both in the meaning of (trans)portable (say, movable) and in the meaning of being in motion (i.e., moving). So, this claim covers, for example, ‘reading’ vehicles ‘out’ from (within) a moving patrol car. Performing verifications from (within) a moving patrol car will be covered explicitly by claim 30.

In a further preferred embodiment of a method according to the invention, there is (also) dissemination of traffic information by an authority. (This is claim 24.)

Elucidation

This claim describes that the traffic information system concerned in this claim is (also) suited for the dissemination of traffic information. Note that traffic information also covers information about the infrastructure. Think, for example, of prohibitions to enter (drive in), speed limits and temporarily mandatory alternative routes (i.e., detours). Also the information that is sent to a vehicle e.g. for navigation or for the benefit of verifications in the vehicle by an agent (think of the earlier treated position and/or speed data), is covered by our wide notion of traffic information.

In a further preferred embodiment of a method according to the invention, semi-identifications derived from meter readings are used. (This is claim 25.)

Elucidation

The (total, i.e. incremental or decremental) meter in question can, for example, be an odometer, a consumption meter or a traffic fee meter. The only thing being essential is that the correct progress of the meter reading in question can be determined or predicted externally (i.e., outside the vehicle, thus from a distance) with sufficient accuracy. The meter in question may belong to the vehicle concerned or to the user or payer concerned. See also chapter 15.

In a further preferred embodiment of a method according to the invention, semi-identifications derived from the license number of each vehicle concerned are used. (This is claim 26.)

Elucidation

See also chapter 15 and particularly section 15.3.

In a further preferred embodiment of a method according to the invention, semi-identifications for each vehicle randomly chosen from a set of elements are used. (This is claim 27.)

Elucidation

See also chapter 15 and particularly section 15.3.

In a further preferred embodiment of a method according to the invention, the information supplied in or from (within) a vehicle is verified on reliability and the (supplied and) verified information concerns at least information about one of the following aspects: the odometer reading, the speed, the gear engaged, the number of revolutions, the fuel consumption, the noise production and/or the environmental pollution caused. (This is claim 28.)

Elucidation

For verification one needs external ascertainment of the right information. Note that odometer readings and speed indications are related to each other and thus are, in a certain sense, mutually interchangeable data. (See also section 11.10.) Of course, something similar is valid for a momentary and a total (i.e., incremental) fuel consumption, noise production or environmental pollution meter. In this text, revolution-counter stands usually not only for ‘momentary number of revolutions per minute (i.e., rpm) meter’ (as is common), but also for ‘total number of revolutions meter’. How the odometer reading and/or the speedometer indication can be verified is explained in chapters 11 and 16. In other words, external ascertainment of the length of a certain trajectory or of the speed at a certain moment is easy and (how to do this is) well-known. The gear engaged can externally be ascertained (and thus verified) via speed measurement(s), speed change measurement(s) and directional noise production measurement(s), while also reliable information about the vehicle type is required. How the number of revolutions per minute and the momentary fuel consumption can be determined externally is described in section 11.7. In section 11.8 is explained how the noise production can be ascertained. The use of derived information already was elucidated earlier in this introductory chapter. In a further preferred embodiment of a method according to the invention, an agent performs verifications in the vehicle with the help of externally ascertained, reliable information supplied to him. (This is claim 29.)

Elucidation

See chapter 16. How the required reliable, i.e. correct, information can be ascertained externally has already been elucidated with claim 28 for a number of kinds of information. For e.g. place (location), date and point in time the external ascertainment needs no further elucidation. How forwarded, reliable position or speed data can be used for verifications on odometer readings and speed indication, is described in chapter 16. Checks on speed changes can be performed similarly. (See also section 11.10.) Also verifications on, for example, number of revolutions, noise production, fuel consumption and the like are sufficiently described elsewhere in the text. The externally ascertained (determined) and reliable information supplied to the agent may also comprise an algorithm for computing derived information. For further elucidation to the use of derived information we refer, for example, to section 1.14 of this introductory chapter.

Note that this claim also covers continuous surveillance (supervision) on traffic behavior (like for example the in section 1.3 already mentioned continuous speed checks/controls). See also section 16.8 and point 5 in section 18.1.

In a further preferred embodiment of a method according to the invention, verifications are performed from (within) mobile checkpoints (checking stations). (This is claim 30.)

Elucidation

Here we mean with mobile not only movable, but in particular also moving. This claim thus covers, for example, checking from (within) moving patrol cars. Flying checkpoints (checking stations) may be attractive because of, for example, the surprise effect that can be attained.

In a further preferred embodiment of a method according to the invention, trajectory speed checks are performed in a privacy friendly way. (This is claim 31.)

Elucidation

With a trajectory speed check (respectively, trap) we mean the checking of the average speed that a vehicle has traveled with between two points. The average speed realized is computed from the length of the trajectory (i.e., from the length of the route traveled between the two points) and from the time difference between the passing of the two points. With privacy friendly we mean that (unique) identification of the person (respectively, payer) and/or of the vehicle in question will take place only for those vehicles that have exceeded the speed limit. The meaning of payer will be treated in chapter 5.

In a further preferred embodiment of a method according to the invention, a correct indication of time is disseminated and in at least part of the vehicles at least one clock will be adjusted automatically, in particular when passing from one time zone to another or when changing from summertime to wintertime or vice versa. (This is claim 32.)

In a further preferred embodiment of a method according to the invention, a quota system is used, whereby the consumption rights are tradable (negotiable) or not. (This is claim 33.)

Elucidation

Consumption rights stands also for usage rights and ‘pollution rights’. Usage rights can be expressed, for example, in kilometers and ‘pollution rights’ can be expressed in some environmental pollution unit.

In a further preferred embodiment of a method according to the invention, some or all deviating, possibly not (anymore) correctly functioning vehicles and/or vehicle equipment are tracked down. (This is claim 34.)

Elucidation

For the notion of vehicle equipment see chapter 5. The deviation can be caused, for example, by a defect, by wear, by bad tuning or by an attempt to defraud.

In a further preferred embodiment of a method according to the invention, vehicles can be tracked down on authorized request. (This is claim 35.)

Elucidation

See chapter 12.

In a further preferred embodiment of a method according to the invention, software can be distributed, installed, and/or put into operation via the traffic information system. (This is claim 36.)

In a further preferred embodiment of a method according to the invention, an agent verifies fully or partly the reliability of a measuring-instrument or counter (i.e. meter) in the vehicle concerned. (This is claim 37.)

Elucidation

See chapter 16. There we show that checking of, for example, an odometer can also be performed partly by an agent.

In a further preferred embodiment of a method according to the invention, there is made use of agents existing of a chip with a processor and memory that, at least for a part, is sufficiently protected against (illegitimate) reading and against modification of data stored therein and/or against modification of the software used by that chip. (This is claim 38.)

Elucidation

Although software in principle can be considered to be data as well, it here has been mentioned separately, because the software does not have to be protected against reading. For the data protected against reading and modification (and thus also against writing) think of, for example, meter readings and/or cryptographic keys.

In a further preferred embodiment of a method according to the invention, data are gathered about certain performances of vehicles actually realized in practice under certain usage conditions and these gathered data are worked up, or not, into information about certain performances of certain groups of vehicles under certain usage conditions. (This is claim 39.)

Elucidation

With usage conditions we mean here, for example, all aspects belonging to usage information and to circumstantial information, both of which categories have been described in the elucidation to claim 1. Think, for example, of the gathering of data concerning fuel consumption and processing these data into information about the fuel consumption level under certain usage conditions, such as in case of a certain speed, gear engaged, acceleration, outside temperature, and the like.

In a further preferred embodiment of a method according to the invention, the data gathered in practice are used for finding/determining an algorithm for computing derived information. (This is claim 40.)

Elucidation

An algorithm can, for example, be expressed in any natural or computer language or, for example, as one or more tables. It can be used, for example, for verifications or for use in new measuring-instruments.

In a further preferred embodiment of a method according to the invention, an algorithm for computing derived information is used to determine the fuel consumption and/or the noise production of an individual vehicle, whether or not to be used for the benefit of verifications/inspections. (This is claim 41.)

In a further preferred embodiment of a method according to the invention, an algorithm for computing derived information is used to determine the quantity of (a certain form of) environmental pollution caused by an individual vehicle. (This is claim 42.)

In a further preferred embodiment of a method according to the invention, cruise control equipment in a vehicle makes use of information about speed limits that has been disseminated outside the vehicle and has been received by equipment in the vehicle. (This is claim 43.)

Elucidation

The information disseminated about a speed limit may exist of an absolute indication of the speed limit or of the (relative) change from the previous speed limit to the new one. (In the latter case it concerns the difference in speed limits on the borderline between two connected areas that each have their own speed limit.) Cruise control equipment may (on request of the driver) use the information about the locally valid speed limit for automatic respecting of speed limits.

In a further preferred embodiment of a method according to the invention, the information gathered and/or disseminated by means of the traffic information system is used for calibrating measuring-instruments. (This is claim 44.)

Elucidation

See section 12.1. This claim does not only cover calibration of instruments whether in a vehicle or outside the vehicles, but also covers the case of mutual (reciprocal) calibration. Think, for example, of calibration of clocks, outside temperature gauges (i.e. thermometers), air humidity meters (i.e. hygrometers), noise (production) meters, speedometers and odometers. In case of the latter two examples one thus can banish the inaccuracy due to tire wear.

In a further preferred embodiment of a method according to the invention, an agent is (also) used for fraud-resistant identification of the vehicle in which that agent, whether attached in a fraud-resistant way or not, has been placed/installed. (This is claim 45.)

In a further preferred embodiment of a method according to the invention, the correctness of the meter reading(s) supplied is verified by checking random samples fully or partly from a distance (i.e., remotely). (This is claim 46.)

Elucidation

That meters can be verified, if desired, fully from a distance, will be illustrated in chapter 11. That meters can be verified, if desired, partly from a distance, will be illustrated in chapter 16 using odometers as example. Think, in particular, of various verification aspects, such as verification of precision and verification of monotony.

In a further preferred embodiment of a method according to the invention, audiovisual (i.e., audio and/or visual) means have been installed in a vehicle to render at least part of the information. (This is claim 47.)

In a further preferred embodiment of a method according to the invention, at least part of the disseminated information is used (also) for navigation. (This is claim 48.)

The invention also refers to a traffic information system using a method according to the invention. (This is claim 49.)

The invention also refers to a traffic information system according to claim 49 that is prepared for adaptations and extensions. (This is claim 50.)

The invention also refers to a vehicle suited for (use with) a method according to the invention. (This is claim 51.)

The invention also refers to an agent suited for (use with) a method according to the invention. (This is claim 52.)

Elucidation

An agent is a hard- and/or software component that is considered by the authority to be fraud-resistant.

The invention also refers to a hard- and/or software component suited for use as ‘vehicle-related processor’ for a method according to the invention. (This is claim 53.)

Elucidation

For the notion of ‘vehicle-related processor’ see, for example, chapter 17. This component will (very likely) be some data-processing device that consists of a processor with memory and software and that does not have to be fraud-resistant. The vehicle-related processor is primarily intended for performing tasks on behalf of the holder (and maybe also on behalf of the user) of the vehicle. It might (also) perform certain tasks on behalf of the authority, at least if the authority allows those tasks to be performed on behalf of itself by a not fraud-resistant component, i.e., if the authority does not adhere to a really good protection against fraud. See, for example, chapters 5 and 17.

The invention also refers to a user card suited for (use with) a method according to the invention. (This is claim 54.)

Elucidation

The notion of user card has a wide sense here. A user card thus also includes, for example, a consumption card. See chapter 5.

The invention also refers to a rolling tester for the (further) inspection of the functioning of vehicle equipment that is used (also) for the sake of a method according to the invention, respectively is used (also) for the sake of a traffic information system according to the invention. (This is claim 55.)

The invention also refers to a reliable taximeter using (or used for) a method according to the invention. (This is claim 56.)

Elucidation

The adjective ‘reliable’ (trustworthy) here does not only concern the fraud-resistance of the equipment itself, but particularly also the verification of the correctness of (part of) the data supplied. (See chapter 18.)

The invention also refers to a reliable tachograph using (or used for) a method according to the invention. (This is claim 57.)

Elucidation

The adjective ‘reliable’ here does not only concern the fraud-resistance of the equipment itself, but particularly also the verification of the correctness of (part of) the data supplied. (See chapter 18.)

The invention also refers to a reliable ‘black-box’ using (or used for) a method according to the invention. (This is claim 58.)

Elucidation

The adjective ‘reliable’ here does not only concern the fraud-resistance of the equipment itself, but particularly also the verification of the correctness of (part of) the data supplied. (See chapter 18.)

1.20 Elucidation to and Overview of the Further Contents

In the following we will treat step by step all kinds of aspects of the TIP-system and in particular also explain how one thing and another work. In our treatment we will concentrate mainly on the use of a TIP-system for traffic pricing in case of road traffic and for road pricing (in a wide sense, i.e., inclusive congestion and pollution pricing) more in particular. We do this not only because this is an important application, but also because with this application the TIP-systems characterizing ways of verification and of privacy protection can stand out clearly well. After all, protecting privacy and combating fraud are in case of road pricing, and of traffic pricing more in general, obviously of great importance. Now and then aspects and applications that are not or not directly related to road pricing or, more general, traffic pricing, will be addressed in passing (between-whiles).

We use now and then a concrete example and do sometimes mention a number of possible variations. The given examples and variations serve, as already remarked earlier, only as an illustration and should not be understood as imposed restrictions. As already has been remarked earlier in a footnote, we also often speak of the TIP-system, although it-actually concerns a class of many systems with certain characteristics.

Our explanation occurs more or less in two phases by describing in the first instance an approach without and then (not until almost at the end) one with use of agents. Unintended our explanation (whether or not partly by doing so) perhaps conceals somewhat that there is a whole range of possibilities to realize a TIP-system with the aid of the described techniques and that for the various realizations elements of both more explicitly described approaches might be combined.

For further orientation on the complete text we here give an overview of all chapters:

1. Introduction

2. Kinds of fees and tariff systems

3. Tracing

4. Fraud-resistance

5. Equipment (apparatus)

6. Cryptography

7. Administration (book-keeping)

8. Use of a transmitter

9. Security of messages

10. Identification numbers in messages

11. Verifications (inspections)

12. Use of a receiver

13. Privacy protection

14. Identification

15. Semi-identification and its applications

16. An approach using agents

17. Preparation for ‘growth’ of the system

18. TIP-systems

19. Claims

2 Kinds of Fees and Tariff Systems

One can distinguish several kinds of fees (levies), respectively tariff systems. In this text we use a classification whereby a distinction is made between open tolling, closed tolling and continuous pricing.

In case of open tolling (pass-by tolls) the fee is charged based on gauging only once, in particular when passing certain borderlines, whether or not in the direct environment of a certain (tolling) point. Examples are import and export taxes (customs duties) on traffic of goods when passing national borders, lock and bridge fees for ships and the charging of tolls for tunnels or bridges in case of road traffic. Other examples are formed by certain fare-stage systems, which are used, for example, for several forms of public transport. The tariff with those systems has to be pre-paid and depends on the number of borderlines between zones that one passes. Note that one usually also has to pay for transport within one zone. i.e., when no border between zones is passed. But, in this case one does pass a borderline when entering the transport system, in particular when entering the public transport vehicle or the platform.

In case of closed tolling (pass-through tolls) the fee is based on gauging twice, e.g. to charge for traveling a certain trajectory (passage) between a certain starting-point and a certain end-point, whereby the precise route actually traveled has no influence on the payable fee. Examples are formed by certain tariff systems used for public transport or road pricing, whereby for each passenger, respectively for each vehicle, both the place of entrance to and the place of exit from the public transport system, respectively the involved road or road network, are used to determine the correct fee. If several routes are possible between the points of entrance and exit, then the choice for a particular one should have no influence on the fee. If the chosen route does have influence, one usually has to do with a form of open tolling or continuous pricing.

In case of continuous pricing¹⁸ gauging occurs almost continuously, in particular to be able to charge for one's total usage or turnover, expressed in, for example, kilometers (miles), liters (gallons) of fuel, minutes, dollars or some environmental pollution unity. Examples are income tax, sales tax and kilometer tax. ¹⁸ Open tolling and closed tolling were examples of discrete pricing. The essence of continuous pricing is that, in order to able to charge for one's total relevant ‘behavior’, now and then (almost) continuous measurement is required, i.e. that a (very) large or even an (almost) unlimited number of points in time are of interest for correct measurement.

As already somewhat exemplified by the above, it is not always easy to correctly classify a tariff system as an open, closed or continuous tolling system. Nevertheless we assume that all this is sufficiently clear for our purpose, namely the description and explanation of various aspects of the TIP-system.

3 Tracing

As has been remarked in the introduction, the TIP-system is among other things characterized by the way in which provisions can be made for the property/attribute that (when collecting and/or verifying information about persons and/or vehicles) illegitimate tracing of individual, uniquely identifiable persons or vehicles is not made practically doable. By this we mean that the information collecting and/or verifying authority in general does not need to get access, or reasonably not even can get access, to (considered privacy sensitive) information about the movement patterns of a certain vehicle or person of which the identity can be tracked down.

The last part of the previous sentence is of importance, because tracing of permanently anonymous, i.e. not identifiable, vehicles and/or persons presents no danger to the privacy. This formulation does not only cover the situation that the identity can be determined via the traffic information system, but also the situation that the identity can be tracked down (possibly later) in another way. Notice that unlimited, complete tracing of an as yet not identifiable person or vehicle presents a considerable danger, because there is then a real chance of later identification. The privacy threat resulting from an as yet anonymous tracing will become smaller as the maximum duration and/or distance to which such a tracing is limited, becomes smaller. When there is a sufficient restriction on the said duration and distance, then there is no real danger for the privacy or, more precisely, the danger for the privacy may be found/thought to be acceptable.

In such a case we speak of legitimate tracing. It should be clear that this is fully justified by looking at the current practice. After all, when any citizen sees a car pass by (i.e. does trace that vehicle for a rather limited time and distance) and next determines the identity of that vehicle (usually correctly) by reading the license plate, it is generally accepted that this is in no way an illegitimate tracing.

The addition of the word ‘illegitimate’ in the formulation of the mentioned property has also a second reason. Often one wants to prevent that tracing can occur unrestrictedly, while at the same time one does really want tracing to become possible in certain (preferably in law embedded) circumstances and under certain (preferably in law embedded) conditions. On the one, hand think for example of trajectory speed traps, whereby the average speed of a vehicle over a certain trajectory (distance) of, say, several kilometers is determined by identifying a person or vehicle both at the beginning and at the end of that trajectory (distance) and by determining the time elapsed between both identifications. In this example the size of the traveled trajectory (distance) is usually rather limited, so that this example perhaps is not sufficiently convincing. Therefore on the other hand, think for example also of the possible tracking down of stolen vehicles or even the possible tracing of big-time criminals.

In chapter 15 we will show that by means of semi-identifications vehicles can be traced well enough to enable for example trajectory speed traps or even measuring traffic congestion delays without really endangering privacy. These forms of tracing we would therefore like to entitle as legitimate. (Let it be clear that, first, it is about a decision/weighing between the practical usefulness and the danger, and that, second, we think that the danger is sufficiently small enough to justify turning the scale in favor of the practical usefulness. How small the danger is, one can judge for oneself after reading of chapter 15.)

In closing we here superfluously repeat the earlier in a footnote given remarks about our use of various formulations. In this text ‘privacy protection with respect to movement patterns’ and ‘hindering illegitimate tracing’ mean the same. For convenience, the addition of ‘with respect to movement patterns’ will often and the addition ‘illegitimate’ will sometimes be left out. We also speak often shortly of ‘prevention’ or ‘hindering’ instead of ‘not making practically feasible.’ What exactly is meant will generally become apparent from the context. The cumbersome formulation ‘not making practically feasible’ has been mentioned earlier (and is mentioned here again) because of its greater accuracy compared to ‘prevention.’ After all, as is apparent from the above given examples, tracing is already possible to a certain extent anyhow and a traffic information system of course cannot prevent such tracing behind its back.

4 Fraud-resistance

Strictly speaking one can only speak of (absolute) fraud-resistance if no kind of fraud at all is possible. In practice one often speaks already of (sufficient) fraud-resistance if there is resistance to every known, practically feasible and paying form of fraud against which the interested party wishes to arm itself. After all, it is in general difficult to arm oneself against all as yet unknown forms of fraud. And sometimes one does not wish to arm oneself against certain known forms of fraud, because the risk of unacceptable damage is reckoned to be too small (whether in proportion to the costs of protecting against it or not).

We use the term particularly in the second meaning. In this text the interested party, i.e. the one who wishes to arm himself against fraud, is mostly the authority and we therefore generally view fraud-resistance from the viewpoint of the defense of the interests of (the traffic information system respectively) the authority. That interest includes particularly the correctness of certain information that is collected. By means of checks on the reliability of that information we can provide for (at least part of the) fraud-resistance.

With the above we think we have made sufficiently clear what fraud-resistance means. In particular it should now be sufficiently clear what we mean by a fraud-resistant traffic information system¹⁹. However it seems useful to go somewhat further into the application of the term to an individual component. We make an attempt to create extra clarity by giving below a supplementary, more detailed and informative description of the concept of fraud-resistance applied to an individual component. ¹⁹ We concentrate our attention (almost self-evidently) on the fraud-resistance of components in the vehicle and of the communication via transmitters.

In this text, an individual component (in a vehicle) is in general called fraud-resistant if that component is inherently (!) protected in such a way that it cannot reasonably be forged, i.e. if it is in itself protected in such a way that it does not pay or is not practically feasible to forge that component. With forging is not only meant the making of a (deceptive) imitation, but also the manipulation of that component (at the expense of the authority as interested party). With respect to this last point think, for example, of (for the authority) negatively influencing the functioning of the component (excluding destruction) or pilfering crucial information (like for example a cryptographic key) from the component.

For example, a magnetic card is thus not fraud-resistant, not even when the information stored in it is protected by cryptographic techniques. After all, making an imitation is in case of a magnetic card relatively easy, because the bit patterns on a magnetic card can be read without too many problems. Furthermore, it is true that a magnetic card is not protected in itself against manipulation, because reading, writing and/or changing its bit pattern is rather simple. So, it does not matter that the total system (that makes use of the magnetic card in question) might do indeed protect itself with the use of cryptographic techniques against certain forms of fraud with magnetic cards, like for example against comprehensive reading or meaningfully changing the bit pattern on it. For other passive means for data storage something similar applies, of course.

Note that with certain electromagnetic devices (aids), like for example magnetic and chip cards, there can generally only be an imitation if one manages to copy or produce certain crucial bit patterns (that for example are a representation of software or data, which particularly also include cryptographic keys). To be able to copy or produce such crucial bit patterns, it is usually necessary to worm these or other crucial bit patterns out of one or more authentic specimens first. But then there is first a question of manipulation of an authentic specimen at the expense of the authority. In short, manipulation at the expense of the interested party is generally the dominant form of forgery with electromagnetic means in general.

Also note that with the fraud-resistance of an individual component, the physical security (protection) in general plays a dominant role and is the decisive factor. On the other hand, in a larger whole, like the total traffic information system, logical protection measures (like for example the application of cryptography, inspections and organizational measures) do play a major role. When evaluating individual components for their own fraud-resistance, the logical protection (security) in the larger context does not count. This in a way adds to the dominant role that physical security (protection) plays in case of considering individual components.

Further we like to elucidate somewhat that the choice of the viewpoint, i.e. the choice of who is the interested person/party, plays a role. Suppose that users of a certain system have to identify themselves by putting digital signatures and that they use some aid(s), for example in the form of magnetic or chip cards, when doing so. (See also the chapters 6 and 14.) From the viewpoint of each owner of an identification aid, his own identification aid then must preferably be fraud-resistant to prevent that someone else can take advantage of his digital signature in any way. But from the viewpoint of the authority (of the system) the identification aids do not need to be fraud-resistant at all, because in principle every correct signature can be accepted. The way by which the signature has been created (whether or not by using an aid, authentic or false), does play no role in the validity of digital signatures.

There is yet another, at least as important aspect (concerning the choice of the viewpoint) that deserves attention. Suppose that the identification aid is not protected against, for example, manipulation or copying. From the viewpoint of the owner the aid is then not fraud-resistant, because his interests can be damaged (particularly by copying). The owner will then have to be really careful with it. In our example it is solely the responsibility of the owner to prevent abuse of his identification aid and the interests of the authority are not impaired by forgeries. Thus, from the viewpoint of the authority the said identification aid is in a certain sense ‘fraud-resistant’, because no fraud at the expense of the authority can be committed with it. (At least not directly at the expense of the authority, but maybe indirectly. See also the end of this section.)

In general, a component of which the fraud-resistance does not matter, will not be called fraud-resistant. In the above given description our addition of ‘inherent’ (respectively, ‘in itself’) plays a role in this. Despite all the effort that we have taken to find a formulation that is as close as possible, also our formulation is probably not completely waterproof. Finding a waterproof formulation is usually at least difficult or even impossible. But with the given elucidation one thing and another is deemed to be sufficiently clear. (Of course this remark is not only valid for the in our case important notion of fraud-resistance, but also for all other notions that we use and that are of importance, like particularly tracing, agent, semi-identification, and the like.).

Finally we make yet two remarks about the example above. In the example above it might seem that only the card holder in question and the authority could be regarded as interested parties. That possible impression is wrong. All other card holders are to a certain extent interested parties as well. For, all card holders have an interest in the fact that the authentic card of somebody else cannot be manipulated (i.e. forged) in such a way that their own digital signature can be put with it (by someone else). So, fraud-resistance from the viewpoint of other card holders can also be of importance.

Besides, it can (and usually it will) be the case that the authority (even if a different authority is responsible for the identification aids in question) does really have an (indirect) interest in the fact that card holders cannot cheat each other too easily. After all, this might result in the users turning away from the authority's system (or wanting to turn away), i.e. not wanting to use it (any longer).

5 Equipment (Apparatus)

5.1 Overview of the Tasks of the Vehicle Equipment

In first instance we will restrict ourselves (for a moment) to tasks related to traffic pricing. We assume that in each participating vehicle equipment (apparatus) will be present during participation in traffic to perform the required tasks. This vehicle equipment (VE) will in case of the TIP-system then often perform the following tasks: 1) keeping (holding), measuring and/or reading certain, for the working of the TIP-variation in question necessary data in relation to the vehicle, its movement, fuel consumption, exhaust-gases or the like, 2) keeping one or more (total) meters up-to-date according to a prescribed algorithm and on the basis of the required data, 3) transmitting certain, prescribed data, like for example speed or odometer reading, which are necessary for the traffic pricing and/or the verification on the correct functioning. If the vehicle equipment includes a receiver, in general also: 4) reacting adequately on requests, respectively commands that are received from the authority (i.e., from authorized organizations).

5.2 Required Vehicle Equipment

For a TIP-system certain equipment must be present in each participating vehicle. Usually only part of the below mentioned means and/or elements are necessary.

1) A small number of processors with corresponding/accompanying memory, among which also a quantity of non-volatile memory (i.e., memory that is protected against power failures or memory of which the contents anyhow remains unimpaired in case of a power failure) for preserving essential software and data, like for example algorithm(s) for derived information, meter readings and/or cryptographic key(s).

2) (A connection to) a transmitter and/or a receiver for communication with the outside world.

3) A number of (connections to) sensors and/or measuring instruments in the vehicle to be able to ascertain or read out all sorts of data, like for example the number of revolutions and/or the odometer reading.

4) (A number of connections to) other equipment in the vehicle with which can be communicated and/or cooperated, like for example a cruise control.

5) (A number of connections to) equipment for communication with users, like for example a display and/or a speaker for supplying information to users of the vehicle and e.g. a microphone for receiving information from users (voice-input).

6) A number of (preferably standardized) connection points (points of junction, including connectors), like for example magnetic or chip card readers, for making a connection to loose, to be connected equipment, like for example a by or on behalf of the payer to be brought in consumption pass and/or user card, which for example encompass a meter reading and/or an identification device.

7) A (preferably standardized and central) connection point (connector) for making a correct mutual connection between all equipment²⁰. ²⁰ This connection point may be used also for the connection of (part of) the equipment to a power supply. As the need for a power supply is self-evident, we have not mentioned a whether or not central power supply, like for example the battery of the vehicle or separate batteries, when enumerating the possibly required vehicle equipment. Also in the following we will pay (almost) no attention to this rather obvious aspect.

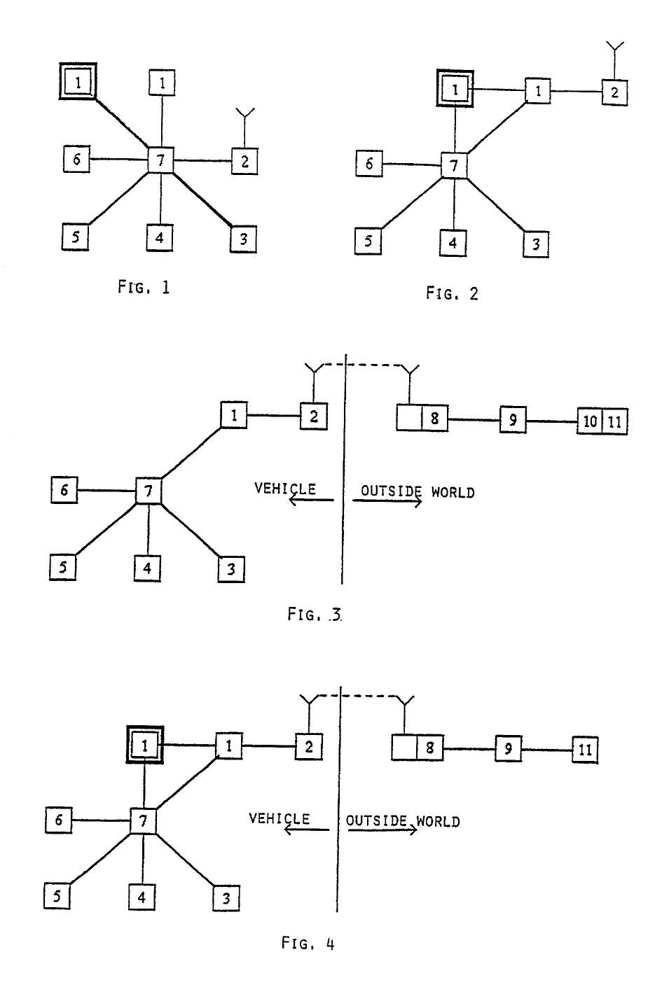

FIG. 1 gives a schematic illustration of a possible situation. In which cases the above-mentioned equipment components must, may or have to be present or not, and for what purpose(s) they can be used for example, will become clearer bit by bit in the course of the further explanation. Below we give already some elucidation. All equipment mentioned is in various forms obtainable and/or known, and therefore we will not digress on the equipment itself. However, if in certain cases or for certain reasons special demands are (or must be) made from the components, we will (try to) mention that explicitly.

In our further explanation of the TIP-system we assume that all processing is performed by maximally three processors, although the work also can be distributed, of course, over more processors. Also processors that are present in other mentioned components, may be used. The fact that we do mention explicitly the possibility of two or three processors, only has to do with possibly wanting to keep strictly separated at one hand the possible processing on behalf of 1) the authority (i.e., the processing for exercising supervision by a possibly present agent) and on the other the processing on behalf of 2) the holder (or owner) of the vehicle and/or 3) the user or the payer. (The latter two processors serve, for example, for putting digital signatures and/or for exercising supervision on the agent on behalf of the holder, respectively the user or payer.)

A reasonable possibility is, for example: 1) a (whether or not to the vehicle attached) fraud-resistant processor that acts as agent, 2) a (whether or not fraud-resistant) processor attached to the vehicle for supervision on behalf of the holder of the vehicle, and 3) a processor on a chipcard either of the vehicle's user himself or of the payer, i.e., of the person or organization that accepts the responsibility for the use of the vehicle and thus in particular also for the payment of the charges due to the use of the vehicle²¹. (Think for example of traffic pricing and traffic fines.) This third processor is not rendered in the example of FIG. 1, but the thereto-required chipcard reader is (see below). ²¹ Just because of this possibility we have earlier in this text already a number of times taken into account this distinction between user and payer. In the further text we will often (try to) choose for the most appropriate term in the context concerned. That does not alter the fact that both the word ‘user’ and the word ‘payer’ sometimes can stand for ‘payer and/or user. Note also that the user does not necessarily have to be the driver. Thus, there can be a (perhaps somewhat subtle) distinction between driver, user and payer. As the context generally gives sufficient grip, we do not have to be always that precise with our use of words in this text.

A bold printed frame (as present in FIG. 1) indicates that the component concerned (i.e., in question) is fraud-resistant, respectively, that the authority has to trust on sufficient fraud-resistance of that component. If no agent is used, then the left processor in FIG. 1 will be dropped. If an agent is used and combined point) use of one processor is acceptable to both parties (for example, because there is a manufacturer of fraud-resistant processors that is sufficiently trusted by both parties), then the right processor of FIG. 1 may be dropped. We here already emphasize that it is very well possible to use only one processor per vehicle instead of two or three (or possibly even more).

By the way, it is even possible that there is no (question of a) ‘real’ processor in a strict sense at all. If, for example, only the license number and/or (a certain part of) the odometer reading of the vehicle is transmitted continuously, then there is no or hardly a question of ‘real’ processing exclusively for the benefit of the TIP-system. It may be clear that in this latter case also most of the other (kinds of) components being rendered in FIG. 1 will be dropped.

For the non-volatile memory used it is in general true that (only) a small amount of it besides readable also has to be writable.

Often the sensors and/or measuring instruments said will already be present in the vehicle and only adequate connections to that equipment have to be established (effected) yet, if desired at all. Think, for example, of connections to already present sensors on the crankshaft and drive shaft or (instead) to possibly present electronic revolution-counter and odometer. But of course one can also introduce equipment especially for use by the TIP-system. In FIG. 1 only one sensor or measuring instrument, say the odometer, (together) with its corresponding connection (i.e., with the connection belonging to it) is explicitly rendered.

The category connections to other equipment in the vehicle could in principle also be considered to include the possible connection(s) to loose (separate) equipment for fraud-resistant identification and/or for fraud-resistantly preserving of and giving access to data concerning the classification of the vehicle, like for example year of make, brand, model, gearbox type and engine type. This is also true for a possible connection to separate equipment for keeping the time (i.e., a clock) and for putting digital signatures on behalf of the vehicle, respectively the holder of the vehicle. Later we will come back extensively to the subjects identification, classification and digital signatures. We will then show, among other things, that digital signatures can be used for excellent fraud-resistance of identification and classification (characterization).

However, if (respectively, in so far as) the in the previous paragraph mentioned tasks require processing, we assume for convenience that such functions belong to (respectively, are combined with) the tasks of one of the above-mentioned processors. This assumption does not lead to an essential restriction of the generality of our explanation, but does help to keep FIG. 1 simple and to avoid that we would (have to) enter into all kinds of details, respectively difficulties, that have to do with security aspects, which are not specific for our invention and on which we here do not want to digress further. The in FIG. 1 rendered (connection to) other equipment may concern, for example, the cruise control of the vehicle.

The transmitter or the receiver is not strictly necessary for all variations of the TIP-system, but usually handy at least. One thing and another will later become clearer of itself. In FIG. 1 there is (a question of) a combined transmitter plus receiver.

Application of voice-input is perhaps an aspect for the somewhat longer term, although the technique in this area has already been advanced substantially. In FIG. 1 only one component for communication with a user, say a display, has been rendered explicitly. It may be expected that for output usually at least a speaker will be present as well.

In relation to the connection points (connectors) for the benefit of to be connected equipment we remark that a (at least in case of certain variations of the TIP-system) supervising agent may be on a removable (detachable) chipcard. (Later we will show also that such an agent that has been realized as loose vehicle equipment, might also take on the task of consumption pass.) Also the processor that performs certain tasks on behalf of a user or payer, like for example putting digital signatures and/or supervising the possible agent, may be on a loose chipcard. In short, both processors just mentioned thus may be connected to other equipment by means of a chipcard reader²². It is most plausible that at least the possible processor of (the holder or owner of) the vehicle will be attached to the vehicle. In FIG. 1 the two processors for the agent and for (the holder of) the vehicle, respectively, are connected to each other via the central connection point and the card reader is intended for a user card. ²² Despite the misleading name we generally assume that a cardreader enables communication in both directions, i.e., also enables ‘writing’.

A user card is (primarily) an aid to be able to ascertain which person or organization accepts the responsibility for (the costs of) the use of a vehicle. So, it may primarily be a device (aid) for the identification of the payer. A consumption pass has (primarily) as task to keep a meter reading for the benefit of the user and possibly also for the benefit of the traffic information system. The meter reading may, for example, concern the use (consumption inclusive) by a certain person, whereby that use may happen at (distributed over) several vehicles and whereby that use may be for one's own account or for account of a certain organization, like for example the employer. If the kept meter reading is of essential interest for the traffic information system, then consequently the consumption pass will form part of the traffic information system. If, to protect the meter reading(s), the consumption pass must be, from the traffic information system's (respectively, the authority's) point of view, fraud-resistant, then the consumption pass is an agent as well. (Note: The meter readings stored in or on not fraud-resistant means, like for example magnetic cards, can also be protected in another way against certain kinds of abuse.)

The above descriptions make it in principle possible to clearly distinguish between user cards and consumption passes. However, for convenience and because both functions may also occur combined on one card, we will henceforth often use the term user card for both notions. Later we will still come back on the case that the user card contains (also) an agent, respectively is itself an agent as well. (Or, in yet other words, the case that the agent takes on the tasks of user card as well.) At the risk of laboring the obvious we here remark yet that, if for the use of a vehicle a user card and/or an agent on a loose chipcard is required, then the user of the vehicle has to ‘offer’ such a card, i.e., has to connect this/these card(s) to the other vehicle equipment. (For example, by putting it into the slot of a card reader.)

A central connection point is not necessary at all. The connection of all equipment can also occur in many other ways. However, a central connector does lead to a simplification of the physical organization of the equipment and of our rendering of an example of that in FIG. 1.

A disadvantage of FIG. 1 is that it seems as if both processors have equally access to all other components. However, that definitely does not have to be so. It is, for example, well imaginable that only a processor of the holder or of the payer has direct access to the transmitter and receiver in the vehicle and that the processor on behalf of the authority, i.e. the agent, certainly does not (have so). Then the agent thus cannot freely and without limitation send all kinds of (secret) messages to the authority, but has to do so via another processor that thus can keep an eye on (the communication by) the agent.

In FIG. 2 we have rendered the situation of FIG. 1 in a slightly different way in order to make such an aspect of the ‘logical’ organization of the equipment stand out better²³. Thus, even when the physical connections are realized as suggested in FIG. 1, the logical organization still can be as suggested in FIG. 2. FIG. 2 is intended to express that the rendered processors can communicate with each other and both have direct access to all other equipment with the exception of the transmitter and the receiver. In this example the processor on behalf of the authority, i.e. the agent, can only get access to the transmitter and the receiver with the assistance of the other processor, i.e. can only get indirect access to the transmitter and the receiver. ²³ The fact that in both figures the connections cannot only be interpreted as physical connections, but also as connections of communication, was an extra reason for us to omit the (physical connection to the) power supply or supplies from the figures.

5.3 Protection Against Fraud

When using the traffic information system for traffic pricing, for example, the need for sufficient protection against fraud is self-evident. Therefore, it seems plausible that (at least part of) the by the traffic information system used equipment in a vehicle itself must be fraud-resistant and perhaps also must be attached to that one specific vehicle in a fraud-resistant way, so that it is warranted that certain parts cannot be removed for (illegal) use with another vehicle.

How in case of TIP-systems one can ensure a good or even excellent resistance against (attempts to) fraud, will be made clear in the course of the further explanation. Here we already remark that in case of the TIP-system the protection (security) of equipment in vehicles is relatively easy and inexpensive, because the physical protection generally can be restricted to the used agents, if any. In case of a TIP-system without agents the involved equipment in each vehicle thus does not have to be physically protected at all! Also in case of a TIP-system with agents the physical protection will not be expensive at all, as chips can be physically protected at low costs and because for each agent one chip with corresponding software suffices. Furthermore, the number of agents in each vehicle can be restricted to one.

In certain cases an agent additionally must be linked in a fraud-resistant way to one specific vehicle. This is for example the case if an agent is (also) used for fraud-resistant identification and/or classification of the vehicle and if a very high level of fraud-resistance is required. Often other measures, such as simple and early detection of removal or destruction, can suffice. We will return to this later. (See chapters 14 and 17)

If nevertheless one considers it wise to give the other vehicle equipment (also) some physical protection in order to discourage attempts to commit fraud, one can confine oneself to very cheap measures, because that extra security is not of essential importance, i.e. does not need to offer full protection.

5.4 Minimizing the Use of Physical Protection

With security (protection) there is always a question of some kind of arms race. Particularly with physical protection one can find for each protection measure one way or another to get around that measure, which makes further protection measures necessary, which invites new counter measures, etc., etc. A high level of physical protection therefore generally goes hand in hand with high costs. This is the more so because of the necessity to carry out physical inspections regularly, which is laborious and expensive because of the personnel costs for the inspectors. This all explains why in general we do not like the fraud-resistance of a system to depend on all kinds of physical protection measures.

With the TIP-systems to be described by us, a very high level of security and also of privacy protection can be achieved. For this one can, as we will outline, make use of organizational measures and in particular also of cryptography²⁴. When using cryptographic techniques it is true that there is also an arms race, but in this case the security level generally can be increased easily by starting to use larger numbers, i.e. larger bit patterns. The increasing computing power due to the ongoing development of faster and faster chips forms no real threat to the security of cryptographic techniques. It is true that the increased computing power makes deciphering easier and easier, but that applies to enciphering as well. In case of cryptographic techniques the security is rather based on an essential difference in complexity between certain operations on numbers. So, a very high security level can remain being guaranteed, as long as there remains a substantial difference in complexity between the underlying computations. ²⁴ Actually cryptology. See also the chapter on cryptography.

Because the security level, when using cryptographic techniques, depends on, among other things, the degree (extent) to which the used cryptographic keys are secured, in general some kind of physical security (protection) will really come into play when using cryptography. If, for example, the used keys are being stored in chips, one needs also some form of physical protection for securing these chips against extraction of their contents. However, this form of physical protection, which is used with chip cards amongst other things, has proven in practice to be able to offer a high level of security (protection) at low costs, so that we do not consider its use difficult to accept. Even better, we see it as an advantage of the systems developed by us that the physical protection (of the vehicle equipment in particular) can be restricted to this specific, cheap form, of which the reliability has proven itself.

5.5 Already Present Equipment

It is to be expected that within the foreseeable future most of the above-mentioned equipment will be standard equipment for new cars. This equipment can or will be able to carry out a multitude of tasks, like for example supervising the correct functioning of (parts of) the vehicle, keeping administration for the benefit of automated diagnostics (possibly remotely), supporting navigation, sufficiently fraud-resistant keeping of and granting access to an identification number of the vehicle for service and guarantee purposes, remembering the desired settings of e.g. steering wheel, driver's seat and mirrors for various drivers, simplifying tracing after theft, implementing a tachograph or black box, communicating with parking machines to automatically establish parking fees and possibly also for direct or indirect automatic payment of parking fees, communicating with all sorts of other provisions alongside the road, with other vehicles and/or with the rest of the outside world, etc., etc.

So, in the future only a fraction of the mentioned equipment will (have to) be present exclusively for imposing traffic fees with the assistance of the TIP-system. After all, only the non-volatile memory word(s) for the (traffic fee) meter(s), respectively meter readings, seem to be intended exclusively for that. All other parts may also be useful and/or necessary for other tasks.

For example, the connection point for e.g. a chipcard may already be present (or also going to be used) for tasks, like for example determining by or on behalf of whom the vehicle is going to be used in order to be able to determine whether that use will be permitted and/or in order to automatically adjust the driver's seat, steering wheel, mirrors, and the like according to the in a chip card registered wishes of the user. The receiver can be used, among other things, to receive data about the infrastructure, like for example the locally valid speed limit or information about delays as a result of traffic jams. In short, there are numerous other useful applications possible, even too many to mention.

5.6 Possible Integration with Other Applications

Because the equipment used in vehicles by (the traffic fees part of) the TIP-system does not or hardly need physical protection to hinder fraud, the traffic fees part can easily be integrated or cooperate with all kinds of other applications. If desired, certain other applications can therefore also (start to) form part of the total TIP-system. The equipment required for the traffic fee part of the TIP-system, respectively for the total TIP-system, thus may be used collectively with other applications within or outside the total TIP-system, so that the costs that will have to be made per vehicle for (the traffic fees part of) the TIP-system, may be (extremely) low.

5.7 Fixed and Loose Vehicle Equipment (FVE and LVE)

Not all mentioned equipment needs to be (or have been) permanently attached to the vehicle. The equipment or important parts thereof may be loose²⁵ and may, in the case that there is a connection point, be connected to fixed vehicle equipment, like for example sensors and/or the battery. The loose, connectable equipment may for example consist of a chip card, which can take care of a part of, or even all, processing and/or which contains (a part of) the non-volatile memory. It is for example also possible that the transmitter and/or the receiver form part of the loose equipment. ²⁵ We are aware that in general there is no clear distinction between what can be called loose and what can be called fixed. For example, the battery of a vehicle is in a certain sense also fairly easy to loose (detach, remove, take out), so that against our intention it might be considered also as a loose part of the vehicle. However, a more precise definition does not seem necessary for our purpose.

With the term fixed vehicle equipment (FVE) we henceforth will allude to all equipment that is permanently attached to the vehicle and that supplies information to, or is used (directly or indirectly) by, the TIP-system. And with the term loose vehicle equipment (LVE) we will allude to all other equipment that during participation in traffic is present (and possibly connected to the FVE) in the vehicle for the benefit of the TIP-system. We will keep on using the term vehicle equipment (VE) for the union of FVE and LVE.

On the one hand it is possible that there is only (i.e. it is only a matter of) FVE, i.e. that all equipment is permanently attached to the vehicle and that no use is being made of loose, connectable equipment. On the other hand it is possible in certain cases that there is only (i.e. it is only a matter of) LVE. The latter is only possible if no use is being made (yet) of sensors attached to the vehicle (for example to be able to keep the odometer) or of identification means that have been fraud-resistantly attached to the vehicle, like for example a chip with an identification number and/or a type indication. Because otherwise there also would be (a question of) FVE. It is self-evident that there is a whole range of other possibilities between both extremes.

Normally a TIP-system that is used for traffic pricing and particularly for congestion, pollution or road pricing, will also support continuous pricing, for which it is in general necessary to make use of data that are acquired via sensors in/on/of the vehicle concerned. Thus, in general there will be (a question of) FVE, to which LVE can be connected or not. However, when introducing road pricing with the assistance of the TIP-system one can also restrict oneself (possibly only at the first instance) to open and closed tolling. (See also chapter 17.) In doing so one then may limit oneself, for example, to transmitting an identification number of the payer or of his checking account. Thus, data about the vehicle then are not necessary, so in this case (having) only LVE can suffice.

5.8 Broad Interpretation of the Used Notions

Perhaps superfluously but to be quite on the safe side, we remark explicitly that the used notions in general must be interpreted broadly. Not only the notions dealt with in this chapter, but all notions in the entire text. For example, we will use the concept of transmitter for every means by which a message can be given or made available to the receiver(s) of other objects or persons in the environment. The term is usually used if there is no question of physical contact and messages are being transmitted by means of for example sound or radio waves, light, infrared, or whatever²⁶. But in our context the term obviously also covers those cases in which the transfer of messages occurs via physical contact, for example by means of electrical conduction. Thus we could also have entitled the possibly present connection point for the connecting of equipment (on behalf) of the payer as a transceiver. This last remark illustrates that the earlier used term connection point, without it being said explicitly, really was meant (intended) to be interpreted broadly, so that it also includes cases without physical contact. In short, the communication between LVE and FVE can also take place via transmitting and receiving means. ²⁶ So, a display and a loudspeaker fall also under the broad notion of transmitter.

6 Cryptography²⁷ ²⁷More strictly speaking, cryptography only stands for ciphering. The correct term for the theory of both enciphering and deciphering (say, both producing and reading ciphertext) really is cryptology. In the rest of this text we will nevertheless continue using the somewhat more well-known and quite current term cryptography.

In general, the suggested TIP-systems gratefully use already known cryptographic techniques for various purposes.

By means of cryptographic techniques it is, for example, possible to keep the contents of a message secret for any other person than the intended recipient. In the following we will call a message secret if that message has been enciphered in such a way that only the intended recipient can decipher the message or, in other words, can undo the message of its ‘packing’ that provides for the secrecy. This situation is somewhat comparable to a sealed envelope around a letter, albeit with the difference that anybody can indeed unlawfully (unauthorized) open a sealed envelope, but not a secret message. (The comparison with a sealed envelope is not unusual, even though a safe vault of which only the sender and recipient have a key, offers more similarities in properties.)

Furthermore, by means of cryptographic techniques it is possible to warrant the authenticity of the contents and/or of the sender of a message. If both aspects are guaranteed, one speaks of a digital signature on that message. Henceforth we will call a message furnished with a digital signature a signed message.

To hinder fraud, each message should not only be signed, but also provisions should be taken to make sure that only the firstly received copy of each signed message really counts, i.e., that all copies (possibly) turning up later (and anywhere) cannot get any effect in addition to the (intended) effect of the firstly received copy. Hereto, the original copy of each signed message should be at least unique. Usually the desired uniqueness is obtained by adding to each message a timestamp or a serial number. Hereto, also the intended effect of each message should be clear. The intended effect is often made clear by recording in each message explicitly, among other things, the addressee and/or the subject. Besides all that, it is for a good digital signature in general necessary to incorporate into the message also a known (or from the rest of the message derivable) bit pattern.

We will not digress further on these kinds of cryptographic details and henceforward we will pay no (or hardly any) attention to these. Even worse (i.e., to put it even stronger), we will (may) sometimes not even indicate explicitly whether secrecy and/or signing is either desirable or necessary for a proper functioning of the various protocols that will pass in review. A person skilled in the art is supposed to be able himself to (further) determine which protection measure(s) are necessary and how these can be implemented by means of cryptographic techniques.

Nevertheless, we will pay quite some attention to a number of security aspects. Not only to show here and there what application of cryptography has to offer, but also to get the explanation of a number of aspects of the protocols and of the functioning (working) of TIP-systems clear(er). Thereby we will (try to) restrict ourselves to the two properties secret and signed. Thus, in our description sometimes the stronger means of digital signatures is mentioned, while it might suffice, for example, to warrant the authenticity of only the sender or of only the contents of the message. Also we will indicate here and there that secrecy or signing takes place or should take place, while one may also content oneself with a similar approach without these cryptographic additions. In short, the descriptions given serve only as illustrations and may not be understood as imposed restrictions.

7 Administration (Book-keeping)

7.1 Data to be Collected

As mentioned earlier, we will initially focus on imposing traffic fees. The data that needs to be actively maintained for this purpose by the vehicle equipment will in general include anything that affects (the level of) those fees (say, is used as a parameter). These data can be of any kind. For example, in a vehicle with a combustion engine one could, at least in principle, continuously measure and record the quantity and quality (kind) of the exhaust-fumes produced by that vehicle. However, in most cases it concerns data that can be determined more cheaply, like for example the distance covered, the speed, the point in time, number of revolutions per minute, vehicle type, engine type, the engaged gear, the position of the gas pedal, etc.

7.2 The ‘Kilometerteller’ as Odometer

Below we will give a number of examples whereby (at least) the odometer reading is kept record of. (In the Dutch text version we then explain our use of the common term ‘kilometerteller’ (literally, ‘kilometer-counter’) instead of the in Dutch rather uncommon term odometer. This piece of text is not relevant for the English version and thus has been dropped.) In the rest of this text we assume that the odometer is kept up-to-date, and can be read, in a sufficient number of decimals.

7.3 Some Examples

To illustrate the above we will give some concrete examples. In the first example only the odometer reading is recorded (to a sufficient accuracy). In this case the corresponding traffic fee may consist of a fixed price per distance unit traveled.

In the second example the odometer reading is recorded, as well as the time, speed, and accumulated fees paid and/or due. Each of these four readings must of course be expressed using some prescribed unit. For example, the fees due can be expressed as a sum of money, or in terms of ‘levy points’, etc. The way in which dues are calculated from the other data, will of course be prescribed (presumably by government).

Continuing the second example, the prescribed amount that must be contributed to the accumulated ‘levy points’ for each distance unit traveled thus may depend on the time span (i.e. the speed) in which the distance was covered, and on the precise period (i.e. date and time) in which it was covered. To put it another way, in the given example the price due for a unit of distance traveled can be determined by any desired function of speed and time. For example, it is possible for kilometers traveled at a speed higher than, say, 90 km/h to be charged at a progressively higher rate (i.e. the charge per kilometer increases with speed). The same applies to kilometers traveled during specific peak hours on specific days. Another possibility is to follow a U-shaped function of speed, and thus additionally increase the charge per kilometer as the speed drops further below, say, 60 km/h. The reasoning behind such a U-shaped function is that fuel consumption and/or pollution per kilometer is greater at higher and lower speeds.

Our third example augments the data used by the second example with the license number (or some other registration number) of the vehicle. The license number register (to be) maintained by, or on behalf of, the government might for instance include an accurate description of the vehicle type, engine type, etc. of the vehicle concerned. Therefore, one now can choose for any vehicle type, i.e., for any combination of brand, model, year of manufacture, gearbox and engine type (etc.), the price function in such a way that the price per distance unit traveled will be fairly accurately related to the fuel consumption and/or environmental pollution caused without having to continuously measure and/or analyze the exhaust-fumes of each individual vehicle. Note that one can choose to let the price per kilometer depend not only on the average speed at which this distance unit was traveled, but also on the average speed at which the preceding distance unit was traveled. Therefore, additional pollution (and/or fuel consumption) resulting from speed variance, i.e. acceleration and deceleration, can be charged fairly accurately without having to continuously analyze exhaust-fumes emitted by the vehicle while participating in traffic.

7.4 Empirical Discovery of an Algorithm

In order to come to a sufficiently accurate algorithm for calculating the degree of pollution caused by a vehicle from relevant data (such as speed, acceleration, temperature, fuel consumption, number of revolutions per minute, etc.) one would like to perform actual analyses and measurements on at least one specimen of every possible kind of vehicle. The kind and quantity of environmental pollution caused by the specimen under all kinds of conditions should be analyzed and measured, and the corresponding combination of relevant data determined. One specimen may be sufficient already, since we can gather data of all other vehicles of that type through the traffic information system, and check whether they manifest the same characteristic combinations of data relevant to this calculation. Another use of the data thus obtained is to call in for closer inspection those vehicles that seem to deviate. Similarly, one can track down vehicles that no longer conform to (environmental) standards, perhaps due to bad tuning or wear (old age). (Observations similar to those described here apply to the example of overall noise production by a vehicle. This example of using derived, i.e. calculated, information is addressed in chapter 11.)

If one decides to base the fee on fuel consumption, often even no specimen at all is necessary for prior experimentation. The reason is that one can collect for every type of vehicle all information about (reported) fuel consumption under all kinds of usage conditions through the traffic information system. After filtering out any too far deviating results (perhaps due to attempted fraud), accurate information about fuel consumption occurring in practice can be derived per vehicle type. The results thus obtained can be used to determine a sufficiently accurate algorithm (e.g. in the form of a function or a multi-dimensional table) for calculating the fuel consumption from a suitable (e.g. minimal) number of input parameters. Such an algorithm can subsequently be used to verify the fuel consumption reported by an individual vehicle. (Observations similar to those described here apply to the possible use of the traffic information system to collect measurements of the level of noise production occurring inside the engine compartment of vehicles).

Either of the two above described ways for empirically discovering an algorithm for calculating derived information may be applied also to data other than fuel consumption (or noise production). More in general, one can automatically collect the information required for combating fraud with a particular type of vehicle (i.e. use the second way) provided that the abundant majority of the vehicles of that type are not subject to fraud.

7.5 Some More Examples

Another possibility is to let the pricing function used for a particular traffic fee vary with (depend on) the area or the section of road. Obviously one must then keep track of the tariff zone the vehicle is in. For example²⁸, assuming the vehicle equipment includes a receiver, it can be kept informed about which tariff, i.e. which price function must be applied, by announcing at/on each border crossing between different tariff zones via a transmitter to the vehicle equipment the kind of tariff zone that is being entered. One could also let the fees due be dependent (in part) on the heaviness of local traffic conditions. Later we will separately address a number of other advantages of the use of the receivers. ²⁸ The correct tariff can, for example, also be determined with the aid of a GPS and a description of the tariff zones/areas.

From the above it should have become clear that there are countless possibilities, too many in fact to mention. More or less as a coincidence, all of the examples that have just been given involve an odometer. This is a coincidence in the sense that one can very well conceive of situations in which the length of the distances traveled has no effect on (determining the level of) the fees. On the other hand it is not a coincidence at all, since we expect that in practice eventually in many cases an odometer will really be used. After all, an important property of the TIP-system is that it makes continuing pricing possible. This also explains why, in the remaining exposition, we will mainly concentrate on the use of meters. In our examples we will often confine ourselves to mentioning meters (meters in general or odometers in particular).

We would like to point out in advance that all possible kinds of data of which either the reliability can be verified sufficiently easily from a distance or which are sufficiently protected against fraud attempts in another way, can be used as parameters of the pricing function. We will return to this matter in chapter 11.

7.6 A Tolling Meter per Person and/or per Vehicle

All parameters that influence the level of a traffic fee are used in some prescribed way to maintain the current value of a tolling meter. In many cases a cumulative, in other words monotonically increasing, tolling meter will be used. However a monotonically decreasing meter can also be used. To simplify our explanation, we will often say ‘the meter’, deliberately ignoring the possibility of maintaining more than one meter, and also leaving unstated what the meter(s) are associated with. For example, the tolling meter, i.e. the meter on which the payment process²⁹ is based, can be associated with a vehicle or with a payer. Another interesting alternative is to maintain two meters, one associated with the vehicle and one associated with the payer. ²⁹ For example, this might simply be an odometer.

Associating a meter with the vehicle (and therefore indirectly with the holder of that vehicle) is a straightforward possibility, which closely matches the (ultimate) responsibility of the license holder to pay the traffic fees that arise from the use of the vehicle. This possibility also closely matches the traditional association between odometers, respectively odometer readings, and vehicles.

The advantage of a direct association between meters and payers is that the users of a vehicle can alternate, and yet each of them will still be held accountable by the authority (in this case the fee collector) for payment of traffic fees arising from their own individual usage.

The possible charging of traffic fees incurred by a vehicle to its actual users can be considered to be the responsibility of the vehicle's holder himself (or herself). If that is the case, the tolling meter is associated with the vehicle and it is up to the holder to (make/let) keep track of fees per individual user (possibly aided by LVE), if desired. Thus, in this case the holder will be responsible for the possible use of a second kind of meter.

Of course, it is also possible that the authority, i.e. the fee collector, is interested in both meters³⁰, and uses them both for the verification and/or payment process. Having a redundancy in the meters provides the authority with an additional means of verification (of consistency), since e.g. the total amount of traffic fees due according to the meters associated with vehicles should be equal to the total amount of traffic fees due according to the meters associated with payers. ³⁰ For example, if individual and whether or not tradeable pollution rights are involved.

In any case, in the remainder of the text we will generally for convenience continue to consider one meter (only).

8 Use of a Transmitter

A realization of a TIP-system in which no transmitter is used, seems unlikely. In principle it is in case of an approach using agents (which are discussed in chapter 16) certainly possible to have the agents report, for example via an electrical contact, only during a periodic inspection. However, the use of transmitters is so cheap and convenient that in the remainder we will assume the use of a transmitter. There is no reason to separately treat the ‘more classical’ possibilities without transmitter in more detail, since all relevant aspects are already contained in the remaining explanation of the case using a transmitter. (Note that communication by physical contact is also covered by our notion of a transmitter in a wide sense.)

8.1 Continuous or Solicited Transmission of Data

If (respectively, to the extent that) the vehicle equipment in each participating vehicle maintains the administration (book-keeping) by itself, the authority must be able to gain access to the administration of each participant at any desired moment in order to be able to perform effective supervision. In the first to be discussed approach with only remote verifications, every participating vehicle must for this purpose make crucial data available to the authority in the outside world via a transmitter. In chapter 16 we will describe a similar approach whereby these data are passed to an in the vehicle present agent, i.e. a representative, of the authority. This agent then communicates via a transmitter with (the rest of) the said authority in the outside world.

The transmission of messages with the required data can take place (almost) continuously, that is to say the messages must be transmitted at least as often as a prescribed high rate, or else it can take place solely in response to an authorized request (or rather, to an authorized instruction/order). If one chooses for gaining access to the data kept in the vehicle on request only, good verification from a distance becomes harder to perform and therefore costlier, so that an adapted approach, such as the approach with agents residing in the vehicle, seems at least desirable. Until the treatment of the approach using agents in chapter 16, we will (to the extent possible) confine ourselves in our remaining exposition to the case in which the required information is made available almost continuously via the transmitter.

8.2 Reading from a Distance

The messages transmitted by vehicles (or more precisely, by vehicle equipment) can be read by means of receivers, without traffic being disturbed in any way. In principle, receivers can be placed at any desired distance, as long as they are within the prescribed range of the transmitters of the vehicles to be ‘read out’. The necessary receivers may be placed, for example, alongside or above the road, but no other possibility is ruled out at all!

8.3 Possibly Transmitting Only (Semi-)Identifications

If the TIP-system is only used to e.g. gather traffic information in a narrow sense, thus among other things to measure the quantity and/or average speed of certain traffic flows and/or to determine traffic congestion delays and/or to determine the (average) speed of individual vehicles on particular road segments, then it is sufficient to transmit identifications or semi-identifications from each vehicle. The notion of semi-identification is not yet explained and will be treated extensively in chapter 15. For open and closed tolling too, it may be possible to restrict oneself to transmitting (semi-)identifications. (As has already been mentioned earlier in the penultimate paragraph of chapter 5. An example of this is given in chapter 17.)

9 Security of Messages

9.1 Signing Messages

The transmission of messages to the authority with relevant data about one's administration can be seen as a submission of an automated, electronic declaration. If such a declaration turns out to contain errors, intentional or not, then one would like to call to account the sender responsible. Thus it is convenient if: 1) the sender responsible can be determined indisputably, and 2) this sender can be called to account as to the precise contents of the declaration. The latter requires that nobody can alter the contents of somebody else's declaration unnoticed.

If one wishes to have both properties just mentioned, one must require that every declaration carries an (unforgeable) digital signature. For, a digital signature ensures the authenticity of both the identity of the sender and of the contents of the signed message. In other words, such a signature ensures that one can prove the message was not sent by another person, and also that its contents cannot have been altered surreptitiously by another person. Thus, digital signatures can prevent another person making a false declaration, and also remove any chance of success in repudiating an incorrect declaration submitted by oneself.

The authenticity of both contents and sender, which is ensured by a digital signature, need not of course merely be relevant for electronic declarations, but can also be useful and/or necessary for other, or even all, messages.

9.2 Authorized Inspection Only

By means of cryptography one can ensure that every message remains secret to anybody but the intended recipient. Thus one can for example ensure that a particular transmitted message, like for example a declaration, is only readable by the addressee. Later we will further address the need for privacy protection against and secrecy towards certain persons or authorities. For now it is sufficient to note that the transmitted messages can be encrypted in order to secure against illegitimate inspection.

10 Identification Numbers in Messages

10.1 The Need for Identifications

Often it is the case that a message to be transmitted by vehicle equipment must also include a number of identifications. A number of reasons for this can be given.

In the first place, as will be explained in detail later, it is necessary to be able to verify that the meter reading(s) only increase³¹ and are not occasionally (during traffic participation or while stationary) put back surreptitiously. For this it is necessary to be able to determine whether or not the meter readings submitted at various points in time belong to the same FVE or the same LVE, respectively. Thus, in the first approach described by us, which only involves remote verifications, a corresponding identification number must be transmitted together with every meter reading. ³¹ Assuming an incremental meter and not a decremental one, of course. See also section 11.6.

In addition, it must be possible to charge the registered traffic fees to the correct payer regularly. For this it is desirable to register or transmit some identification number of the payer with each meter reading and/or meter identification. If desired, payments might also be made in an anonymous or semi-anonymous way within the vehicle. Doing this, and then sending just a proof of payment along with the meter reading(s), perhaps seems like an attractive thing to do given the demand for privacy protection. But even then the need for identification numbers has not necessarily disappeared, because for example, the fee collector will normally want the proof of payment to specify what meter has been paid for. Therefore, it seems not to be so easy to get around the use of some identification number or other when making charges.

Thirdly, it is at least desirable for particular messages, such as declarations, to carry a (digital) signature. However, one can only verify the signature on a message if one can determine whom the signature is supposed to belong to. In short, if a message is signed, the intended recipient must be able to identify the owner of the signature.

In short, some form of identification seems indispensable. How one can ensure a sufficient level of privacy protection despite the use of identification(s) will be discussed in chapter 13. And in chapters 15 and 16 we will show that the use of identifications of persons and/or vehicles can be minimized, and how this can be done.

10.2 Several Identifications

Several identification numbers may be necessary and various kinds may be used. We will come back to the latter in chapter 13. If one associates certain meter readings with vehicles, then a vehicle identification must accompany such meter readings in the messages. In such a case the meter is actually bound to the FVE and it is thus possible to opt for a FVE identification number instead of a vehicle identification number. Which is the more convenient depends, amongst other things, on the desired course of things in case of e.g. replacement of equipment in the event of defects etc. One can also choose to associate each person with one or more private meters. Then the identification number must concern the person or his meter, i.e. his LVE. When considering this last choice, one should, among other things, bear in mind what should happen in the case of e.g. loss and/or theft of the personal LVE. One might also have two meters be maintained during traffic participation: one belonging to the FVE, the other to the LVE. Thus in this case message transmissions must at least include the two associated identification numbers.

Maintaining a meter per person has a number of advantages. Firstly, several users/payers can take turns in using one and the same vehicle (i.e., can ‘share’ vehicles), and yet each individual can be charged with the traffic fees due to his/her own use. Secondly, this makes it possible to introduce a quota system, in which each citizen is allowed, for example, to travel a quotum of kilometers in a motorized fashion or to cause a certain quotum of (some kind of) environmental pollution. Possibly the trading of (parts of) such usage rights (licenses), or pollution rights (licenses) respectively, will be permitted or regulated.

For convenience, in the remainder of the text we will (almost) always speak of one meter and do so without specifying what kind of meter is concerned. Thus, in the remaining explanation in general we do not distinguish between the various possible cases with one or several meters and with meters that are personal or not. A person skilled in the art is considered to be able to fill in by himself the required details in each case.

11 Verifications (Inspections)

To make and keep a traffic information system sufficiently fraud-resistant, in general all sorts of verifications will be needed. Of course, one will need in particular verifications on the reliability of those data whereby directly or indirectly some economic interest (say, money) is at issue, like for example in the case of price calculations or traffic fees. An incorrectness or unacceptable deviation revealed by an inspection may, for example, be the result of a fraud attempt, a defect or an incorrect tuning. The counter action may for example consist of arresting (holding) the vehicle or sending a summons to the holder of the vehicle to bring the vehicle in for further inspection.

11.1 The Fee Collector as Inspector

Although it is a possibility that the government, respectively the fee collector, could contract out certain inspections to various competitive organizations, we will for our convenience often assume in the remainder of this description that the inspector and fee collector are one and the same, i.e., that there is one fee collector who takes care himself of performing the necessary inspections. Therefore, we can restrict ourselves to the term fee collector when we want to specifically refer to the authority. (Often, however, we will just continue to use the more abstract term authority).

11.2 Remote Verification

An important aspect is that the authority can also verify from some distance, i.e. without obstructing traffic at all, whether the administration in the vehicle is maintained correctly. In first instance we will treat one thing and another for the case that the administration concerns only the odometer reading. For good verifications on correct odometer readings, generally attention must be paid to two aspects, namely: 1) whether the odometer is continually increased correctly, i.e. whether the odometer is precise, and 2) whether the odometer is not being surreptitiously decreased now and then, i.e. whether the odometer is monotonously increasing (or more precisely formulated, monotonously non-decreasing).

11.3 Checking Precision of Odometers

To check on the first mentioned aspect one can set up an inspection trap at randomly chosen, varying (and possibly also at a few permanent) positions. If the inspection trap consists of a section of road where there is no opportunity to leave the road between the beginning and the end of the trap, then it has one entrance and one exit. If after the beginning of the inspection trap there are, for example, a number of forks and/or exit ramps, then the inspection trap can be seen as a tree structure with one entrance as its root and many exits as its leaves. Even more complicated inspection traps with several entrances are conceivable. In any case, the intention is that one can only enter an inspection trap via one of its entrances and only leave it via one of its exits. Besides that, it is for verifications of odometers of importance that the length of each verification trajectory, i.e. of each trajectory (route) from an entrance to an exit, is known with sufficient accuracy. (An inspection trap can also be used for traffic control, namely for observing and gaining insight into the course of traffic flows. In this case, the lengths of the trajectories inside the inspection traps play no role.)

Of each participating vehicle (or, of each VE) that travels a verification trajectory, the odometer (reading) is read out twice. Once at the moment that the vehicle passes the beginning of the verification trajectory, i.e. enters the inspection trap, and once at the moment that the same vehicle passes the end of that trajectory, i.e. leaves the trap. With the aid of a processor one can for each pair of odometer readings belonging together subtract the two numbers from each other and compare the result to the known length of the verification trajectory.

If both distances correspond sufficiently accurately, then apparently the odometer is properly maintained in the vehicle. But, if the difference is considered to be too big, obviously a certain action will be initiated. This action may e.g. consist of arresting the vehicle concerned further up the road. Or, for example, of making a video recording of the license plate of the vehicle concerned in order to later track down the holder who is responsible and then summon him or her to bring the vehicle in soon for a further inspection. (N.B. We here already make the remark that manipulating license plates is generally easy to do and that it thus would be advisable to arrange for/about a really fraud-resistant means of identification.)

Whether two odometer readings belong together, i.e. either belong to the same vehicle or to the same payer, can be determined by providing that each odometer reading in a transmitted message is accompanied by a proper identification number or semi-identification number. The term semi-identification number will be treated extensively in chapter 15.

11.4 Ascertaining Which Vehicle the Inspection Relates To

Before continuing the discussion of odometer verifications, we remark that for certain (counter)measures, like for example the taking of a photograph, it must be known precisely from which vehicle the not acceptable declaration originates. Furthermore, one must be able to relate an independent measurement (for example, a speed measurement: see also sections 11.10 and 16.7) to messages from (or, more in general, communication with) the correct vehicle³². In other words, one must then be able to ascertain with sufficient certainty the physical identity (say, the position) of the vehicle with which is communicated. A known technique is, for example, taking cross-bearings. However, taking sufficiently accurate cross-bearings on one or several messages broadcasted (i.e., transmitted in all directions) by or from the vehicle, may be impracticable or even impossible. Therefore we suggest here the possibility to realize one thing and another by means of directional (beamed) communication from and/or to the vehicle that is (to be) inspected. In particular ‘pointing to’ the vehicle in question by means of directional communication towards the vehicle, seems to be a very attractive option. ³² This is particularly difficult if the messages sent from the vehicle do not contain a fraud-resistant identification that is suitable to relate them unambiguously to the correct independent measurement.

For the sake of clarity, we give by way of further elucidation one example in more detail. One could aim a narrow beam³³ at (whether or not special) receiver(s) of the vehicle that is to be inspected, in such a manner that only this vehicle receives the message being transmitted via the beam(s). The message having to be sent in the case of an inspection aimed at a specific vehicle, then concerns an instruction for (the equipment in) the vehicle to which should be responded immediately and in a prescribed way³⁴, of course. Upon reception of the required response(s) the verifying authority thus will know exactly which vehicle is ‘responsible’ for these response(s). If there is no response by or from the vehicle pointed to by the beam(s) or if the response is not in time or is otherwise inadequate, then that will of course constitute a violation that induces a counter measure (like for example arresting/holding the vehicle and/or sending a summons for an extensive inspection). ³³ For example, a beam of electromagnetic waves. The only requirement is that the communication can be aimed, i.e. that the beam can be made sufficiently narrow. Another possibility is to use several beams and to arrange (see to it) that at the moment of inspection only one vehicle is covered by all the beams. We do not pursue this matter further, as this remark should suffice for a person skilled in the art. ³⁴ In the instruction one might include e.g. a unique number, say an instruction number, and one could make it obligatory to report (repeat) this number in the response(s) to this message. Also one might require that the response(s) have to be signed. The latter is advantageous for later argumentation (i.e., it has evidential value), but is disadvantageous for the anonymity of the sender.

At the risk of being superfluous, we remark that this technique is not only applicable and of importance in case of TIP-systems, but also more in general. Particularly also in case of positioning-based systems using a GPS and/or an electronic roadmap. If it turns out that (the application of) the here by us suggested verification technique using directional communication and active participation of vehicle equipment is indeed new, or is new in the context of the said traffic information systems (that enable continuous pricing), then we want to claim this technique (method) as extensively (amply, liberally) as possible. Thus, it is among other things explicitly our intention that also the use of this technique for positioning-based traffic information systems using GPS and/or an electronic road map forms (is included as) part of our invention.

11.5 Checks Against Surreptitious Putting Back of Meter Readings

To ensure that meter readings do only increase monotonously, i.e. that they cannot be put back at any moment without real danger of being caught³⁵, there must be a sufficient number of checks on meter monotony. These verifications take place by reading out meter readings with accompanying identification, i.e. receiving (intercepting) declarations, at random times, thus also at the most ‘wild’ moments. Upon receipt of a declaration, an administration to be kept by the inspector will be used to find the meter reading that until now was recorded as the most recently received one relating to the identification in question. If the currently received meter reading is higher than the one found in the administration, it will be registered in the administration as the most recent one. If it is lower, an appropriate counter measure should be taken, as this signifies a not allowed situation. ³⁵ Particularly also protection against putting back of a meter during a standstill (of the vehicle) is necessary!

The administration needed for monotony inspections thus consists of one most recently received meter reading per identification. Let it be clear that each meter reading (of one meter) must be uniquely identified again and again by one and the same identification and that the use of real identification numbers is essential to these monotony checks. Semi-identification numbers therefore are not suited for this. This last aspect is supposed to become clear to the reader after reading of chapter 15.

Please observe that for monotony checks it is sufficient (to be able) to receive (intercept) messages transmitted from vehicles. Thus, for these checks it is not necessary (to be able) to determine the position of the vehicle at the moment of reception of the message, as is necessary in the case of checks on precision.

If the meter reading(s) are identified in each message by identification numbers, then it will be possible to combine in each inspection trap precision checks with monotony checks. So, it is not always necessary to perform ‘separate’ checks on meter monotony.

11.6 Meter Checks in General

The above-described method of checking on monotony cannot only be used for odometers, but also for other kinds of meters. Furthermore, it cannot only be applied in case of increasing (incremental) meters, but obviously also in case of decreasing (decremental) meters³⁶. In short, the monotony may equally well be decreasing instead of increasing. For complete verification checks on precision are required too. But fortunately checks on precision are also possible for far more meters than odometers only. ³⁶ Decremental meters may, for example, keep track of the kilometers or ‘pollution rights’ still available.

Suppose for example that there is (a question of) a tolling (traffic fee) meter and that the amount of ‘levy points’ for a traveled distance unit is a function of several variables, like for example speed, number of revolutions, vehicle type, length, width, and the like. As long as the correct value of all used variables can be determined reliably, the tolling meter can be completely verified. The values of variables involved can be established (ascertained) reliably in two ways, namely either 1) by determining them externally, i.e. (remotely and) independent of the report from the vehicle, or 2) by making sure that the report from the vehicle can really be trusted. In the following three sections we go somewhat further into this.

We just notice here that for data that can be determined externally, the presence in each declaration does not have to be required, strictly taken. However, it is usually more convenient still to do so. After all, checking whether a reported value is correct may be easier (and therefore cheaper) than independent ascertainment, but never harder (respectively, more expensive). For example, checking whether a reported license number is in accordance with that on the license plate is easier than reading the license number on the license plate totally independently (i.e. without having a hint).

Finally it is noticed that, in case of separate checks on precision and monotony, it must be prevented that a certain meter (counter) in a vehicle can escape from a full check by giving the appearance of two different meters. In other words, one must make sure that both kinds of checks for each individual meter can be correctly ‘associated (related) to each other.’

11.7 Data Suitable for Remote Verification

The detection of incorrectnesses or deviations is certainly possible for all kinds of by vehicle equipment supplied data of which the correct values can be remotely (and preferably automatically) determined for passing vehicles. This can be done by direct determination, like for example with speed, speed change, length, width, color, shape of body-work, license number on license plate, and the like. Sometimes it can be done indirectly via derivation from other data.

An already earlier given example of this is the fuel consumption. Even though the fuel consumption of a passing vehicle cannot be directly measured from a distance, it is often possible to derive the fuel consumption rather accurately from a number of other data that have proven to be highly determining for the fuel consumption of the passing vehicle. For these other data think e.g. of the full classification of the vehicle and of certain data about the use (including the usage conditions) of the vehicle, i.e. certain data connected with (related to) its movement. As said already before, a full classification can for example consist of brand, model, year of make, gearbox and engine type. Data about the use that may play a role, are on the one hand for example speed, acceleration, number of revolutions per minute, and the like, and on the other hand for example the air humidity, air pressure, outside temperature, wind speed and wind direction. If a sufficiently accurate dependency (connection, relation) is known and if also reliable values are available for the thereto-required data (i.e. for the input parameters), the correct fuel consumption thus can still be derived. A value reported from a vehicle can thus really be verified on/for reliability.

Another example of a derivable datum is for example the number of revolutions per minute. If a full classification (make, model, year, gearbox and engine type, and the like) of the passing vehicle is known, one can check indirectly in what gear is being driven by performing a speed measurement, a speed change measurement (say, an acceleration measurement) and a directional sound measurement. Based on the speed and the data made available by the manufacturer (and perhaps checked by the authority) concerning transmission ratios, one then can derive the number of revolutions per minute much more precisely and use this for verifying the correctness of the reported number of revolutions per minute.

We have described already earlier that and how various meters can be randomly checked from a distance. It should now be clear that revolution counters and fuel meters (can) also belong to that category.

11.8 Another Example of the Utility of Derived Information

To illustrate the possibilities that derivations can offer, we describe here in passing yet one more specific example. This example concerns the possibility of deriving the total amount of noise caused by a vehicle (thus including noise from the rush of air along the vehicle) rather accurately from a number of other data. The nice thing about this example is that derivation may even be necessary, because it seems in certain cases unfeasible or even impossible to actually measure this datum sufficiently accurately.

After all, in case of road traffic one may be bothered a lot, both in case of measurement from the vehicle itself and in case of measurement at a certain distance along or above the road, by the noise produced by possibly plenty of other traffic present. Besides, it seems impossible to measure from (within) a fast moving vehicle the noise of the self-produced air turbulence. This second reason plays particularly also a role in case of air traffic. By the way, in case of air traffic sufficiently accurate noise measurement seems only unfeasible from the concerning airplanes themselves (i.e. only the second reason seems to count).

Note that the difference with the earlier mentioned example of environmental pollution caused is that, at least in case of road traffic, it is in principle really possible to actually measure and analyze the exhaust-fumes in the vehicle. In that example we just assumed that actual measurement and analysis was too expensive.

11.9 Data Not Suitable for Remote Checking

Of course one might also have the vehicle equipment use and transmit data of which one does not know (yet) how these can be directly or indirectly verified from a distance in a sufficiently easy (and therefore sufficiently cheap) way for vehicles participating in traffic. For such data think for example of the type of engine that is present in the vehicle, the position of the gas pedal and/or whether there is being driven on LPG (Liquefied Petrol Gas) or gasoline. (Nevertheless, it is indeed imaginable that the position of the gas pedal can be indirectly verified, if sufficient other factors are known. Also, the exhaust of a vehicle might be ‘sniffed at’ sufficiently well from/at some distance to establish a distinction between the use of LPG and gasoline without disturbing traffic.)

If the correctness of such data is of sufficiently high importance, it must be made sure that these data are obtained, collected and transmitted in a sufficiently fraud-resistant way. For example, in order to prevent false input to the processor (of the VE), the components involved in collecting that kind of information (often sensors and their connections to the processor) must be engineered sufficiently fraud-resistantly³⁷. ³⁷ Because then the whole chain up to and including transmission must be protected against fraud, the processor will almost certainly have to be fraud-resistant as well. Anyhow, we here are actually just anticipating the later treatment of the use of agents.

In short, for every kind of data used that can not or not sufficiently easily be checked randomly (and with our first approach: remotely) with moving traffic, a sufficient guarantee of the reliability by means of physical protection seems required!³⁸ If for example a reliable report from the vehicle about the license number and/or the full classification of the vehicle is considered to be necessary for the desired traffic fee system, these data can be held and supplied in a sufficiently fraud-resistant way by a (for example under seal installed) component. It may concern a separate, special component for just this purpose (i.e. what we will call a specialized agent in chapter 16), but a (general) agent that is attached to the vehicle in a fraud-resistant way can also perform this task. We will return to one thing and another in chapters 14 and 16. ³⁸ As we have shown already earlier, we are of the opinion that it is in general wise to trust (rely) as little as possible on (just) physical protection (alone), among other things because a high level of physical security often goes hand in hand with high costs.

11.10 Checks Based on Difference or Differential Quotients

We have illustrated with the above that it is, more in general, possible to carry out checks on precision by receiving a value at each of two points to be passed successively and by seeing whether the difference between the two reported values agrees with a reference or calibration value that has been obtained in a different, reliable way. The reader has probably sensed the suggestion (and not unjustly) that these two points must be at a certain distance from each other. However, the moment now seems to have come to point out explicitly the possibility of carrying out checks with the help of difference quotients or differential quotients. (These last two terms are, supposed to be, mathematical terms, that is, we mean quotients whereby whether or not infinitesimal differences are involved.) Put differently, in principle one might choose the distance between the measuring points to be very small and one might have difference or differential quotients be transmitted from the vehicle. In chapter 16 we will illustrate this possibility by showing that verification of (checking on) an odometer can also take place by using the correct speed at a certain moment (instead of the correct length of a checking-trajectory) as a reference or calibration value.

11.11 Rolling Tester for Further Inspection

If, based on a check, something appears to be incorrect, the vehicle in question and particularly the vehicle equipment in question must be further inspected and verified. Also, one may embed in the law the obligation to have every vehicle undergo (go through) such a further inspection periodically, for example at least once a year.

In addition to a visual inspection for (attempts to) defraud, the further inspection may consist of testing for the correct functioning of the vehicle equipment on a rolling tester developed for that purpose. With the rolling tester all kinds of situations can be simulated and the correct functioning of the vehicle equipment in those situations can be checked, respectively the cause of incorrect functioning can be traced.

12 Use of a Receiver

When every participating vehicle is also equipped with a receiver, this then gives a large number of possibilities and advantages, of which we mention only a small number here.

12.1 Automatic Calibration

For example, transmitters along or over the road can transmit information (for example about the speed of the vehicle or about the correct distance between two points to be passed), that makes it possible after reception in the vehicle to calibrate certain equipment (in our example the odometer and the speedometer) automatically.

So, one advantage is that odometers and speedometers can be calibrated fully automatically while driving on certain parts of road, so that they continue to work accurately all the time. In this way the influence of tire wear on the accuracy of odometers and speedometers might even be removed. In a similar way, for example, a thermometer that is attached to the vehicle to determine the outside temperature can also be made self-calibrating, i.e. check itself automatically and/or adjust itself based on a transmitted reliable temperature for the location of the vehicle. By ensuring that the thermometer in a vehicle can register the outside temperature more accurately, there could for example be a more accurate warning for possible slipperiness as a result of freezing.

It is self-evident that other measuring equipment in vehicles can also be calibrated automatically in a similar way. The reverse is also possible, namely that measurement equipment along the road calibrates itself, i.e. checks itself for correct functioning and/or adjusts itself automatically, based on the measurement values provided by passing vehicles. After all, one might calculate a value, like for example the temperature, in a certain place fairly accurately based on a sufficient number of values measured and supplied by passing vehicles. So, the automatic calibration of the measurement equipment, like for example speedometers and thermometers, can be about measurement instruments in vehicles as well as about measurement equipment along the road and it might even be done mutually.

12.2 A Few Other Advantages

The use of a receiver also makes it possible to prevent the clock from deviating too much in the long run and to handle time changes (when crossing a time zone border and when changing from summer to winter time or vice versa) automatically. Because speed is a quantity derived from the distance traveled and the time, the measurement of the speed in a vehicle can be done with extra accuracy if it is known by how much its clock speed deviates. Further it is possible to use a different algorithm (price function) for every tariff area, consisting of a certain part of road or of all the roads in a certain area. Thereto, one may have transmitters at all the crossings of borders between tariff areas to inform passing vehicles of the tariff changeover. Another advantage is that a new calculation method, i.e. tariff function, can also be received. This can be used for example to implement a tariff increase or to adjust the valid peak times.³⁹ ³⁹ A receiver can be used beneficially with the examples mentioned here, but it is not absolutely necessary. For example, a tariff change when entering a different tariff zone (area) can also be set manually or be done automatically with the aid of a GPS.

The transmitters of the infrastructure (often along or above the road) and the receivers in the vehicles could also be used for the distribution of new software in general and of new software on behalf of the traffic information system in particular. By ensuring that software that is provided with a correct signature, can be installed and put into operation automatically to replace an earlier version, certain changes or adjustments might be made even without intervention of the user or holder of the vehicle.

The receiver can also be used to limit the transmission from the vehicle to a short period after every authorized request. Probably the most important advantage of this is that less bandwidth is necessary for the communication with all vehicles. For the protection of privacy this has the advantage that is becomes somewhat more difficult for third parties to eavesdrop the message traffic. Furthermore, possible attempted misuse by the government (for example, an attempt to still trace all traffic by putting a transmitter/receiver on every street corner) will become more conspicuous, respectively will be easier to detect. On the other hand is it a disadvantage from the viewpoint of fraud prevention, when one can find out in every vehicle at what moments and/or places data are requested by inspectors. After all, without extra countermeasures the protection against fraud by checking at random will then generally get weaker, because one can then anticipate or gamble better on moments at which tampering with the counter will probably not be discovered. (See chapter 16 for further details.)

It thus seems that, in case of exclusively remote checking, one has to make a choice between either 1) a simpler fraud prevention and more (need for the) use of cryptography to protect against eavesdropping, or 2) more difficult fraud prevention but less or maybe even no (need for the) use of cryptography for the privacy protection. Because cryptography will often be required anyway, for example in order to keep the secrecy of and/or to provide digital signatures on messages, when making this choice the scales may tip in favor of (almost) continuous transmission. However, the in chapter 16 described approach without continuous transmission from vehicles, but with supervision by agents in vehicles, offers a very attractive alternative. By the way, this latter approach usually does make use of receivers in vehicles.

Of course the receiver can be used for many other purposes as well. For example, on reception of a certain code or of an appropriate message (co-)signed by the holder or owner, there could be switched to adding a full identification to each message transmitted and possibly also to the continuous transmission of an identification. Such a provision can be used amongst other things for tracing vehicles after for example theft. It is for example also possible to inform passing vehicles frequently via transmitters along the road about for example traffic jams and delays or about the locally valid speed limit. The given speed limit can for example be used to warn the driver when he is speeding. In the following is described how the traffic safety can be increased by having speed limits be respected automatically.

12.3 Automatic Respecting of Official Speed Limits

We propose to implement the equipment for cruise control in such a way that it is able to (begin to) use the messages disseminated by the traffic information system about speed limits. In this way the driver can be relieved of a part of his task, because the maximum speed to be driven can then be adjusted and obeyed automatically. Adjustment to a higher maximum speed will then normally only happen if this maximum allowed speed is still lower than the desired speed that the driver has ordered to the cruise control.

Such a provision will no doubt benefit the traffic safety. The task lightening for the driver alone could already ensure a positive effect. Additionally it is prevented that the official speed limit is exceeded accidentally, for example because the driver misses a traffic sign with a speed limitation. Besides, the speed of vehicles can likewise be gradually adjusted when approaching a traffic jam and in a traffic jam (traffic queue, tailback) the speed of the vehicles can be made fairly homogeneous and even.

When in the long run all vehicles are (can be) equipped with such apparatus (at an acceptable cost), a better basis for strict maintenance of maximum speeds will arise as well, because there will then be no longer a reasonable excuse for speeding accidentally. By strict maintenance, which will become very well possible with the traffic information systems proposed by us, traffic safety can increase even further. Think for example of maintaining the speed limitations in residential quarters, respectively in residential precincts.

Finally it brings a substantial cost saving as well, when it shows that less (construction and then maintenance of) traffic bumps and tables (speed ramps) and other speed discouraging provisions will be necessary. Besides, think also of the savings as a result of reduced wear of for example springs and shock absorbers and of the saving in fuel consumption. (The current practice of braking before and accelerating again after a speed ramp is also extra damaging to the environment.)

Note that such equipment for cruise control also offers drivers the possibility to drive, if desired, as fast as possible without exceeding a speed limit anywhere. At first sight this might seem a traffic safety unfriendly application, but yet it can definitely benefit traffic safety! After all, in practice it happens all too often that one wants to go somewhere as fast as possible. When drivers without such an aid try themselves to stick as much as possible to the maximum allowed speeds, that costs a high level of attention and concentration, while they will still exceed the maximum speed every now and then, even without really wanting to do that. With a mass use of this facility on highways, the speed variations and differences will decrease, which will benefit traffic safety additionally.

12.4 Support with Inserting on Highways

The collaboration between the TIP-system and the cruise control might go even further in the long term. For example, support could be offered for entering (inserting on) a highway. The traffic information system can then, for example, determine an entry position between the vehicles already driving on that highway and, if necessary, influence the speed of those vehicles and of the entering vehicle in such a way that entry (insertion, merging) happens safely, smoothly and without problems. We will not go further into the details of this.

13 Privacy Protection

In this chapter we will pursue the matter of how payments and verifications can be arranged and how at the same time sufficient privacy protection can be offered. We base our explanation primarily on the situation in which the traffic fees are settled via giro or bank account, for example by means of automatic payments based on a prior authorization. Later we will also glance at the possibility of direct payment in the vehicle by means of a chipcard.

As mentioned above, we assume that the fee collector also functions as inspector. In case verifications would be contracted out to several independent organizations, the privacy of the traffic participants is less threatened, so that it then will be easier to protect privacy. Thus, we limit our explanation here to the more difficult case whereby the fee collector himself is the only inspector.

13.1 Direct and Indirect Identifications

For the identification of a payer there are several possibilities. For payment it is not necessary that the authority, in this case the fee collector, knows exactly who is the payer. So, a direct personal identification, as is the case when using e.g. a driver's license, passport or social security number, is not strictly necessary and even can be undesirable. From the point of view of privacy protection, it is generally better to use a suitable indirect identification (think of a bank account or credit card number, for example), so that the fee collector does know where the bill should go to, but not also immediately knows who is (hidden) behind this identification.

Normally, the organization that has given out a certain indirect identification number for this purpose, will (have to) keep secret which person is behind that number. Of course, this requires laws that also describe in which circumstances the organization concerned may, or must, reveal the identity of the corresponding person.

Note that it is not true that any indirect identification will do. For example, if each vehicle has one corresponding holder (owner), the vehicle's license number identifies the holder of a vehicle indeed indirectly. Nevertheless, license numbers do not guarantee sufficient privacy protection to holders if the license number registration is, as usual, completely accessible to the government. (Of course one could also consider to remove the association between vehicles and holders from the license number registration of the government, and to protect privacy by relegating this association to one or more separate organizations.)

13.2 Fraud-resistant Components, e.g. Chipcards

The addition of some identification number may, at first glance, seem unacceptable for the desired privacy protection. However, there are various possibilities to protect privacy sufficiently while still using identification numbers. One interesting possibility concerns the use of chipcards, or other combinations of hardware and/or software, whose fraud-resistance the authority is willing to trust⁴⁰. Henceforth, we will only speak of chipcards, although the explanation is also valid for all kinds of other manifestations, including e.g. chipkeys. ⁴⁰ In this section and the two next ones, we get somewhat ahead of the later treatment of the use of agents.

In case of securing chipcards against all sorts of fraud, always some kind of physical protection will be present. For example, if, as usual, cryptography is used for the protection of the chipcard and of its functioning, then the card will contain at least one key (i.e., one bit pattern) whose secrecy can only be warranted by physical protection. Therefore, if a system uses chipcards, the security of the overall system depends also on (the quality of) this physical protection. In practice this appears not to encounter difficulties, as in case of chipcards one apparently can provide for a sufficient physical protection against theft of a (cryptographic) key.

Anyhow, the organization that issues the chipcard, can build in enough safeguards to (dare to) guarantee that the chipcard only functions, and can be used, as intended. As a consequence, it is, for example, possible to let anonymous payments be performed by means of such a chipcard. We assume that the use of such chipcards for anonymous or semi-anonymous payments is already sufficiently known and that it is not necessary to describe in more detail how such (semi-)anonymous payments can contribute to a well set-up (virtually waterproof) TIP-system whereby privacy is sufficiently protected. Yet, we will now digress somewhat further on a number of relevant aspects of the possibility to use chipcards for other purposes than payments. The further treatment of the possibility to use chips in general, and chipcards in particular, for e.g. (more) trustworthy providing of data from (within) a vehicle, will take place in chapter 16.

13.3 Anonymous, Anonymously Delivered or Semi-anonymously Delivered Chipcards

Chipcards can be anonymous or be delivered anonymously or semi-anonymously. We call a chipcard anonymous if it is not (sufficiently uniquely) identifiable. The holders of such a chipcard and/or vehicles in which such a chipcard is used, can self-evidently not be identified exclusively on the basis of the card used if this card is anonymous. But also if every chipcard itself really is identified by means of a unique identification number, i.e., if it is not anonymous, identification of the holder of the card and/or of the corresponding vehicle can be avoided. This can be arranged by delivering such identifiable chipcards anonymously or semi-anonymously. We speak of anonymous delivery if it is not registered to/for whom or for which vehicle a certain chipcard, whether or not upon payment, has been issued. In case of semi-anonymous delivery this really is registered, but by separate organization(s) that act as privacy protector(s). In this case the association between chipcard and holder and/or vehicle may only be disclosed under conditions that are clearly described by law, and even then only to the government. (This is, to a certain extent, comparable to the delivery of, for example, secret bank account numbers or secret telephone numbers.) In the case of semi-anonymous delivery, we can therefore speak of a form of indirect identification.

13.4 Privacy Protection when Using Chipcards or Chipkeys

It goes too far to treat exhaustively all possible ways in which with the aid of (semi-)anonymously delivered and/or anonymous chipcards a well set-up, virtually waterproof TIP-system can be obtained whereby privacy is sufficiently protected. We now only point out the possibility to make (certain forms of) fraud impossible by invoking the help of a chipcard for the (verified) supply of data, like for example odometer readings, from (within) a vehicle. In fact we here are already discussing an approach using agents, to which we will devote an entire chapter later on. Since, as will become clear later on, chipcards can act as agents, we actually give in chapter 16 also a further illustration of this possibility to use chipcards. This later illustration is considered to be sufficient for persons skilled in the art.

At this moment it is actually only of interest that the reader sees already that it is easier to protect privacy with the use of anonymous, anonymously delivered or semi-anonymously delivered chipcards than without. We now give in the following an extensive explanation of the more difficult case whereby no use is made of (semi)-anonymously delivered or anonymous chipcards to represent persons and/or vehicles.

13.5 Privacy Protection when Using Personal or Vehicle Identification Numbers

As remarked before, the addition of an identification number may seem at first sight to be unacceptable for the desired privacy protection. In the previous section we have already suggested that privacy can rather easily be protected if the identification number identifies a (semi-)anonymously delivered chipcard. In the following we will show that one can also offer sufficient privacy protection if the identification number does really identify a person or vehicle.

The point is that it is well possible to prevent that one can trace systematically the movements of the vehicle and/or the payer. We will show that this can be done particularly by creating a chain of organizations, whereby we will draw a distinction between hunters, intermediaries (specialized privacy protectors) and the eventual addressee(s), respectively message receiver(s), whom we will occasionally call final receiver(s). (As mentioned before, we do not make a distinction between inspectors and fee collector, so that in our example of traffic fees the fee collector is the final receiver.) Messages are in this case only being delivered to the final receiver after intermediation (intervention) of a hunter and one or more intermediaries. Of course, there are also all kinds of other solutions/variations possible. For example, one or more of the ideas that are hidden behind what is explicitly sketched here, may be combined in another way in order to get a well set-up (virtually waterproof) system.

13.6 Hunters

The idea is that the authority (respectively, the fee collector) may not find out at which places (locations) the senders of the messages were at the time of the receipt of the messages concerned. We will assume, and in practice this usually will also be the case, that during receipt of a message one may (in principle) be able to determine rather well the place where the sender is. Therefore, at first sight it seems essential that the authority (respectively, the fee collector or, more in general, the government) should not be given direct access to the messages transmitted by the traffic.

For completeness we remark now already that this does not necessarily mean that the authority in question, for example the fee collector, will not be allowed to collect the messages on his own. For, this can do little harm if intermediaries (see later) are used and if the contents (if each message are unreadable to that authority (respectively, that fee collector) at the moment of collecting. Although we are primarily concerned here with the secrecy of the place of transmittal of a message, the secrecy of the contents of a message thus really is an important aspect as well. One thing and another will become clear(er) before long.

Anyhow, for the sake of collecting (receiving) messages from as much participating vehicles as possible without interfering with the traffic one may call into existence independent, mutually competing organizations that offer themselves to the government as (what we will call) hunters. In the case that the final receiver is, for example, a verifying authority or fee collector, he probably will pay the hunters for, among other things, picking up messages of as much participating vehicles as possible and/or for doing so at the most exceptional locations.

For this purpose each of these hunters may install at various fixed locations receivers for continuous use. Besides, each hunter may also install receivers temporarily at varying locations and times. These last-mentioned receivers thus are moved regularly. Finally, a hunter may also use receivers that are moving (almost) continuously (for example, because they are driven about), to make that (because of fraud attempts or otherwise) incorrectly functioning vehicle equipment has as much chance as possible of being ‘caught.’

The fanaticism by which messages are being hunted for, is emphatically of importance for achieving good inspection. At first instance it seems wise not to let this task be performed by the verifying authority itself, but to move this task from the public to the commercial domain and to make that the hunters are kept ‘sharp’ by introducing competition. By making the height of the hunting wages conditional on the success of the hunter, ‘sharpness’ may be extra stimulated.

Through regulations one can arrange that each individual hunter must restrict himself to a ‘light armament’, i.e., that he must confine himself to a sufficiently small network of receivers with a certain geographic spread. Nevertheless, the total network of all hunters may be very extensive indeed, of course. The set-up with independent hunters thereby has a number of advantages with regard to the protection of citizens against their own government: 1) the government has no direct access to any receiver in this network and therefore needs permission of a hunter to be able to utilize a particular receiver in a lawful way, and 2) the government can only obtain access to a substantial part of this network in a normal way with cooperation of several hunters, so that even conspiring with one or a few hunters does not or hardly pay off.

The described set-up gives all in all a certain protection against possible attempts of the government yet to be able to trace, if need be in an illegal way, the traffic rather well by means of a very dense network of receivers. For, the government cannot use the network of the hunters without further ado and thus either has to ‘break into’ a very large number of receivers of that network, or has to create especially for this purpose a network of receivers of its own. Both possibilities seem to be rather costly and also seem to be almost impossible to be realized unnoticed.

Finally, we remark that one, to be quite on the safe side, can oblige hunters to keep the place of receipt (or, better formulated, any possible indication of the place of the sender at the moment of receipt) of every message caught by them, secret. Additionally one might possibly also prescribe that for certain kinds of messages the precise time of receipt must be kept secret as well. Of course, one can (and in general will) make a number of precisely described exceptions on these obligations.

An extreme case is that the law will forbid hunters to even register the place (and perhaps the precise time of receipt) of messages⁴¹. However, it is also possible, for example, to dictate that hunters only during a certain limited period after receipt of each message may and must register where the sender must have been at the moment in question, while at the same time only in specific, by law clearly described circumstances may be deviated, in a prescribed way, from absolute secrecy. We will later come back to the use of such a registration for the benefit of interventions, like for example video shots, at the proper place. ⁴¹ Later it will appear that it is more pure to let hunters not also act (partly) as intermediary. In the case of these ‘pure’ hunters such a legal prohibition seems not to be extreme at all. See further on in this chapter.

13.7 Intermediaries as Privacy Protectors

Although in the above-mentioned way a reasonable protection can be offered already, we need not be satisfied yet. After all, the primary interest of the hunters does not always have to be the privacy protection of citizens, certainly not if they are paid by the fee collector or, more in general, the government. Moreover, we want a better protection against the possibility that the government can get, through a network of its own, to know more than some people care for.

We will now show that an important contribution to the total protection can be made by having all messages coming from the traffic be enciphered in such a way, that neither the government, nor others can read their contents without first getting help from one or more independent, privacy protecting organizations, which we will call intermediaries henceforward. The purpose of the use of intermediaries is to hinder the undesired tracing of vehicles and/or responsible payers as much as possible.

The idea is that the holder of each vehicle and/or each payer, from now on both to be called sender, chooses himself at least one intermediary, who will then furnish the desired service. (We will here not go further into the matter of how the intermediary gets paid for furnishing these services.) The mandatory, from a vehicle to be sent messages will then, before transmission, be enciphered in such a way by the sender using cryptographic techniques, that they can only be deciphered by the chosen intermediaries. Almost the only thing that intermediaries have to do is to decipher the messages destined for them and delivered to them via hunters, and next to forward these deciphered messages to the final receiver (e.g., the fee collector) or the next addressee on the route to the final receiver.

An essential point is that by means of cryptographic techniques it can be ensured that only the intermediary chosen by the sender will be capable of deciphering the message in question. Furthermore, it is for outsiders, even if they can eavesdrop/intercept the message stream to and from a certain intermediary, impossible to figure out which incoming message belongs to which outgoing message of that intermediary.

In the following we will limit ourselves in our further explanation to the case that the whole message is made anonymous. Of course it is also possible to apply the described techniques only to a part of the original message.

More in detail, the service that intermediaries must provide, in general consists of: 1) deciphering each message that they receive via a hunter and possibly other intermediaries, i.e., removing the protection against reading (by anyone else but the intermediary) from the message in question, 2) forwarding the deciphered message to the next addressee (e.g., the final receiver), and 3) keeping secret the relation between incoming and outgoing messages. In later sections we will explain that intermediaries, if necessary will also 4) keep a certain administration about the relationship between incoming and outgoing messages in order to be able to send a possible reaction of the final receiver (to the by him received message) back via the reversed route to the hunter via which the message had come in. Later we will see that, if the message comes form a ‘pure’ hunter, the (first) intermediary in addition has to remove first of all the place and the point of time.

The third point mentioned states that this administration must be kept secret. It might be clearly embedded in law in which specific cases and circumstances one may deviate in a prescribed way from absolute secrecy. Also it can be embedded in law that intermediaries for each message may or must register this relationship only for a certain limited period of time after reception.

By calling intermediaries into existence as sketched above, one can arrange in a reasonably simple way that the privacy (at least as far as movement patterns are concerned) will not be violated, not even if we assume that the hunters can locate the sender of a message. The latter will in general be the case if the receivers are placed alongside or above the road.

13.8 Per Message Varying Intermediary

We point out that one does not have to choose for one fixed intermediary and next be dependent for one's privacy on the integrity of this one organization. For, one can also choose several, and possibly even all, intermediaries from the available ones, and then make for every message to be sent a random choice from the pre-selection made. The messages then are going via continually varying intermediaries. In other words, the stream of messages of such a randomly choosing client is ‘cut in pieces’ and spread over various intermediaries, which will certainly benefit the privacy protection. After all, even if a certain intermediary conspires with a hunter to illegally find out one thing and another about the movement patterns of such a client, then these two still can capture only a small, random part of his message stream.

13.9 Messages Only Readable for the Final Receiver

By the way, one can ensure that no intermediary and/or hunter can read the contents of the messages and therefore that they cannot or hardly get information about movement patterns. For, the messages additionally can be obfuscated (enciphered) in such a way that they, after being deciphered by the intermediary, can be read only by the next addressee (e.g., the final receiver). Thus, the hunters and intermediaries then simply receive messages and process those messages without being able to understand anything of the contents of the messages any further.

In this case messages (or parts of these, but we have already promised not to treat such a case explicitly) thus are (at least) doubly enciphered. One time to make the message only readable by the actual, say second, addressee, and after that another time to pack (wrap) the message in such a way that this second addressee can only read it with the help of (i.e., after deciphering by) the intermediary, i.e., the first addressee. In short, as long as an intermediary does not conspire with the second addressee (say, the final receiver), this intermediary cannot distil any information from the contents of the received and forwarded messages.

In the way just described, whereby always the whole message is obfuscated (i.e. made secret) for anyone else than the final receiver (respectively, the next addressee), there is no danger at all to be feared from the intermediaries and/or the hunters.

13.10 Several Intermediaries for One Message

Of course the privacy of a randomly choosing client now still can be violated for a small part if an intermediary conspires with both a hunter and the final receiver, at least if this last one is the second addressee. But by using a series of addressees and applying the corresponding series of encipherments to a message, one can ensure additionally that a message will have to go via a number of successive intermediaries. For example, in case of 3 intermediaries between the hunter and the final receiver, the privacy can only be violated if all 5 mentioned organizations conspire. If one always chooses the intermediaries to be used anew and randomly for each message, then such a possible violation still will concern only a small, random part of the stream of messages sent by a certain sender.

By the way, let it be noticed that the use of one intermediary for a message already seems to offer sufficient protection and that in practice probably there will be little need to use more than one intermediary for a message, at least for some time to come.

13.11 Return Messages, Such as Requests for a Counter Action

In some cases it is necessary for example to make (or to let make) a video shot of the vehicle belonging to a transmitted message. If something is wrong with the transmitted message, say a declaration, but it has been signed correctly, then the final receiver, say the fee collector, can identify the one responsible and thus usually also track him/her down. Thus, a counter action in the form of for example an arrest or a video shot then does not seem to be necessary. But if it concerns a declaration (respectively, a message) without a correct signature, then a counter action, like for example an arrest or the making of a video shot, should be set going at the place where the vehicle is.

This is possible without the final receiver getting to know the location of the vehicle. We will outline explicitly one relatively simple possibility that goes as follows. According to legal prescriptions every hunter assigns at reception of a message a unique number to it, and then registers this number for a short period of time together with (an indication of) the place of reception (respectively, the place from where the message has been sent). The message itself needs not or may not be kept by the hunter, but does have to be forwarded to the specified intermediary with this number attached to it.

Each intermediary removes this number from each incoming message, takes care of ‘unwrapping’ the message and then forwards it to the next addressee with another unique number attached to it. Each intermediary keeps for a certain time the combinations of incoming and outgoing message numbers that belong to each other, and from whom the incoming message was received.

If the final receiver for example wants to have a video shot of the vehicle in question made, then he sends to the intermediary from whom he received the rejected message, a signed request for such a counter action with mention of the message number earlier attached to the message by this intermediary. (That the request must be signed has to do with preventing abuse of this possibility.) The intermediary looks up in his administration which incoming number belonged (corresponds) to this outgoing number once chosen by himself. Next he forwards the request together with the found incoming number to the corresponding, registered sender.

In this way the right hunter will eventually get the request. The hunter looks up in his administration the right, corresponding location and takes care of (really starting) the counter action, say the video shot, on that location. Thus, hunters are not only paid for hunting messages transmitted from (within) vehicles, but also for carrying out counteractions on authorized request, i.e., for (a part of) the ‘hunt’ for possible violators.

13.12 ‘Opening’ Locations for the Benefit of Inspections

For carrying out certain inspections, in particular for checks on the correct functioning of odometers, it can be desirable that the inspector knows what the distance is between two places that a vehicle passes successively. For this purpose one may temporarily withdraw the secrecy of a number of locations. Thus, the inspector will even this case surely not get unrestricted access to the information about the places (locations) of reception, but must each time apply in advance for such access for a number of checkpoints. Obviously, access will then only be granted for a limited time and with regard to a limited number of varying locations.

13.13 Hunter Rather Not as ‘Half’ Intermediary

In case of the arrangement of the whole chain as described above, the hunters take care already of (a part of) the privacy protection by partly operating also as an intermediary. The only substantial difference of a hunter compared to a ‘normal’ intermediary seems to be that the client does not himself choose the hunter. So, if there are several hunters, it is also impossible to send secret messages to the hunters, because the client does not know beforehand which hunter will catch the message.

With a somewhat different and properly also more pure and better approach, a hunter does not act at the same time as an ‘half’ intermediary. In this approach the hunter adds to each received message the place, date and time of reception and then signs the thus resulting message. It is then not necessary anymore that every hunter keeps an administration to be able to specify later at which place the message had been received, respectively at which place the vehicle was during the transmission of the message. (Even better, this can then even be forbidden.) The first intermediary in the chain keeps the complete, by the hunter signed message, but only forwards the original, from the vehicle transmitted message to the next one in the chain. Thus, the kept message registers the place of the vehicle at the time of transmission, respectively the place of reception by the hunter, and can, if necessary, later be brought up as piece of evidence. The latter is an advantage over the previously sketched variation.

Note that a final receiver, like for example a government agency, now might operate himself as ‘message hunter’ without the privacy protection necessarily being jeopardized. For a really good privacy protection it does remain necessary to deny the government unrestricted access to certain things, like for example video cameras along the road. Certain counter actions, like for example making video shots, should therefore preferably be delegated to independent ‘suspect hunters.’

13.14 A Description of Hunters and Intermediaries

It goes too far to treat all possible variations on the tasks of and on the distribution of tasks between hunters and intermediaries. The foregoing explanation is deemed to have sufficiently illustrated the basic idea. Now this idea has been made clear, we will make an attempt to give a concise description of the notions of hunter and intermediary.

A hunter is an organization that manages at least a part of the means for transmitting and/or receiving being present in the outside world (i.e., being outside vehicles) for the sake of the communication between vehicles and (the rest of) the traffic information system (respectively, the authority) and that makes a contribution to keeping secret as much as possible the position of a person or a vehicle, in particular at the moment of reception of a message from that vehicle.

Primarily we allude here to the ‘pure’ hunter as described in the previous section. A ‘pure’ hunter keeps no administration and forwards each received message to an intermediary, but only after both 1) having added to the message the date and time of reception, the place of reception and/or the place of the person or the vehicle at the moment of reception, and 2) having signed the thus resulting message. (If one is content with a weaker system, one can drop e.g. the last requirement.) A ‘pure’ hunter can thus only function if there is also at least one intermediary. Carrying out certain counter actions, i.e. the task of ‘suspect hunter’ (see the previous section), can also be counted as one of the tasks of a ‘pure’ hunter.

Secondarily we use the term hunter also for a hunter that additionally performs (all or at least part of) the tasks of an intermediary. (In other words, for a hunter that also acts as a ‘whole’ or ‘half’ intermediary.)

An intermediary is an organization that is independent of the authority and that for the benefit of the privacy protection acts as a middleman for the communication from vehicles with the authority. An intermediary (more precisely, the first intermediary in a possible chain of intermediaries) separates the signature of the hunter and the data that have been added by the hunter (i.e., place and point in time) from the message and keeps this for a certain time in a privacy protecting way. The rest of the incoming message is deciphered and forwarded to the next addressee, i.e., the final receiver or the next intermediary in the chain. If an intermediary receives a certain message not as the first intermediary in the chain, then only the in the previous sentence sketched task need be performed on that message. Besides this, all intermediaries will in one or another way take care of making return messages possible.

13.15 Applications of the Sketched Approach for Privacy Protection

It goes too far to treat all possible variations exhaustively. On the basis of the first described approach and the just described variation with hunters and/or intermediaries, the basic ideas are deemed to have become sufficiently clear. For a person skilled in the art this will be sufficient to be able to apply the protection (measures) against illegitimate tracing in a TIP-system (thus including all kinds of variations falling under such a system).

We have shown how the privacy can be protected, even if messages with an identification are continuously being transmitted from each vehicle. The said identification cannot only be used for traffic pricing, but, if desired, also for other applications, like for example speed measurements at certain places (locations). In the next chapter we will first digress somewhat on (problems with) the identification of persons and objects, before we will show in chapters 15 and 16 that the use of hunters and/or intermediaries can also be avoided.

In chapter 15 we will show that for a number of applications semi-identification numbers can be used instead of identification numbers. The ‘detour’ via hunters and/or intermediaries is then no longer necessary for the protection of privacy. In chapter 16 we will show that the use of identifications can be reduced even further, namely so far that the use of hunters and/or intermediaries is not or hardly necessary anymore. The use of agents and semi-identifications will therefore appear to be a very attractive option.

14 Identification

We have used the term identification already many times somewhat loosely, namely to denote an identifying datum or an identifying combination of data. Undoubtedly, we will do that still more often, although strictly speaking the term identification concerns (the process of) the ascertainment of the identity of a person or thing. In this chapter we will enter into some details of (especially) the latter.

14.1 Problems with the Identification of Vehicles

When registering a vehicle in the central license registration in the Netherlands at present a license certificate, consisting of a number of documents, will be issued. These official documents are liable to all sorts of fraud. Furthermore, not only these paper documents, but in particular also the corresponding vehicles are tampered with. According to news-reports driving with false license plates (which is terrifically easy and seems to yield a too low probability of being caught already for many years), but also (the more difficult) tampering with identification numbers on chassis and engine (such as modifying, removing and/or re-creating) seem to happen all too often. Therefore, there is need for a more fraud-resistant way to couple (i.e. logically associate and/or physically attach) license numbers, chassis numbers and the like with vehicles.

One possible idea is to furnish the vehicle with a component that contains the chassis number (or the license number) and that can make this number available to the outside world. However, making a constant bit pattern available may lead to undesired problems. For, the disadvantage is that the bit pattern in question can be intercepted. (And that is all the more a real possibility if the bit pattern is sent via a transmitter.) Thus it is possible to make false components that do exactly the same as the original. In other words, the problem is that the receiver of the bit pattern cannot ascertain (remotely) the authenticity of the bit pattern and of its sender. In short, when using such components fraud seems to be easy in general.

14.2 No Interchange of Constant Data for Identification

This objection against the use of (passive) components that make a constant bit pattern available, is somewhat comparable with the objection against the use of passwords or pin-codes for securing the use of identification aids, such as magnetic cards (‘PIN-passes’), that are applied for many systems, like for example payment systems and automatic teller machines. The objection is in both cases that during normal use a constant datum must be interchanged and that this constant datum runs extra risk of being intercepted especially during this interchange. Think, for example, of interception by peeping at the keyboard without being perceived (for example, by using mirrors and/or a hidden video camera or by using an inconspicuous substance on the keys) or of eavesdropping the (tele)communication during the sending of the PIN-code or the password. After interception a copy of the constant datum can be used as original, because there is for bit patterns no difference between original and copy.

14.3 The Problem of Fraud-resistant Identification in General

Consequently, in general it is true that for good protection against fraud (direct) interchange of crucial information should be avoided as much as possible. Therefore, it is better to (indirectly) proof that one possesses certain crucial information, without revealing that information itself⁴². This approach is known as using challenges, whereby one must show that one is capable of something unique. ⁴² An alternative is to arrange that crucial information is not crucial anymore immediately after the first interchange, i.e., to use each time a different bit pattern. So, one still may use passive (memory) means, like for example a magnetic card. However, because it is easy to read, modify and write the bit pattern on e.g. a magnetic card, this alternative is still subject to various difficulties. Anyhow, we do not enter here into more details of this alternative and its limitations.

A good example of this approach is unique identification by means of putting a digital signature. One then shows to be capable of putting a signature on a certain message without revealing the bit pattern (i.e. the key) on which that signature is based⁴³. ⁴³ To skilled persons it will be clear that here we have in mind particularly the use of asymmetric cryptography, or public key cryptography. The mentioned key that is not revealed, then will concern the private key.

Of course, the message on which the signature is to be put, should be usable only once (for, copies are not allowed to have any value) and thus must be a new one each time again. Furthermore, it must be an absolutely harmless message, that is, signing it may not possibly lead to undesired consequences. For example, it may certainly not be such that by signing one enables the other party directly or indirectly to obtain a false signature on another message (e.g. a contract) with undesired consequences.

Without wanting to enter into details of all further difficulties, we give one suggestion for such ‘harmless only-for-identification messages’ and a corresponding identification protocol. To meet the requirement of uniqueness and inconstancy we require that each such message contains the point in time concerned in a certain, prescribed and constant format. To prevent that somebody can use elsewhere and (almost) at the same time a copy of someone else's identification to falsely impersonate himself as that other person, each such message must also be specialized for the one identification process in question. This can be done, for example, by arranging that the identification questioner (inquirer) must always first send a signed identification request⁴⁴ that contains the time of that request, to the person or object to be identified and that the to be identified object or person (at least, if he or she wants to meet the identification request at all) then signs that identification request, preferably after self having added to it the point of time of signing. ⁴⁴ This also solves the problem of forgeries, like for example counterfeited automatic teller machines.

For the rest we remark additionally that in certain cases it is possible to use identification means with a (partly) collective signature. If the care for the supply and the correct working of the identification means is entrusted to a certain organization, it is for example possible to have several, and possibly even all, identification devices making use of the same ‘basic signature’. The ‘basic signature’ then serves to proof that the identification device in question is original, i.e., is handed out by the thereto-authorized organization.

That organization then does have to arrange that each identification device possesses a unique identification number too and that this unique number always will form part of each signature put on any identification request with the help of the ‘basic signature’, for example, by adding the unique number to the to be signed identification request before signing it. This unique identification number thus must always be used together with the ‘basic signature’ to form the complete, identifying signature. Consequently, it must be protected against theft just as well as the key of the ‘basic signature’. In other words, the unique key on which the complete signature is based, consists in this case of both the unique identification number and the collective key used for the ‘basic signature’.

All in all we hope that the above text has made sufficiently clear that for good identification one needs preferably some means being capable to perform the required processing, say, a small device that can put signatures. If each such a small device is sufficiently protected against theft of its key, i.e., of the key on which the digital signatures that can be put with it are based, then that small device is sufficiently protected against impersonating by a forged copy.

If we are capable of making small devices that can identify themselves uniquely and fraud-resistantly, we strictly speaking have not found a solution yet for the identification of arbitrary objects (also including persons). For, to be able to use such devices for fraud-resistant identification of objects (persons inclusive), we still have to connect (couple) these in an adequate way with the objects in question as well. In the following two sections we will enter into somewhat more details of connecting (coupling) identification devices with persons, respectively vehicles.

14.4 Personal Identification

If we hand out to each person one unique and fraud-resistant identification device, we therewith do not attain (yet) that each owner of such a device can identify himself fraud-resistantly. For, the identification device can, for example, be lost or stolen. So, among other things, care must be taken that the identification device cannot be used without permission of the rightful owner. The latter is sufficient in case of, for example, transfer of payments, but not for personal identification. For reliable personal identification the device must be associated fraud-resistantly with one correct person, which implies that it must even be prevented that the identification device can come to be used for, respectively by, another person with the assistance of the owner.

For both transfers of payment and personal identification we have found solutions that offer much better security than the existing solutions known to us. Our solution is particularly suited for transfers of payment, because it does not only offer excellent protection against the earlier mentioned risks (like for example leakage of the PIN-code either by peeping or eavesdropping or by errors or fraud within the PIN-code supplying organization), but also is very simple to use in practice. It thus meets the important requirement of practical usability for the general public. However, on second thoughts we have decided not to reveal the solution concerned in the current context, i.e., in this application for a patent on the TIP-system.

14.5 Vehicle Identification

Two sections back we have described how an identification device can uniquely identify itself. By attaching to each vehicle such an identification device one obtains already a significantly more fraud-resistant way of identification than that of the current approach.

For, then it will be prevented that the identification function can be taken over by a forgery. And there is no use in rendering the authentic identification device inoperative only. For, the absence of a well-functioning identification device can sufficiently easily be detected (in particular during the use of the vehicle).

Thus, although the protection of the identification device against actual destruction or removal on itself is still equally difficult, one yet can arrange sufficiently that only rendering the original identification device inoperative by destruction or removal will not pay off at all, by putting sanctions on the absence of a correct functioning identification device.

The only remaining fraud possibility against which still protection is required, thus seems to be the mutual interchange of authentic identification devices of a number of vehicles. Although the advantage that can be gained by interchange will be in many cases (already more) limited, one really has to arm oneself against it in certain cases. The latter is the case if the identification and/or classification (characterization, typing) of the vehicle must be very fraud-resistant, i.e., also resistant against interchanges, for example because different rates are applicable to different vehicle types in case of traffic pricing.

Thereto, one possibility is to attach each identification device to the corresponding vehicle in such a way, that it (almost) impossibly can be removed without fatal damage, i.e., without overriding the correct working of the identification device.

If vehicles are furnished with fraud-resistant identification devices, this offers a number of advantages. One advantage is that traffic violations then can be settled more efficiently and more accurately. Due to the fully automatic identification no license plates have to be recognized anymore, as currently is usual. Furthermore, certain problems resulting from the use of false (or, probably better formulated, misleading) license plates will vanish. To get these advantages it is often not even necessary yet that the identification devices have been attached to the vehicles fraud-resistantly, because it can be avoided in other ways that interchanges will be profitable. (For more details about the latter we refer to the example in chapter 17.)

15 Semi-identification and its Applications

Before going on with treating an important variation, namely the approach using agents, we first introduce the notion of semi-identification and we show some examples of purposes semi-identification(number)s can be used for. One application concerns anonymous inspection (i.e., verification) of the precision of (incremental or decremental) meters. Another application is, for example, privacy friendly and automatic ascertainment of traffic delays, e.g. due to traffic jams.

15.1 The Odometer Reading as Semi-identifying Datum

For inspections on the proper keeping of meter readings it is of essential interest that two messages that are received from a certain vehicle that passes two successive receivers, have a high probability of being recognized as being related to each other. Hereto one can add an identification number (of the vehicle or the vehicle equipment or the like) to each transmitted message. The nice thing is that for the verification of certain meters, like for example odometers, addition of a unique identification is not strictly necessary. For, the odometer reading of a vehicle may itself already be a, what we will call, semi-identifying datum with sufficient uniqueness. (Actually even with too much uniqueness, but we will come back to that later on.)

We will digress on the subject of semi-identification presently. But to improve the understanding of some things, we first explain that almost always one can find back the relationship between related odometer readings. For, because the odometer readings of a not all too large number of vehicles in general will differ sufficiently from each other, two messages will very likely be related, i.e. originate from the same vehicle equipment, if the difference between the two odometer readings reported therein does not, or hardly, deviate from the length of the checking-trajectory. (Note: The size of allowed deviations is not only determined by the required accuracy of the odometer in the vehicle, but e.g. also by taking into account the effect of a fluctuating course of the vehicle. e.g. due to manifold changing of lanes. In short, the accuracy of the inspection plays an important role for the size of allowed deviations.)

If ever there are coincidentally several possibilities to pair messages, like for example in case of two vehicles that shortly after each other enter the same inspection trap with (almost) the same odometer reading, then one has the choice of either 1) start an action against the (two) vehicles involved to make them be further inspected, or 2) just drop these (two) vehicles from the scope of this inspection. As the probability that such a thing happens, is sufficiently small, such escapes from one specific inspection will, in general, not pose a problem.

But in the case that such vehicles are kept outside the scope of the inspection, one has to avoid in some way or another systematic abuse of this possibility. Someone could try, for example, to escape from inspections during a certain period by making his vehicle represent itself continuously (during that period) as two vehicles with the same odometer reading. Such a situation can be detected and thus countermeasures can be taken. Here we are only concerned with mentioning that one has to keep good watch for all kinds of fraud attempts.

Anyhow, the underlying principle of pairing, i.e., finding out which odometer readings are related to each other, is now supposed to have become sufficiently clear to a reader skilled in the art to enable him (or her) to work out concrete examples (further) for himself and to sufficiently understand (the idea behind) the concise formulation below of the notion of semi-identification (number) introduced by us. The just described way of relating we occasionally call the pairing trick.

15.2 Semi-identification

With the term semi-identification we have introduced (in the meaning of semi-identifying datum⁴⁵), we mean a datum⁴⁶ that is not unique and/or predictable enough to be able to represent the corresponding object (respectively, person) all the time (i.e. through time) uniquely within the set of all relevant objects (respectively, persons), but is sufficiently unique and predictable to offer a sufficiently high probability of being able to represent the corresponding object (respectively, person) uniquely within a relatively short period or in a relatively small subset of all relevant objects (respectively, persons). ⁴⁵ The word semi-identification perhaps should be used only for the semi-identification process. Thus, we use it, just like the word identification, somewhat loosely. (See our earlier remark about that at the beginning of chapter 14.) ⁴⁶ Or a combination of data.

In our example the odometer readings were sufficiently unique to be able to distinguish almost all vehicles that pass the start, respectively the end, of a checking-trajectory in a certain limited period from each other with high probability and in addition were sufficiently predictable (at least within the checking-trajectory in question) to be able to find back almost all related pairs. In this example the size of the period in question is (roughly) limited by the maximum time required by one of the vehicles in question to travel the checking-trajectory.

However, odometer readings are not yet good enough for practical use as privacy protecting semi-identification number, as for odometer readings roughly it is true, for example, that the higher the reading is, the more selective it will be, i.e. the more it will approximate a unique identification. Besides, the total number of participating vehicles does also play a role for the degree of uniqueness, just as the smallest distance unit indicated by the odometer does. All this together makes that odometer readings, and particularly high ones, often will have a too high uniqueness for our purposes or even will be uniquely identifying instead of semi-identifying.

Now observe that this is not a problem at all for the just sketched inspections as such, but should be seen as a problem if we take the desire for privacy protection into consideration. In palliation it should be remarked, though, that odometer readings still are much safer for privacy than license numbers or other vehicle identification numbers, as odometer readings change continually and the changes between two observations are not (always) fully predictable. Anyhow, we will explain how one can get better semi-identifications.

15.3 Artificial Semi-identification Numbers

One can also create an artificial datum that is suited for use as semi-identification (number). Namely, in particular by making for each vehicle once-only a random choice from a set with a suitable number of distinct elements and then using that chosen element as permanent semi-identification for that vehicle. Thus, one can, for example, choose for each vehicle once-only a random number from a limited range and then use that number as permanent semi-identification number.

Suppose that for each vehicle a four-digit random number is chosen. Then, in case of a total number of, for example, 5 million vehicles, each semi-identification number will be used by 500 vehicles on the average. (Note: From the viewpoint of privacy protection this is, by the way, still somewhat few.) However, within a random subset of, say, 1000 vehicles the far majority⁴⁷ of the vehicles then really will be uniquely identified by their semi-identification number. So, as long as there are, in this example, at every moment less than, say, 1000 vehicles within an inspection trap, such an artificially generated datum can be used very well to ‘identify’ related odometer readings. ⁴⁷ For a precise computation we refer to the in mathematics well-known ‘birthday problem,’ which is closely related to this.

Despite this local ‘identification’, privacy then still is protected to a certain extent, because the vehicle in question cannot be fully tracked in the traffic. For, even in case of a rather dense network of receivers along the roads, full tracing remains almost impossible, e.g. because of the probability of ‘encounters’ with other vehicles with the same semi-identification number. By the way, note that something similar is true if one would use for the semi-identification a part of the license number, like for example the last 3 or 4 digits and/or characters.

In case of this kind of semi-identification numbers the degree of privacy protection depends, for example, on: 1) the size of the set from which the semi-identifications are chosen randomly, 2) the total number of vehicles in the area in question, 3) the size of the area in question, and 4) the intensity by which the vehicles in question are used. In short, it is not always very easy to choose a suitable (i.e., not too large and not too small) range of numbers.

15.4 Semi-identification Numbers Based on a Meter Reading

The just explained approach can simply be combined with the use of sufficiently predictable meter readings, like for example odometer readings, what leads to a considerable improvement over separate use of one of both methods. Hereto one can simply choose a part of the digits, say four, from the meter reading. For example, if the odometer reading is correct to at least one decimal, one may choose for the rightmost three digits to the left and the leftmost digit to the right of the decimal point of the odometer reading.

For the selection of a (sub)range it is not strictly necessary to choose a number of digits from the meter reading, but is it also possible to use all sorts of computations, like for example computations involving a modulo operator and/or an division operator with rounding to the nearest smaller integer. In the rest of this text semi-identification numbers usually are supposed to be of the type based on a (verifiable or sufficiently predictable) meter reading.

15.5 Verifications of (Incremental/Decremental) Meters with Aid of Semi-identifications

As was already indicated at the beginning of this chapter, the just mentioned type of semi-identification numbers can be used for checking whether meter readings are kept correctly. Not only for verifications of the (incremental/decremental) meter used for the semi-identification number, but of course also for those of other meters. It may surprise some people that meter readings can be used for the verification of meter readings, but it is really so. Although now it actually should be clear already how this works, for clarity we yet give an explicit explanation.

For the verification of the precision of an arbitrary (incremental or decremental) meter, the last so many digits (i.e. a generally small number of the least significant digits) of the meter reading to be verified should be transmitted continually from the vehicle together with the vehicle's semi-identification number. (Thus, if the so many digits are also used as semi-identification, then only the semi-identification number has to be transmitted to be able to verify the precision of the meter on which the semi-identification is based.) Verifications then can be performed by receiving on two points that will be passed by successively, the corresponding transmitted messages. With aid of the pairing trick one then can determine for each vehicle how much its meter reading has been increased (or decreased) between the begin and the end of the checking-trajectory. Assuming that one externally (i.e., in the outside world) ascertains or has ascertained how much the (incremental or decremental) meter to be verified should change, one can compare the correct, required change with the change between the two meter readings that have been made available from (within) the vehicle.

For example, if the semi-identification numbers exist of the last 4 digits of odometers with one decimal, i.e., odometers indicating hectometers, then only these semi-identification numbers have to be transmitted and then the precision of the odometers can be verified by receiving the semi-identification numbers in question on two points along the road with a known distance between them.

In short, for the verification of the precision of odometers and other meters real (i.e., unique) identifications are not necessary and semi-identification(number)s can be used to ease the protection of privacy. However, note that with the approach described until now (with remote verifications only) real identifications still have to be used as well, because they are required for the verifications on the monotony of meters.

15.6 Fully Automatic Ascertainment of Traffic Delays

The pairing trick whereby part of a sufficiently predictable meter (reading) is used for semi-identification, can also be used for other purposes. Based on the above it will be clear that for vehicles that pass both receivers, the time they required for the trajectory between the two receivers generally can be ascertained precisely by means of semi-identification.

If on the basis of a sufficient number of such vehicles one computes the average of the traveling times realized on the trajectory (and thereby possibly leaves out of consideration all too far deviating values), one can subtract from this actual average traveling time the average time usually required for this trajectory if there are no traffic jams, and thus ascertain the actual traffic delay precise to the minute. In short, the transmitted semi-identification numbers can be used for continually and fully automatically measuring the traffic delays in a privacy friendly manner.

For the rest we supplementarily remark that traffic delays expressed in time (say, minutes) often offer much better information than the length of traffic queues expressed in distance (say, kilometers). For, a traffic queue of 1 kilometer with an average driving speed of 5 km/h results into more delay than a queue of 5 kilometer with an average speed of 30 km/h.

15.7 Trajectory Speed Traps

Of course can the pairing trick be used for still more applications, like for example for performing trajectory speed verifications in a very easy and privacy friendly way. In case of a trajectory speed trap (trajectory speed check/verification) one ascertains for each vehicle that travels a certain trajectory with known length (or for each person in that vehicle), how much time elapses between the passing of the begin and of the end of the trajectory. In this way one can determine for each individual vehicle the average speed by which that individual vehicle has traveled that trajectory.

15.8 Possibly Integrated Traffic Fines

Now we are discussing speed traps (speed verifications) anyhow, we here take the opportunity to just glance at the possibility to perhaps integrate the ‘price’ of speeding in the tariff function used for traffic pricing instead of imposing separate fines. If so, then automatically an extra high price will be charged for each distance unit that has been traveled with a speed higher than the locally valid speed limit. Of course, such in the (traffic fee) tariff integrated traffic fines cannot only be applied for speeding, but also for other violations, like for example producing too much noise.

In case of this last example, think particularly also of application in the context of air traffic. One might use (whether or not integrated) fines to limit the noise nuisance by aircraft. One plausible approach is to take the nuisance observed on the ground as starting point and thus to allow an airplane to produce more noise at higher than at lower height. Undoubtedly, the function for determining the allowed noise production then will not only be made dependent of the height, but for example also of the distance to and preferably even of the position relative to the airport⁴⁸, so that take-offs, landings and prescribed approach and fly out routes can be taken into account. ⁴⁸ Note that the geographical position of a commercial aircraft usually is not considered to be privacy sensitive.

For the sake of clarity, we emphasize that the imposition of (whether or not integrated⁴⁹) traffic fines is a possible TIP-system application being separate (independent) from using semi-identifications or not. So, the reader should not be misled by the fact that we have raised the matter of integrated fines in this chapter incidentally and just for a moment. (By the way, we do make such side-leaps, i.e., jumps aside, more often in this text. Usually even without mentioning explicitly that we jump aside.) ⁴⁹ Probably it is usually wiser not to integrate fines into the tariff, but to keep them separately.

15.9 The Benefit of Semi-identification

We have shown already in chapter 13 that privacy can be protected with some effort (viz., by using hunters and/or intermediaries), even if real identifications are used. However, it is simpler, and thus also less expensive, to apply semi-identification(s) where possible. The privacy then is sufficiently warranted, while the manager of the infrastructure (say, government) then still can get direct access to certain required or desired information. For example, all applications mentioned in section 1.3 as examples of traffic management and control can be implemented privacy friendly by means of semi-identifications.

We take as example an integrated traffic information system for traffic pricing and traffic control, whereby the vehicles receive messages (about speed limits, traffic jams, traffic delays, and the like) and transmit messages themselves. Say, transmit themselves messages with semi-identifications in it for the benefit of speed traps and traffic control, and messages containing identifications for the benefit of traffic pricing. In this example the traffic manager (say, the government) then can derive the necessary information from the directly accessible semi-identifications, while only the messages containing identifications require a roundabout route (at least in case of the up to now described approach using hunters and/or intermediaries) on their way to the intended receiver (i.e., the government).

We will show in the next chapter that the privacy threats due to the use of identifications can be reduced further by means of agents, and indeed so much that the use of hunters and/or intermediaries is not or hardly necessary anymore. It will appear to be a very attractive option to use both agents and semi-identifications.

16 An Approach Using Agents

It is unfeasible to explicitly describe all possible variations of the TIP-system. Yet, to make clear which possibilities exist for the implementation of the TIP-system, in this chapter an example is given in which two earlier mentioned, but not in detail explained aspects play a role. These two aspects concern the transmittal on demand only and the use of a fraud-resistant component. On the basis of this example these two aspects should become clearer.

16.1 Only Transmitting on Demand

If messages with the required data are not transmitted continuously, it becomes substantially more difficult to perform (effective) verifications. For, knowledge of the moments when data has to be provided to the inspector creates a broader opportunity for fraud. It is best to illustrate this by means of an example.

Suppose that at a certain moment at location X the odometer reading of a particular vehicle has been given. If the next request (or, better stated, the next order) for that vehicle is sent at location Y, then the odometer reading should have been increased with at least the length of the shortest possible route from X to Y. As long as this principle is not violated, the inspector cannot find anything objectionable. This means that if a larger distance has been covered, e.g. because in the time between these two checks also location Z far from the route between X and Y has been visited, the extra covered distance (or a part of it) can be concealed.

One possibility to counter this is to increase the density of the network of checkpoints, and thus the frequency of issuing orders to transmit data, enough to make that this form of fraud will not be worthwhile. This option seems not very attractive because of the associated costs.

16.2 Use of Agents

Another, much more attractive possibility is to have (part of) the check be performed in the vehicle by, what we have called, an agent. On the one hand, an agent has to offer specific certainties to the data collecting and/or verifying authority, and on the other hand the agent should not be able to breach the desired privacy. As stated earlier, an agent exists of software and/or hardware that is/are trusted by (at least) the authority.

In the following we will leave open whether an agent is implemented as fixed (permanent) or as loose (removable) vehicle equipment, but both is possible, even at the same time! (At the end of this chapter we will say more about this.) Also we will dwell as few as possible on details of all kinds of other variations, e.g. those that are a consequence of each agent being uniquely identifiable or not, or of possibly distributing identifiable agents in a (semi-)anonymous way. Nevertheless it will become clear to a reader skilled in the art that, if the agent consists of a chipcard, our example can also be seen as a further illustration of the possible use of, whether or not, anonymous and/or (semi-)anonymously delivered chipcards, as has been suggested earlier in this text. (See chapter 13.)

In general, an agent keeps in a vehicle participating in traffic supervision on certain matters. On authorized request (and/or now and then by his own initiative) the agent provides for a personally signed report on his findings. Such a report can then be transmitted via a transmitter to the authority (e.g., the authority managing the traffic information system or a separate authority supervising the agents).

The transmitter and/or receiver do not have to be trusted by the agent and/or the concerning authority. To simplify our explanation we assume the transmitter and the receiver not to be part of the agent. Of course it will be made impossible to commit fraud unnoticed by obstructing the communication. This can be prevented by the use of explicit or implicit acknowledgements, i.e. of confirmations of receipt. If, for example, a request for a report by the agent is made, it is the task of the other vehicle equipment to provide for an adequate response. Because the aforementioned report is necessary for an adequate response, the agent needs to be involved and the transmission of the report cannot be prevented unnoticed. In this example explicit acknowledgements thus are not necessary.

The report, made and signed by the agent, is (preferably) always first handed over to the other vehicle equipment. For, the owner and/or user of the vehicle does/do not have to trust the correctness and integrity of the agent. Before transmitting the report of the agent, the vehicle equipment can (might), among other things, verify whether the agent has indeed adhered to the precisely prescribed data and formatting of the report. So, one can avoid that the agent surreptitiously includes illicit, privacy sensitive information in his report or that the agent abuses the transmitter for sending messages to the authority illicitly often, which can endanger privacy. Also the correctness of the agent can be doubted. If that is the case, then besides the report also an annotation needs to be included in the response.

When all checks have been made and the response to be issued (consisting of the report of the agent and possible annotations) has been composed and signed, the signed response has to be handed to the verifying authority via the transmitter. It can be agreed upon that the verifying authority upon receipt of an adequate response has to return a receipt. If the response included an annotation of disagreement or of doubt on the correctness of the report by the agent, then within a certain period an agreed procedure will be followed, such as offering the vehicle together with the agent for further inspection and verification.

16.3 Supervision by the Agent on Meter Monotony

As sketched before the agent has in any case the task to provide, if required, a signed report on his findings during supervision. Among other things, an agent can supervise that he is continuously informed (at least during driving) about readings of meter(s) or about the increase(s) thereof. Thus, the agent can verify on the spot the monotony of the meter(s) or use the given data to keep himself record of monotonously increasing meter(s). Both these cases amount to the same thing, but for convenience we will assume that only (pulses or other) increases are provided and that the agent keeps up-to-date meter readings himself. Please note that when using an agent no identification of the vehicle is required for the verification of the monotony of meter readings; identifications are necessary when using remote verification (only).

16.4 A Contribution by the Agent to the Verification of Meter Precision

The agent can, and in general should, also supervise that the meter (reading) is not increased too quickly. So, a sudden increase with a too large distance is not allowed. Stated differently, an increase that corresponds to a too high speed⁵⁰, does not have to be believed and possibly neither will an all too sudden increase in speed, i.e., an impossibly high acceleration. In this way the form of fraud sketched in section 16.1 can be combated. This will be explained now. ⁵⁰ For example, higher than the maximum speed attainable with that vehicle, taking into account a certain margin in view of special circumstances.

Suppose the agent reported at location X a certain meter reading. Then the agent can be misled by not passing meter increases during driving and thus one can pretend towards the agent that one is not driving. Or one can pass too low or too few increases. But, such a deceit will be revealed as soon as a request for a response comes in, say, when passing by location Y. For, one then cannot succeed anymore in making the agent as yet sufficiently increase his meter (reading) in short time, in order that at least the shortest distance between X and Y is included in his meter reading. Therefore, the meter reading of the agent then possibly will be too low and the fraud will be revealed on (after) transmission of his report. The only alternative is to not give an adequate response, but that means that still will be detected that something is going on and that action can be taken. In short, because every agent maintains the meter (reading) himself and because he only does so on the basis of limited increases, such fraud with meter readings will not be possible or not pay anymore.

We now have discussed how an agent can guarantee monotony and that an agent can and may have to detect implausible (unbelievable) increases of the meter reading. If something seems to proceed incorrectly, the agent has to report on that at some point in time, for example as soon as he gets an opportunity to do so. Not accepting too implausible increases is necessary as a contribution to the verification of precision.

If the agent does not do more than described so far, the remainder of the verification of the precision of the meter has to be performed by the (rest of the) verifying authority. However, an agent may perform even more verifications. In the following we will show that an agent can also perform the remaining verifications of precision himself.

16.5 Verification of Meter Precision Completely by the Agent

For an agent to be able to verify the precision on his own, i.e. to be able to verify whether the other vehicle equipment keeps him all the time correctly informed about the correct increases of the meter reading, he does need to have reliable information available now and then.

We now will illustrate one thing and another for the case of odometers. In this case the agent has to get now and then reliable information about the correct speed or about the correct length of a specific traveled trajectory. This might be achieved, for example, by the agent himself being able to determine his geographic position or by the agent getting now and then sent to him information about his position, respectively the position of the vehicle he resides in. As we now will show first, the latter might also be realized in such a manner that the agent does not even get to know where he is.

16.6 Odometer Verification Based on Whether or Not (Semi-)Anonymous Positions

The verification of the precision of odometers can, for example, be realized as follows. At certain locations imaginary measurement lines are drawn across the road. In the simplest case it concerns (is a matter of) pairs of measurement lines, whereby the first measurement line marks the start of a verification and the second one marks the end.

When an agent passes the first measurement line a secret and signed message is sent to him with as contents a timestamp and the message that an odometer verification is started here. When passing the second measurement line the agent again receives a secret and signed message, but now it contains a timestamp and the distance to the first measurement line. On the basis of this information supplied to him (from outside) the agent can determine whether the information about the odometer readings supplied to him on this measurement trajectory from within the vehicle has been correct.

The messages to the agent must be secret, because in case of this approach it is for fraud-resistance of importance that only the agent is allowed to know where verifications begin and end. Therefore, in this case it will be also wise to use not only pairs of measurement lines, but possibly also verification trajectories with three or more measurement lines. The latter makes, for example, that the risk of being caught for (an attempt to) fraud by means of ‘smart gambling’ on correctly guessed begin and end points of verification trajectories, increases considerably.

The signing of a message is necessary to prevent tampering (e.g. via manipulation with the rest of the vehicle equipment) with these messages, i.e., to prevent that messages can be forged or modified unnoticed.

To prevent messages from being delayed or possibly even not being passed on to the agent at all, one can (might) require that a by the agent signed confirmation of receipt must be returned as response. The timestamps help to prevent fraud by means of copied messages. Note that in this case there is in a certain sense (still) question of ‘orders/requests’ with corresponding responses.

In case of the above-mentioned verifications one can make profitable use of semi-identifications. When passing each measurement line an agent then gets a ‘position message’ sent to him containing some semi-identification of this measurement line (e.g., in the form of a number consisting of two digits) and also the semi-identification(s) of one or more measurement lines that possibly have been passed by him earlier, together with their shortest distance to this measurement line.

One advantage of this alternative approach is that there is no distinction anymore between begin and end points of verifications and that the messages to the agents thus do not have to be kept secret anymore. Another, closely allied advantage is that the same messages now might be used in the vehicle for further determining the geographical position, for example in support of whether or not automated navigation.

Now observe that, if at each measurement line the broadcasted ‘position message’ only contains a semi-identification of the location, the agent does not get to know where he is and thus cannot give information to the rest of the supervising authority (or others) about his geographic position, not even via some covert channel⁵¹. But, for example, the driver of the vehicle may really know already his approximate position and, if so, may use ⁵¹ If one does not want to protect oneself against this possibility (of covert channels), then the positions of the measurement lines may also be denoted by unique identifications. The agent then does come to know his position (implicitly), but cannot just transmit this knowledge via the transmitter in the vehicle without a reasonable chance of being detected. the semi-identification of the measurement line to determine now his precise geographic position, at least if this measurement line in question is at a known and fixed location.

For good inspection (verification) it is of course necessary that not all the positions of all measurement lines are known. For the required ‘verifications by surprise’ one may, among other things, use mobile measurement lines, i.e. mobile equipment for ‘drawing’ a measurement line and for transmitting the ‘position messages’ in relation to this measurement line. To be quite on the safe side, we finally yet remark that it is self-evidently also possible to give in the mentioned (position) messages the distance to the measurement line in question instead of only the exact crossing of that measurement line.

16.7 Odometer Verification by Means of Reliable Information About Speed

Covered distance and speed are related to each other. If one is informed about the increase(s) of the odometer reading and one has the disposal of sufficiently precise time measurement, then one can determine the corresponding speed. But ‘the inverse’ is true as well, that is, on the basis of reliable speed data and precise time measurement one can verify the correctness of reported meter reading increases. In short, an alternative approach for verification makes use of speed data.

For example, one may ascertain the speed of passing vehicles independently by means of radar. The verification now can proceed in two ways. Either the externally determined speed is revealed to the agent and the agent verifies whether the speed based on the information supplied from (within) the vehicle is correct indeed, or the agent transmits the internally determined speed and the verification takes place outside the vehicle.

Self-evidently the two compared speeds should concern the same point in time. To be quite on the safe side, we here also draw attention to a fairly subtle point, namely that this should be a point in time before the moment at which someone in the vehicle can begin to have any reasonable ground to suspect that there is an increased chance of soon encountering a check (verification). So, a point in time before the start of any communication whatsoever with respect to this verification between the vehicle and the infrastructure. After all, to hinder fraud no information at all should be revealed on the basis whereof one might get any further suspicion of this point in time. In case of this approach to verifications the agent thus always should keep for a short while recent information about speed.

Of course the compared speeds should also concern the same vehicle. For more information about this we refer to section 11.4.

If the equipment needed for independent speed measurement is more expensive than an additional transmitter, then the approach of verifications by means of speed data may, in general, be less attractive than the one using position data. But even if so, then yet the approach based on speed measurements may be more advantageous for mobile checkpoints (checking stations) for the sake of verifications by surprise. Furthermore, this approach offers the possibility of verifications from moving patrol cars. In short, this approach is certainly interesting for mobile verifications in both meanings, i.e. movable and moving.

The example given in this section can be considered as a specific illustration of the earlier mentioned, more general possibility to perform verifications using difference quotients or differential quotients. (See also chapter 11. We use the somewhat cautious formulation ‘can be considered as’, because in case of external speed measurement the speed usually is determined ‘directly’ by using radar waves and the Doppler effect and thus is not explicitly determined as a derived quantity of covered distance, i.e., is not measured explicitly as an in a very short time traveled difference in distance.)

16.8 Also Other Verifications by Agents

We just have described that keeping the odometer (reading) and verifying its correctness can be done entirely by the agent if sufficient appropriate and reliable information is sent to him. As has been suggested before and should be clear by now, an agent can also verify (monitor, audit, supervise, control, etc.) all kinds of other meters (meter readings) and data, like for example the number of revolutions per minute, fuel consumption, and/or noise produced in the engine compartment of the vehicle.

In the preceding section we have already described (albeit implicitly) that an agent can verify the precision of the speedometer. However, because the agent is in the vehicle and therefore can almost continuously exercise close supervision, he can also establish whether the locally valid speed limit is exceeded, at least if reliable information concerning the correct speed limit is sent to him from the outside world⁵². ⁵² In general, people will not appreciate continuous surveillance of their behavior in traffic (Big Brother). But, such comprehensive monitoring by an agent in the vehicle may possibly be really acceptable on the contrary, if it restricts itself to a judgement of the (average) quality of the total behavior in traffic; in other words, if occasional violations are allowed to a sufficient extent. (Slight sloppinesses, oversights and even some deliberate, deemed necessary violations then do not have to be fatal immediately.) Compare this, for example, to the better acceptance by traffic participants of sanctions for speeding if that offence has been detected by a trajectory speed trap than if it has been detected by the more usual speed trap, whereby speed is measured only at one specific spot.

The agent may play a role also in case of other traffic violations, like for example driving through a red traffic light. For example, by revealing on authorized request the identity of the vehicle or of the payer, at least if he has the disposal of this information. Or by establishing the violation in cooperation with the traffic light installation and recording this ascertainment.

When establishing a traffic violation an agent has a number of possibilities. He can pass on the offence in due time to the rest of the traffic information system for further settlement, or he can determine the indebted fine himself and possibly add it to the already indebted amount of traffic fees. If the fine in question has been integrated, i.e., has been included in the tariff structure of the traffic fee, then he even does not have to do anything special. This possibility exists, for example, for speed offences. The fine then may be included in the tariff structure in such a way that the actually extra charged fine depends on the extent to which the speed limit has been exceeded and on the number of distance units in which that has happened. Of course, this dependency can also be arranged without integrating fines in the tariffs.

Anyway, fully automatic and efficient settlement of traffic offences and fines becomes possible in many cases. If the agent takes care of making a fraud-resistant identification available, then traffic violations can be settled much more efficiently, because reading license numbers from e.g. photographs then is no longer necessary. In certain cases such images can even be completely omitted, which yields considerable savings as well.

Finally we remark yet that the settlement of fines is fairly well comparable to imposing and collecting discrete traffic fees, like for example open tolling at bridges or tunnels. Until now we have hardly paid any attention to the latter, among other things because discrete tolling (particularly, open tolling) is much more common than continuous tolling. Although the use of a TIP-system solely for discrete tolling perhaps is somewhat less remarkable, it may be clear that our approach offers certain advantages also when used for discrete pricing.

16.9 Privacy Protection by Reducing the Transmission of Identifications

If the agent takes for all verifications as much responsibility as possible upon himself, then hardly any other messages need to be transmitted by him than the messages for acknowledging the receipt of reliable information transmitted to him, like for example position data, externally measured speed, noise, and so on. The only things that need to be transmitted additionally, are reports by the agent on a whether or not right course of things and in case of traffic pricing now and then, say once per month, a report containing the relevant meter reading and an identification number by which a responsible payer can be identified indirectly. The latter is needed for the automatic collection of traffic fees. Perhaps very occasionally also a small number of messages will be exchanged extra, for example, because it is deemed to be needful to now and then (extra) verify the correct functioning of the agent from a distance.

Strictly speaking an agent does, of course, not have to supply the reports on meter readings and (in)correct functioning necessarily: 1) automatically, 2) as soon as possible, and/or 3) while being in motion (being driven). In principle it is also possible, for example, to have the agent periodically be ‘read out’ by or on behalf of the authority. This reading out, i.e. this requesting for and obtaining of a report, does not have to happen via the transmitter (in the more usual sense) of the vehicle, but might also happen via physical (e.g., electrical) contact (which is included in our wide sense of transmitter). The reading out might, for example, be combined with (possibly other) periodical tests and inspections. Even if reading out would occur only once a year, the payment may of course be spread as well (and equally well), just as currently is usual in The Netherlands for payment of, e.g., natural gas and electricity.

Nevertheless we expect that one mostly will choose for reading out via the transmitter of the vehicle during normal use because of the advantages offered. After all, it does not cost the customer any time and one can (may) therefore without too many objections also read out the agent more often. Moreover, (attempts to commit) fraud (and incorrect functioning more in general) then are revealed earlier, so that action can be taken sooner.

If the agents are not uniquely identifiable, i.e., if they do not each have their own signature, or if the agents really are uniquely identifiable, but it is not known by which person or in which vehicle an agent is used, i.e., if agents are delivered anonymously, then the confirmation of receipts signed by the agents do not reveal any privacy sensitive information. Thus, the only messages that still might threaten the privacy, then are the reports on the meter readings with the accompanying identifications for the benefit of the payment process. If these latter messages are transmitted only occasionally, for example once per month, there is hardly any threat to the privacy, not even if one could precisely ascertain for each such a meter reading report from where that message has been transmitted. (For such messages one could possibly use a communication channel whereby localization of the sender is not so easy.)

Something similar to what has been described above holds when the agents are identifiable, but are delivered semi-anonymously. In short, the privacy protection by means of hunters and/or intermediaries can in the mentioned cases be omitted partly or possibly even completely! Possibly one could also have the payment take place within the vehicle. About this somewhat more will be said in the next section.

16.10 Differences with the Earlier Discussed Approach

The approach using agents does not differ really much from the earlier discussed approach with remote verifications only. A difference is that the verifying authority via advanced posts, namely agents, is closer to the objects to be monitored and that verifications (all verifications or possibly only a part thereof) occur in the vehicle. The communication between the (usually not against fraud protected) objects (think particularly of sensors and/or measuring instruments) in the vehicle and the information gathering and/or verifying authority now occurs mainly or completely within the vehicle (namely, between the objects and the agent), so that for this communication it is not necessary anymore to bridge all the time the somewhat larger distances between the transmitter (respectively, receiver) of the vehicle and the receivers (respectively, transmitters) in the outside world. Thus, the communication channel between vehicle and outside world is no longer (directly) used for the communication between the monitored objects (say, measuring instruments) in the vehicle and the inspector in the outside world, but instead is used now for the communication between the agent (as advanced post and possibly as full-fledged inspector) and the rest of the information gathering and/or verifying authority.

One thing and another is illustrated in the FIGS. 3 and 4. In both these figures the transceiver rendered on the right side belongs to the hunter (represented by box 8) and there is in both cases one intermediary (box 9), although he is probably not, or hardly, necessary anymore in the situation depicted in FIG. 4. In FIG. 3 the authority, i.e. the final receiver (boxes 10 and 11), takes care of both the verifications (box 10) and the remainder of his tasks (box 11), like for example collecting the indebted fees. In FIG. 4 the verification tasks are performed on behalf of the authority by the agent in the vehicle.

One difference is thus that (at least part of) the verification/monitoring has been ‘pushed forward’, i.e., occurs at a different position in the total chain of activities and/or participants. This in abstraction not so large difference does really have essential consequences. After all, because the actual inspector is now within the vehicle himself, there is no identification needed anymore to be able to determine whether different messages to the inspector (containing, e.g., increases of meter readings or other measurements) are originating from the same vehicle or not. Indeed, hardly any messages about monitored objects (measuring instruments) containing identifications of those objects still have to be exchanged with the outside world. As has been stated before, there still is only the need to send now and then to the authority in the outside world a (possibly indirect) identification in a message with the resulting bill. And even this latter is not strictly necessary, because the agent can also be ‘read out’ during periodical inspections (e.g., via a physical contact).

Also in case the payment occurs inside the vehicle, the communication with the outside world does not necessarily have to encompass messages to the authority concerning the payments. But that communication then will in general (instead) be extended with an exchange of messages for the sake of the payment process. This last mentioned exchange of messages concerns the communication between a bank agent, i.e. software and hardware of or on behalf of the bank, in the vehicle and (the rest of) the bank organization in the outside world. Do note that in the extreme case that agents only send messages to the outside world, i.e. to the authority, in the style of ‘everything is going well, also the payment’, the authority (say, the fee collector) has no, or a less good, overview. This latter aspect may not be appreciated.

Another difference is that the required protection of the agent against fraud introduces a physical aspect. If the agent, for example, is implemented (realized) with (the aid of) a chip or chipcard, the total security (protection) depends on the physical protection of (the storage of) the software and the key(s) of the agent in the chip. As it appears in practice that chipcards can be sufficiently protected and because no further physical protection is required (in the vehicles), this (need for physical protection) does not seem to be an insurmountable drawback.

16.11 ‘Fixed’ or ‘Loose’ Agents

The use of agents seems an attractive possibility for carrying out tasks, such as in particular the charging of all kinds of traffic fees, and for performing the thereto-required verifications. The agents in question can, for example, be installed in each vehicle as fixed vehicle equipment (FVE); say, in the form of a chip with software in some encasement. But an agent can (as has been suggested already more often) also be realized (if desired) as loose vehicle equipment (LVE); for example, in the form of a chipcard that, at least during use, will be connected with the other vehicle equipment of the concerning vehicle (like for example the transmitter, the receiver, the battery and a number of sensors and/or measuring instruments) via a connection point (e.g., a plug or a card reader).

If every user has its own ‘loose’ agent, e.g. on a chipcard (which possibly also acts as identification device and/or consumption pass), and should connect his card via a card reader in the concerning vehicle with the other vehicle equipment in that vehicle before (and during) each drive, then such an agent is of course not very suitable for the task of vehicle identification. In such a case a second, fixed agent can, if desired, take care of the fraud-resistant identification and/or classification of the vehicle. (See also section 16.4.)

16.12 General and Specialized Agents

Sometimes we make for our convenience a distinction between general and specialized agents. With the term specialized agent we then allude to an agent with a specific function that is limited to only a small part of all agent tasks belonging to the traffic information system in question. Think e.g. of a fraud-resistant consumption pass that keeps a for the traffic information system essential meter and further performs no other agent tasks belonging to the traffic information system in question. (We call a meter only informative if it is only used for the satisfaction of the user and is not of decisive importance for the keeping of the correct meter readings by the traffic information system.) Another example is an agent that exclusively serves for the fraud-resistant identification and/or classification of a vehicle. On the other hand, a general agent performs (almost) all agent tasks that belong to the traffic information system in question.

Up to now the term agent was mainly used in the text for general agents and when reading the term agent one had to (respectively, was allowed to) primarily think of the pivot in the vehicle on which everything in relation to verifications in the vehicle hinges. Stated differently, the emphasis has always been on particularly the verification task of the agent, i.e. on his task as representative of the authority in a vehicle who takes care of (a part of the) verifications on the reliability of the information supplied in the vehicle and via whom information is delivered to the rest of the traffic information system. Also in the rest of the text the word agent will primarily denote a general agent. Only occasionally we will additionally use for our convenience the term specialized agent. The difference between both terms thus plays hardly a role of significance. Rightly so, as the difference is yet somewhat vague.

16.13 Some More About Implementation Possibilities/Opportunities

Just as in case of the approach with exclusively remote verifications, there are numerous (often plausible) implementations and/or variations possible when using agents. Therefore, it is too much of a good thing to explicitly enumerate all possibilities. On the basis of the given description it is for a skilled person easy to make up all kinds of different variations and implementations. Here we just glance, in fact already unnecessarily (abundantly), at only a small number of possibilities.

One obvious and already much more often suggested possibility is to implement the agents (i.e., each agent) as a chip, possibly installed in a chipkey or on a chipcard. Certainly if, for example, chipcards or chipkeys are used, one can furnish the to be issued chips, if desired, also with a (say, decremental, i.e., descending) meter, whereby that consumption meter is maintained (kept) by the agent starting from a certain initial state. The agent then thus also takes care of the function of consumption pass, whereby the consumption of the credit-balance can occur distributed over any number of different vehicles. The advantage of such an agent with consumption pass function is, that tracing of identifiable users of such chipcards is impossible then, simply because then there are no identifications of users at all in play anymore. By restricting the sale of such chipcards, one can obtain, if desired, a system with tradable usage and/or pollution rights (per person per year).

We further mention the possibility to combine all mentioned functionality possibly on one chip with other applications, like for example electronic transfers of payment with the aid of a chipcard or electronic access control with the aid of a chipkey. Indeed it then may be desirable to build in good guarantees against unwanted information exchange between the various applications. We also point out yet the possibility to extend the functionality of an agent. For example, to that of a ‘reliable black box’, i.e., a black box that does not only register supplied data and retain these data during a certain time (as is usual), but in particular does also verify (a part of) the supplied data on reliability. Other examples are the possible use of an agent as a reliable (trustworthy) taximeter or tachograph.

16.14 One or Several Agents Per Vehicle

Up to now we have kept, for our convenience, the possibility of several agents per vehicle outside of the discussion as much as possible. This was, so far as we are concerned, right for a number of reasons. First of all it did help to prevent unnecessary complexity of the explanation. Moreover, we have explicitly mentioned already in chapter 5 that we wanted to abstract from the possibility to distribute processing over multiple processors, so that in fact we really do have covered this possibility. The only special case that now will be discussed is the possible distribution of the agent's work over a ‘fixed’ and a ‘loose’ processor, i.e., a fixed and a loose agent.

In case of a fixed agent, we often assume that he performs all desired tasks. The possible user cards then only serve to (be able to) identify an individual meter related to a particular card or person. The agent in the vehicle can keep the consumption corresponding to that meter and pass this information at appropriate moments to the rest of the traffic information system in the outside world. If one appreciates the possibility to make meter readings being recorded in user cards as well, for example because users then can read out the meter readings at any desired moment, then the agents in vehicles simply have to take care that a meter reading after modification will be written to the connected (i.e. present) user card as well.

Manipulation with the meter reading on a user card does not make sense if that meter reading is only used informatively (i.e., only for the satisfaction of the user) and is not of decisive importance for the correct keeping of the correct meter reading by the traffic information system. If the meter readings on the user cards really are essential for the traffic information system, then they have to be secured. This can be achieved, for example, with the help of cryptographic techniques and additional measures, but instead possibly also by relying (also) on the fraud-resistance of the user card, which in this latter case probably will be a chipcard (and not a magnetic card). Only in this last-mentioned case of (from the point of view of the authority) fraud-resistant chipcards with essential meter readings there is, during the use of the vehicle, besides the fixed agent also a second, loose agent in the vehicle.

But if the user card does include an agent anyhow, then it is natural to have this agent at the same time (just as easily) also take all agent tasks on himself, so that the fixed agent in the vehicle then can be omitted. Now observe that this latter is not always possible. Only if the fixed agent had been fraud-resistantly attached to the vehicle in order to be able to also perform the vehicle identification and/or vehicle classification task in a very fraud-resistant manner, these two last-mentioned tasks cannot be taken over by the loose agent.

In short, we have demonstrated that usually one agent per vehicle can suffice. There exist, as sketched above, also real situations whereby several agents are used per vehicle. Suppose one is inclined to use separate agents 1) for the vehicle identification and/or vehicle classification tasks, 2) for the function of consumption pass with meter, and 3) for the function of identification aid (device), whereby the remaining agent tasks then are relegated, for example, to one of the used agents, which thus becomes the ‘general agent’ then. So, then actually three agents would be necessary, one general agent and two specialized agents. But for the function of identification device (aid) an agent is not always really needed, as has been suggested already in chapter 4. (For example, identification does not necessarily require the use of an agent if identification occurs by having a digital signature being put.) Moreover, one can (and generally also, one will) combine the functions of identification aid and of consumption pass in one user card. In short, in the sketched situation two agents can, in general, easily suffice.

Note that for the vehicle identification and/or vehicle classification task an agent is necessary only if the fraud-resistant identification or classification of a vehicle is of importance for the correct functioning of the traffic information system. This is, for example, the case when the classification of a vehicle plays a role in the height of the tariff in case of traffic pricing. Finally, we point out once more that the use of a loose agent is an attractive option from the point of view of privacy protection (see also refer the previous section).

In summary, our argument boils down to the following. One agent can suffice. Anyhow, one fixed agent. But also one loose agent if very fraud-resistant vehicle identification or classification is not required for the correct functioning of the traffic information system. When using a loose agent, two agents are needed (in total) if also very fraud-resistant vehicle identification and/or classification is/are required.

Although there really can be a question of several agents (for example, because the tasks to be performed yet are distributed over a fixed and a loose agent/processor), we generally assumed and will assume, in simplification of the text, that this is not the case. Thus, we assume in this text (i.e., this elucidation of our invention) without loss of generality (i.e., solely for convenience) usually that at most one agent is involved (and sometimes that at most two agents are involved) per vehicle and that the supervision and verification are performed by this one agent (respectively, these two agents). Although that is not necessary at all, we assume, in case that (still) several agents are used, that there is a question of one general agent and a number of specialized (relief) agents.

16.15 The Use of Agents as an Attractive Option

As has been remarked already several times, the use of agents seems an attractive option for performing verifications and charging all kinds of traffic fees. It seems attractive to use an agent not only for keeping record of the due traffic fees and/or the consumed rights per person and/or per vehicle, but also for other tasks, like for example the on request (or possibly almost continuous) transmission of semi-identifications. The use of semi-identifications offers the advantage that the manager of the infrastructure can collect in a direct, but still privacy friendly way all sorts of useful traffic information, like for example information about traffic flows, traffic delays, utilization degree (occupancy) of roads, etc. In chapter 18 we will come back to a number of tasks that an agent can perform.

17 Preparation for ‘Growth’ of the System

By always appending to each message a protocol number (and possibly included in this number or separately a payment method number) and/or a message type number, one can within one and the same system allow different (sub-)systems (like for example versions) at the same time and thus also support several levy (fee) structures and/or payment methods at the same time. In this way one can commence with a simple version of the system and then apply step by step extensions and refinements.

For example, one can choose to support in the beginning only one fairly simple protocol with a certain protocol number (e.g., number 1). Suppose that one does one thing and another as follows. Every vehicle is furnished with: 1) a transmitter and a receiver, 2) a fraud-resistant component that can act as agent, 3) a vehicle-related processor, i.e. a component for, among other things, checking messages from the agent and/or encrypting those message for the sake of privacy protection, and 4) a central connector to connect the just mentioned and possible future components to each other. One chooses one permanent hunter that also acts as the only intermediary. Each vehicle-related processor transmits, in case of this protocol, all messages from the agent destined for the final receivers, though after having them packed in a secret message to the hunter/intermediary, so that final receivers can only read the messages from the agent with the aid of that one hunter/intermediary.

With this first protocol the only task that the agent in each vehicle performs, is reacting on requests for identification. On each authorized request the agent identifies himself (and thus to a certain extent the vehicle) by signing such a request after addition of the time and an identification number, say his own identification number (or possibly the license number of the vehicle for which he has been issued). This thus signed request is handed to the vehicle-related processor, which then enciphers it to a secret message for the hunter and which sends this secret message to the hunter via the transmitter of the vehicle. We assume that in first instance only open tolling is introduced. At all tolling points in question the authorized hunter will ask every passing vehicle, i.e. every passing agent, for identification. The hunter will strip every received response of its for secrecy added packing and then send the stripped message on to the fee collector, who charges the toll to the holder of the agent (respectively, of the license number).

Note that we did not require in our example that the agent must be attached to the vehicle in a fraud-resistant manner. Even without fraud-resistant attachment, one thing and another may really be sufficiently fraud-resistant. For, interchange of authentic agents does not seem attractive. As long as passing of a tolling point leads for each vehicle to the same amount of toll, interchange with agreement of the registered holders of the agents (respectively, of the corresponding vehicles) does not seem to make sense. Exchange with a stolen specimen perhaps seems attractive at first sight, because the bill then will be addressed to someone else, namely the robbed person. However, tracking a stolen agent down is sufficiently easy (at least, if that agent is actually used to have someone else pay for the toll) to minimize the appeal of such attempts to fraud. Of course, fraud-resistantly attaching agents to vehicles from the beginning is, at least if one has the disposal of a sufficiently cheap technique for that, also an attractive option, because then one is also prepared for applications whereby fraud-resistant association of agents with vehicles is really desired or required.

From a certain moment one may require that new vehicles must be prepared (ready) for being able to continuously deliver to the agent data concerning the odometer reading. They have to deliver the required information to the agent in the form of, for example, odometer readings (in, for example, two decimals), meter increases or pulses from a sensor on the driving shaft. At some moment one then can change for new vehicles to the use of a second protocol (say, with procotol number 2), whereby also continuous pricing based on all traveled kilometers can be used for the traffic pricing. Existing vehicles can also join after assembly of a sensor on the driving shaft. The connection of the sensor to the rest of the system is easy to realize, because we have arranged from the beginning, by the installation of a suitable connection point, that the system is ready for connecting other vehicle equipment. Although the software in the agent may be prepared already from the beginning for this extension/adaptation, probably one thing and another will have to be changed yet. For example, when pulses from a sensor on the driving shaft are used, the software possibly must get information yet about which distance covered by this vehicle corresponds to one pulse. (One might arrange that this information is also present already from the beginning.) Of course, the earlier (in chapter 16) described verifications on the correctness of the odometer readings kept by the agent are now introduced as well.

The agent can use the kept odometer reading, only at a later time or immediately in this second phase, also for creating and transmitting semi-identifications based on the odometer, for example for the benefit of gathering information about delays caused by traffic congestion. (With the first protocol the agent could also transmit already from the beginning a fixed semi-identification, but not yet one of the kind in which the semi-identification is based on the odometer and thus changes continually.) Immediately or at a later time again, one can also arrange, without any further change of the by now in vehicles present hardware, that the processor starts using software that makes the tariff of each kilometer dependent on the speed whereby that kilometer has been covered. (As has already been remarked before, that software could possibly also be supplied via the transmitters of the infrastructure, say alongside or above the road, and possibly also be put into operation automatically.) Also, one can add at some moment in time the possibility to use loose vehicle equipment (LVE), so that then the payer may be someone else than the holder or owner of the vehicle, and one can, if desired, introduce a (quota) system with tradable pollution rights. Etcetera, etcetera.

In completion of the above we remark for the sake of clarity once again that, certainly as long as the tariffs of the traffic fee are the same for all kinds of participating vehicles (and the agent therefore does not have to supply reliable information about the vehicle classification), fraud-resistant attachment of the agent to the vehicle can be omitted without presenting all too many difficulties. Fraud-resistant connection (association), i.e. protection against exchanges of agents, is not necessary until a very high level of reliability of the classification and/or identification of vehicles by means of agents is required.

One can settle that for each combination of protocol and payment method a separate protocol number is used. One can also (instead of associating the payment method with a protocol number) introduce a separate payment method number. With this number it can be indicated in what manner one wishes to pay. For example, automatically via a bank account, per week or per month, with or without a credit facility, etc.

18 TIP-systems

In what precedes we have outlined various possibilities to obtain a traffic information system with specific properties. To be able to obtain a traffic information system with the properties considered by us to be desirable, we have introduced a number of techniques, like for example the creation of semi-identification numbers (whether or not on the basis of meter readings), the implementation of speed controls and the ascertainment of traffic delays (both) with the aid of such semi-identification numbers, the implementation of verifications from a distance and/or in the vehicle on, in particular, meter readings (e.g., odometer reading, revolutions per minute and fuel consumption), the fairly accurate computation of the caused environmental pollution, the use of hunters and/or intermediaries for the protection of privacy and the use of agents in vehicles for privacy protection and/or verifications.

In principle a TIP-system can use all the described techniques. But that is, as we have shown before, not necessary. For example, it is possible to realize a TIP-system without agents and without user cards, thus without any fraud-resistant component in each vehicle. Also one may use agents in such a way that hunters and/or intermediaries are superfluous. Or one may, for example, decide not to use semi-identifications. In short, in general a TIP-system will use only a part of the described (and whether or not characteristic) techniques. In general, one will speak of a TIP-system already if at least one of the by us newly introduced, i.e. TIP-systems characterizing, techniques is being used. In any case it is explicitly the intention that any use of one or several of the characteristic techniques de jure et de facto (i.e., by law and by facts) stands for an infringement on our invention.

18.1 A TIP-system with Agents

Just because there are so many mutually different possibilities to realize a TIP-system, it seems wise to lift out, by way of illustration, one attractive option and to describe it as a coherent whole. We do this for the case of road traffic and we choose thereby for an approach with agents in the vehicles, because such an approach has a number of important advantages and does not seem to have serious disadvantages.

A clear advantage is that with agents much more information can be collected and verified without the costs sky-rocketing. For, it is an easy job for an agent in the vehicle to continuously exercise close supervision, while the emphasis in case of the approach without agents yet is slightly more (or more clearly) on catching (receiving, intercepting) random samples of all (from vehicles) transmitted information for the benefit of verifications. In the approach without agents information can indeed, at least in principle, be collected and verified almost equally intensively as in the approach with agents, but then only if the traffic network is swamped with transmitters, receivers and computers to make it possible to be continuously in contact with all vehicles and to process the enormous flood of information transmitted by the vehicles. Think especially of the much greater need for computing power, which then is required for the manifold use of hunters and intermediaries for the benefit of the desired privacy protection. In short, when using agents intensive verification is possible with a much cheaper infrastructure, because then much less transmitters, receivers and especially also computers are needed than with the other approach.

From a slightly different point of view one comes to the hereto-allied advantage that less communication is needed between the vehicles and the outside world than with the approach with all verifications from a distance. There will thus be a much lower chance that the communication with many vehicles at the same time will lead to problems. It may be clear that the approach using agents indeed requires considerably less bandwidth for the communication between the vehicles and the outside world than the approach without agents. After all, each agent processes the data locally and may summarize the information and/or selectively transmit it, so that the communication with the outside world requires only a fraction of the bandwidth that would be required otherwise. (The bandwidth that otherwise would be required for the communication with the outside world, is equal to the bandwidth required for the communication between the agent and the other equipment in the vehicle, such as sensors and measuring instruments.)

The only disadvantage of the approach with agents compared to the approach with only remote verifications is, that a fraud-resistant component is required for each agent. This component will in general contain a chip with a processor and accompanying memory of which (a part of) the contents cannot be modified or even only read without authorization. However, this disadvantage does not carry much weight. Not only because such a component does not have to cost much, but also because it seems anyhow (almost) unavoidable that, due to the need for sufficiently fraud-resistant vehicle identification and/or vehicle classification, a fraud-resistant component with a chip must be attached to the vehicle.

Therefore it is fairly plausible to choose for an approach with agents and to use each agent possibly also for the fraud-resistant holding and supplying of reliable vehicle information. By vehicle information we understand: 1) vehicle (more or less) identifying information, such as chassis (frame) number, engine number, license (plate) number, etc., 2) vehicle classifying (characterizing, typing) information, like for example brand, model, year of manufacture, gearbox type and/or engine type, and 3) other information about the vehicle, like for example allowed kind(s) of fuel, weight, color and/or information about the legitimate holder or owner, like for example his or her social security number or his or her name and address.

When once the choice for an approach with agents has been made, it must then still be decided which tasks the agents will perform. An agent can, if desired, perform a multitude of tasks, of which we here will enumerate a number in the context of road traffic.

1. Gathering and/or keeping of all kinds of considered to be relevant information about the use of the vehicle on the basis of information supplied by equipment in the vehicle (particularly, sensors and/or measuring instruments).

Think e.g. of information such as speed, number of revolutions per minute, odometer reading, fuel consumption, fuel meter reading, temperature, and the like. Note that these data are generally fairly dynamic, i.e., now and then will be subject to fairly frequent changes.

2. Verifying (directly or indirectly) whether that supplied information is sufficiently reliable and/or correct.

For this purpose there is often made use of reliable information supplied from the outside world. Think e.g. of (direct) verification of the speedometer, odometer, and outside temperature meter, and e.g. of (indirect) verification of the revolution-counter and fuel consumption meter.

3. Reporting at appropriate moments to an (authorized) verifying authority in the outside world the findings of the verification/supervision activities.

Think e.g. of the reporting on possible irregularities or of (apparently) flawless working.

4. On the basis of available information computing and/or keeping of derived information.

Think for derived information e.g. of a fairly accurate computation of the fuel consumption and/or of the pollution caused at a certain moment, in both cases on the basis of other data, like for example brand, model, year of manufacture, gearbox type, engine type, speed, number of revolutions per minute, acceleration, fuel consumption⁵³, outside temperature, engine temperature, and the like. Think also of a fairly accurate computation of the noise production. For the computation of derived information from other data the agent of course needs to have the disposal of a method of computation, e.g. in the form of a formula or of one or more tables. The derived fuel consumption can particularly be used to (indirectly) verify the reliability of the fuel consumption as reported by (from) the vehicle. The derived pollution can be used for maintaining an (incremental) meter concerning the total environmental pollution caused. ⁵³ Of course, this item belongs only to this enumeration in case of the example of the computation of environmental pollution caused.

5. Now and then at appropriate moments stipplying specific (reliable) information about the use of the vehicle to a specific authorized authority in the outside world.

This supply may, for example, be performed for the sake of imposing and collecting traffic fees and/or traffic fines. Think e.g. of supplying specific meter readings together with identifying data of the corresponding vehicle (or its user, payer, holder or owner) for the benefit of imposing and collecting a continuous fee, and of supplying data concerning traffic violations possibly established by the agent. Certain fines may have been integrated already in the tariffs of a traffic fee.

6. Gathering and now and then supplying of specific information to a specific (authorized) authority in the outside world for the benefit of acquiring statistical data about practice.

Think e.g. of the (whether or not selective) supply of data about the by/from the vehicle reported fuel consumption in various circumstances (characterized by, for example, speed, acceleration, number of revolutions per minute, outside temperature, engine temperature, and the like) with accompanying mention of the vehicle type, so that the authority in question can get a good view (idea) of the fuel consumption of vehicles of that type (i.e., brand, model, year of manufacture, gearbox type, engine type, and the like) in practice.

Such (statistical) practical data may be used, for example, to find algorithms (computation methods) for the benefit of determining derived information.

7. The fraud-resistant storage of vehicle information and making this information available.

Of course, the making available of vehicle information should, certainly if this information concerns holder/owner or vehicle identifying information, only occur under specific, clearly described conditions and/or in specific, clearly described circumstances and even then preferably only to specific, deemed relevant authority(-ies) in the outside world. Note also that vehicle information is in general rather static, i.e. will not or rather infrequently be subject to changes.

8. The (construction and) forwarding of a semi-identification number on request of an authorized authority.

This number may be derived, for example, from the odometer reading and may be used by the authority in question for e.g. determining traffic delays resulting from traffic congestion, verifying whether the average speed on a specific route has been kept below the speed limit, monitoring/studying traffic flows, performing traffic census, etc.

9. Verifying the authenticity of received messages concerning the infrastructure and passing messages on to other equipment in the vehicle.

Thing e.g. of passing on of official messages about speed limits, traffic delays, the outside temperature, the position, the speed, and the like.

10. Only if a (user) card can or must be made use of during the use of the vehicle, taking care of the communication with the offered user card or, if the agent himself is on that card, performing himself (also) the function of user card (consumption pass inclusive).

The mentioned communication may relate to, among other things, the mutual verification on authenticity, the (in so far as applicable and desired) exchange of identifying data and/or the sufficiently frequent updating of the correct meter reading on the card.

Note that the user card may contain an anonymous or a personal meter reading and that the updating of a meter reading thus may concern, for example, the again and again decreasing of the meter reading on an anonymous or anonymously sold user card, or e.g. the again and again increasing of a personal meter reading on an identifiable payer or user card.

11. After receipt of an appropriate request signed by the legitimate holder or owner (or after receipt of a password earlier entered by the legitimate owner/holder) taking care of frequent transmission of identifying data.

By this it becomes often relatively easy to track the concerning vehicle soon, e.g. after theft.

12. Acting as reliable (trustworthy) taximeter, tachograph and/or black box, and the like.

The adjective ‘reliable’ here concerns (besides the fraud-resistance of the concerning equipment itself) particularly the verification of the correctness of (a part of) the supplied information (i.e., the input).

Of course, an agent does not necessarily have to perform all (whether or not mentioned) tasks and one may choose for a (possibly small) subset. The above does really illustrate once more the broad applicability of the TIP-system, i.e., that the TIP-system is also suited for use as a (whether or not integrated) multifunctional traffic information system.

An agent is by definition a fraud-resistant component. Here we emphasize, abundantly, that for certain tasks it is also necessary that the agent is fraud-resistantly connected/attached (and thus remains connected/attached) to the correct, corresponding vehicle.

18.2 Components Being Part of the TIP-system

In case of a TIP-system the traffic information system consists of, among other things, a large number of computers communicating with each other. When using agents a substantial number of these (namely, each agent) will be located (possibly only during use) in the vehicles involved and therefore will be mobile. Thus, in our judgement an agent forms part of the traffic information system. For possible user cards (say, magnetic cards or chipcards) that users may have with them and that are not covered by the notion of agent, the choice is somewhat less clear. If these mainly serve for the, in relation to the TIP-system, keeping (i.e., holding and maintaining) of whether or not personal usage rights, pollution rights and/or other meter readings, we consider these to be parts of the total system. All other vehicle equipment can be considered not to be part of the TIP-system. So, it is not necessary to consider the in vehicles present components, like for example sensors and/or measuring instruments, to be parts that belong to the TIP-system, not even if these components supply information that is useful or even necessary for the working of the TIP-system in question.

18.3 TIP-agents

Because of the many and diverse tasks that the TIP-system can perform, it is very well imaginable that all applications are not covered by one and the same authority. In such a case one of the authorities involved, or a separate authority that is independent of the authorities involved with the applications, may be responsible for the working (functioning) of the TIP-system. If so, then an agent can be seen primarily as a representative of the authority responsible for the TIP-system, and only secondarily as representative of the authorities involved with the applications, which apparently have enough confidence in the agents (and the rest of the TIP-system) to (dare to) entrust them certain tasks.

18.4 TIP-systems for Other Traffic

The enumeration of tasks that an agent can perform among other things, was given in the context of road traffic. It is not so difficult to make a similar enumeration for a number of other forms of traffic. We do want to emphasize here that the outcome of weighing an approach with agents against one without agents can be different for each form of traffic. For example, this is true for the case of air traffic, whereby tracing of commercial aircraft in general is not considered to be a privacy threat. In case of the earlier sketched example of reducing noise nuisance (by aircraft) one thus can do also very well without agents.

One then requires, for example, that aircraft within a certain distance from a certain airport must (almost) continuously transmit information about their position and about the (amount of) noise that they produce. The correctness of the given position can regularly be verified (by means of radio-bearings and/or radar installations or the like). The noise production can be randomly checked, with a reasonable degree of accuracy, on correctness or, better formulated, on reliability by performing (particularly, off-ground) sound-measurements (sound-ranging) on diverse places in the vicinity of approach and fly out routes. By gathering sufficient knowledge about the propagation of sounds, respectively sound-levels (sound-power??), (in both cases dependent on a number of circumstances, like for example wind-direction), one can derive by computation from the noise level information supplied from (within) the airplane how much noise approximately should have been observed on the spot of the measuring point and thus verify whether this derived value does not deviate too much from the actually measured value.

It is clear that one can verify the correct following of the prescribed approach (or fly out) route anyhow. Besides one then can check whether the airplane in question does have produced too much noise or not. By possibly describing the flying routes as fixed ‘allowed noise contours’, one may reduce noise nuisance in an efficient and flexible way. Less noisy aircraft then will have some more freedom of movement within the fixed (constant) contours than more noisy ones. And also less easily (quickly) exceed the imposed noise limits if, for example, during landing it appears between times necessary to open out the engine (throttle). Fines, if any, then of course can be made dependent on the seriousness (duration and amount) of the exceeding of the noise limit. Airline companies then will have an interest in avoiding fines and will stimulate their pilots (e.g. by means of a bonus and/or penalty system) to stay within the noise contours. In particular with more noisy machines the desired approach, respectively fly out, route then will be followed more accurately. That is not only favorable for those that have to undergo the noise nuisance, but also for an airport. For, an airport then less quickly will be forced to take ‘black/white’ decisions, i.e., then will have the advantage that it does not immediately have to completely exclude a somewhat noisier machine (and particularly a ‘borderline’ instance).

1 Method for collecting traffic information by or on behalf of an authority in order to levy a traffic fee concerning vehicle traffic
a) whereby traffic information required for determining the amounts of traffic fee due is collected from a set of vehicles and
whereby for vehicles in that set during their traffic participation
1) traffic information related to the vehicle in question, such as information about the distances covered by that vehicle, is supplied to a processor present in that vehicle, and
2) this traffic information is processed by that processor, and
3) all or a subset of the processed traffic information is stored by that processor, and
b) whereby the reliability of the in vehicles processed traffic information required for determining the amounts of traffic fee due, such as speed or odometer readings, is randomly checked by or on behalf of the authority by comparing samples of this information with samples of traffic information that have been independently determined by or on behalf of the authority at a distance from the randomly sampled and checked vehicles during their traffic participation and
whereby each such a comparison consists of comparing a sample of the in the checked vehicle processed traffic information that is related to that vehicle during a particular period, such as the speed of that vehicle at a particular moment according to the information received by the processor in question, with a similar sample of traffic information that concerns that same vehicle in the same period and that has been independently determined at a distance from that checked vehicle, such as the actual speed as independently measured from outside that vehicle, and
whereby communication between the checked vehicle concerned and the authority outside that vehicle by means of a transmitter and a receiver is used for transmitting a sample of the in the vehicle processed traffic information and/or a sample of traffic information that has been independently determined at a distance from that checked vehicle, to a place of traffic information comparison.

2: Method according to claim 1 whereby random checks as described in clause b of claim 1 are applied to vehicles at by or on behalf of the authority randomly chosen, varying places.

3: Method according to claim 1 whereby random checks as described in claim 1 or claim 2 are performed from mobile checkpoints, such as moving patrol vehicles.

4: Method according to claim 1 whereby some or all of the comparisons described in clause b of claim 1 are performed by or on behalf of the authority at a place outside the checked vehicle in question, for example along a road, and whereby the sample of the in said vehicle processed traffic information needed for a particular comparison, such as the currently by the processor in said vehicle observed speed and/or applied kind of tariff is received at the place of comparison in question, which is outside said vehicle, from the processor in said vehicle by means of communication via a transmitter in said vehicle and a receiver outside said vehicle.

5: Method according to claim 1 whereby some or all of the comparisons described in clause b of claim 1 are performed by or on behalf of the authority by the processor present in the checked vehicle in question and whereby the from outside said vehicle determined sample of traffic information needed for a particular comparison, such as the measured actual speed and/or the kind of tariff that should be applied in this case, is received by said processor in that vehicle by means of communication via a transmitter outside said vehicle and a receiver in said vehicle.

6: Method according to claim 1 whereby the processor sends during traffic participation at a prescribed rate declarations with piece(s) of traffic information related to the vehicle in question towards the authority outside that vehicle by means of a transmitter with a prescribed range.

7: Method according to claim 6 whereby further processing of the by the authority outside said vehicle received traffic information does not require all from said vehicle towards the authority transmitted declarations with piece(s) of traffic information to be received by the authority outside said vehicle.

8: Method according to claim 1 whereby the processor represents the authority in the vehicle in question and does on behalf of the authority receive during traffic participation piece(s) of traffic information supplied to it at a prescribed rate, so that the authority receives during traffic participation at a prescribed rate declarations in the vehicle in question.

9: Method according to claim 8 whereby the processor representing the authority in a vehicle in question does at appropriate moments supply a) data that directly or indirectly identifies a payer or a vehicle user, holder or owner, and also b) certain in said vehicle collected information related to said vehicle, such as meter reading(s) giving the total distance covered and/or the total traffic fee due, to the part of the authority outside the vehicle, for example in order to enable that part of the authority to collect the traffic fee(s) due for the use of said vehicle.

10: Method according to claim 1 whereby the vehicle user, holder and/or owner or equipment on behalf of the vehicle user, holder and/or owner has control over the communication channel(s) between the processor in the vehicle and a transmitter in the vehicle, so that (s)he or it can supervise or control e.g. the contents and/or frequency of messages transmitted via that transmitter by the processor in the vehicle, for example in order to protect his or her privacy.

11: Method according to claim 1 whereby the vehicle user, holder and/or owner or equipment on behalf of the vehicle user, holder and/or owner has control over the communication channel(s) between the processor in the vehicle and a receiver in the vehicle, so that (s)he or it can supervise or control e.g. the contents and/or frequency of messages received via that receiver by the processor in the vehicle, for example in order to protect his or her privacy.

12: Method according to claim 1 whereby at least part of the communication between vehicles and the authority goes via one or more organizations that are independent from the authority and that help to protect the privacy of vehicle users, holders and/or owners.

13: Method according to claim 1 whereby random checks as described in a preceding claim are applied to vehicles during their traffic participation.

14: Method according to claim 1 whereby the traffic information that during a random check is transmitted to the place of traffic information comparison, includes a meter reading.

15 Method according to claim 1 whereby the traffic information that during a random check is transmitted to the place of traffic information comparison, includes an odometer meter reading or a speed.

16: Method according to claim 1 whereby the traffic information that during a random check is transmitted to the place of traffic information comparison, includes a traffic fee meter reading or its speed of increase or decrease.

17: Method according to claim 1 whereby the communication during a random check between the checked vehicle concerned and the authority outside that vehicle for transmitting a sample of traffic information to the place of traffic information comparison occurs by means of sound waves or radio waves or infrared waves or light waves.

18: System that comprises a processor and also a transmitter and/or receiver, used for carrying out a method according to claim 1.
